(19) United States
(12) Patent Application Publication
(10) Pub. No.: US 2026/0268393 A1
(43) Pub. Date: Sep. 10, 2026

(54) SYSTEM AND METHOD FOR ON-DEMAND DIRECT DISTRIBUTION OF ROBOTIC ASSETS

(71) Applicant: Varindra Vinayakam Persad Maharaj, Sunnyvale, CA (US)

(72) Inventor: Varindra Vinayakam Persad Maharaj, Sunnyvale, CA (US)

(21) Appl. No.: 19/425,722

(22) Filed: Dec. 18, 2025

Related U.S. Application Data
(60) Provisional application No. 63/768,940, filed on Mar. 8, 2025.

(51) Int. Cl. G06Q 30/0645; G05D 1/248; G05D 1/69; G05D 111/30; G06Q 30/0201

(52) U.S. Cl. CPC G06Q 30/0645; G05D 1/248; G05D 1/69; G06Q 30/0206; G05D 2111/32

(57) ABSTRACT

A system and method manage the rental, allocation, and maintenance of robots through an integrated platform. The system facilitates efficient coordination between users, robots, and distribution networks to ensure smooth operation and optimized resource use. The system allows robots to be deployed, transferred, and maintained based on real-time data and operational conditions, reducing downtime and improving service efficiency. Automated decision-making is supported for task assignment, maintenance handling, and user management within a connected environment.

### CROSS-REFERENCE TO RELATED APPLICATIONS

This application claims the benefit of priority of U.S. Provisional Application No. 63/768,940, filed Mar. 8, 2025, the disclosure of which is incorporated herein by reference in its entirety

### FIELD OF THE DISCLOSURE

The present invention relates generally to systems and methods for managing distribution of robotic assets. More particularly, the invention pertains to systems and methods for allocating and dispatching robots in response to on-demand rental requests.

### BACKGROUND OF THE DISCLOSURE

The proliferation of robotics and automation has led to the development of specialized robots for commercial and consumer tasks, including delivery, inspection, construction, security, and cleaning. Businesses and individuals increasingly seek to utilize these assets on a temporary or “as-a-service” basis rather than through outright ownership, which requires significant capital investment and ongoing maintenance.

Conventional systems for renting and deploying robotic assets typically operate on a traditional logistics model wherein a fleet of robots is housed at central depots. When a customer submits a rental request, a robot is dispatched from the depot to the customer's location for the rental period. Upon completion, the robot is retrieved and transported back to the central depot for processing before being made available for the next rental.

This approach suffers from significant operational inefficiencies. The mandatory return to the depot after each rental introduces substantial non-productive transit time, increasing operational costs and extending turnaround times. Available robots may be located at depots far from new customers, resulting in slower response times and increased delivery costs, even when robots have recently completed tasks in proximity to new demand locations.

Therefore, there exists a need in the art for improved systems and methods for managing on-demand allocation and distribution of rental robots that can increase fleet utilization and improve operational efficiency.

### SUMMARY OF THE DISCLOSURE

In accordance with a first aspect of the present invention, there may be provided a method for managing on-demand distribution of one or more robots. The method may comprise receiving, at a server from a first user device, a first rental request for a first robot, the first rental request defining a first rental period and a first delivery location; dispatching the first robot from an inventory to the first delivery location for the duration of the first rental period; prior to a conclusion of the first rental period, receiving, at the server from a second user device, a second rental request defining a second rental period and a second delivery location; identifying, via a processor, that the first robot is positioned at the first delivery location and has a status indicating availability upon the conclusion of the first rental period; in response to said identifying, assigning the first robot to the second rental request; and transmitting, from the server, instructions to a transport resource to execute a direct transfer of the first robot from the first delivery location to the second delivery location, wherein the direct transfer bypasses a return of the first robot to a central depot. This integrated approach may enable efficient asset management across multiple rental operations.

In some exemplary embodiments of the present invention, assigning the first robot may be based on an analysis of multiple objectives, said objectives including delivery speed, cost-effectiveness, and service reliability. Multi-objective optimization may enhance overall system performance and customer satisfaction.

In some exemplary embodiments of the present invention, the analysis of multiple objectives may be based on a plurality of data inputs, said data inputs comprising: geographic proximity, the current status and capability of available transport resources, historical performance data, and estimated travel time based on real-time traffic conditions. Comprehensive data integration may enable informed allocation decisions under varying operational conditions.

In some exemplary embodiments of the present invention, the method may further comprise calculating an efficient transportation route for the direct transfer, the route being determined to reduce transportation time and minimize idle time for the first robot. Route optimization may improve fleet utilization and reduce operational costs.

In some exemplary embodiments of the present invention, the method may further comprise determining a rental cost for the second rental request using a dynamic pricing model, wherein the model calculates a base rate and applies a multiplier based on real-time supply and demand data within a geographic region associated with the second delivery location. Dynamic pricing may optimize revenue generation based on market conditions.

In some exemplary embodiments of the present invention, the second rental request may include a robot type specification, and wherein the multiplier may be increased in response to determining that a demand for the specified robot type exceeds a supply of available robots of the specified robot type, creating a surge price. Demand-responsive pricing may balance fleet utilization across different robot categories.

In some exemplary embodiments of the present invention, identifying that the first robot is located at the first delivery location may be performed using a real-time inventory management system that maintains current location coordinates, operational status, and capability profiles for each robot from the one or more robots. Real-time tracking may ensure accurate fleet visibility and availability determination.

In some exemplary embodiments of the present invention, the method may further comprise, prior to assigning the first robot, analyzing its operational status to determine a health parameter; comparing the health parameter against a predefined maintenance threshold; and wherein the first robot may be assigned only if its health parameter satisfies the maintenance threshold. Health-based allocation may ensure service reliability and prevent equipment failures during rental periods.

In some exemplary embodiments of the present invention, if the health parameter fails to satisfy the maintenance threshold, the method may further comprise transmitting instructions to route the first robot to a designated maintenance location following the conclusion of the first rental period. Automated maintenance routing may extend asset operational life and ensure safe operation.

In some exemplary embodiments of the present invention, the method may further comprise generating an insurance fee for the second rental request based on a computed user score, wherein the user score may be calculated for a user associated with the second rental request based on a plurality of factors comprising: a rental history of the user, a payment history of the user, and damage rates associated with prior rentals by the user. Risk-based insurance pricing may optimize financial protection and encourage responsible asset usage.

In some exemplary embodiments of the present invention, the method may further comprise processing a payment transaction for the second rental request through an integrated financial service module that performs real-time authorization, automated billing, and electronic settlement. Integrated payment processing may enable seamless transaction management for rental operations.

In some exemplary embodiments of the present invention, the method may further comprise, prior to dispatching the robot for a rental period, authorizing a security deposit amount against a financial account associated with the corresponding rental request; and upon a successful conclusion of the rental period, initiating a release of the security deposit amount. Security deposit management may provide financial protection against asset damage or loss.

In some exemplary embodiments of the present invention, the first robot may be owned by a third-party owner and registered in the inventory, the method may further comprise calculating a commission fee for the first rental period; and crediting a payment, based on the commission fee, to an account associated with the third-party owner. Third-party asset integration may enable scalable fleet expansion through distributed ownership models.

In some exemplary embodiments of the present invention, the first and second rental requests may each include functional requirements, and wherein assigning the first robot may be further based on verifying that a capability profile of the first robot satisfies the functional requirements of the second rental request. Capability-based matching may ensure appropriate robot assignment for specific task requirements.

### BRIEF DESCRIPTION OF THE DRAWINGS

FIG. 1A illustrates a non-limiting example of a block diagram of a system architecture configured for implementing an automated robot rental and management ecosystem, in accordance with an exemplary embodiment of the present invention.

FIG. 1B illustrates a non-limiting example of a user to user robot dispatch system, in accordance with an exemplary embodiment of the present invention.

FIG. 2 illustrates a non-limiting example of a method for managing direct transfer of robots between consecutive rental assignments in an on-demand robot rental system, in accordance with an exemplary embodiment of the present invention.

FIG. 3 illustrates a non-limiting example of a method for managing on-demand distribution of one or more robots in a rental system, in accordance with an exemplary embodiment of the present invention.

FIG. 4 illustrates a non-limiting example of a method for implementing dynamic pricing algorithms in an on-demand robot rental system, in accordance with an exemplary embodiment of the present invention.

FIG. 5 illustrates a non-limiting example of a method for calculating insurance fees in an on-demand robot rental system based on comprehensive risk assessment, in accordance with an exemplary embodiment of the present invention.

FIG. 6 illustrates a non-limiting example of a method for robot health assessment and maintenance routing in an on-demand robot rental system, in accordance with an exemplary embodiment of the present invention.

FIG. 7 illustrates a non-limiting example of a method for multi-robot dispatch and fleet optimization in an on-demand robot rental system, in accordance with an exemplary embodiment of the present invention.

FIG. 8 illustrates a non-limiting example of a method for handling concurrent rental requests and parallel workflow processing in an on-demand robot rental system, in accordance with an exemplary embodiment of the present invention.

FIG. 9 illustrates a non-limiting example of a method for third-party owner commission processing in an on-demand robot rental platform, in accordance with an exemplary embodiment of the present invention.

FIG. 10 illustrates a non-limiting example of a method for implementing predictive analytics and fleet redistribution operations in an on-demand robot rental system, in accordance with an exemplary embodiment of the present invention.

FIG. 11 illustrates a non-limiting example of a method for payment authorization and settlement processing in an on-demand robot rental system, in accordance with an exemplary embodiment of the present invention.

FIG. 12 illustrates a non-limiting example of a method for exception handling and failure recovery in an on-demand robot rental system, in accordance with an exemplary embodiment of the present invention.

FIG. 13 illustrates a non-limiting example of a method for user scoring and risk assessment in an on-demand robot rental system, in accordance with an exemplary embodiment of the present invention.

FIG. 14 illustrates a non-limiting example of a method for task assignment and execution flowchart in an on-demand robot rental and dispatch system, in accordance with an exemplary embodiment of the present invention.

FIG. 15 illustrates a non-limiting example of a robot maintenance decision process for an on-demand robot rental system, in accordance with an exemplary embodiment of the present invention.

FIG. 16 illustrates a non-limiting example of a method for robotic asset deployment, including parallel matching of a driver and teleoperator, delivery, and task initiation, in accordance with an exemplary embodiment of the present invention.

### DETAILED DESCRIPTION OF CERTAIN EMBODIMENTS OF THE DISCLOSURE

The embodiments and implementations of the present invention are disclosed herein in detail with the technical matters, structural features, achieved objects, and effects with reference to the accompanying drawings as follows. It shall be understood that the disclosed embodiments and implementations are merely illustrative of present invention which may be embodied in various forms. The present invention may, however, be embodied in many different forms and should not be construed as limited to the exemplary embodiments and implementations set forth herein. Rather, these exemplary embodiments and implementations are provided so that description of the present invention is thorough and complete and will fully convey the scope of the present invention to those skilled in the art. Specifically, the terminologies in the embodiments of the present invention are merely for describing the purpose of the certain embodiment, but not to limit the disclosure. In the description below, details of well-known features and techniques may be omitted to avoid unnecessarily obscuring the presented embodiments and implementations.

In some exemplary embodiments of the present invention, a system and method for on demand direct distribution of robotic assets is provided. The system may enable users to request, lease, and operate autonomous or semi-autonomous robots for variable durations through a fully integrated digital ecosystem. The system may consist of a plurality of interconnected software and hardware components configured to automate various stages of the rental lifecycle, including but not limited to, customer request, robot allocation, delivery, operation, maintenance, and return.

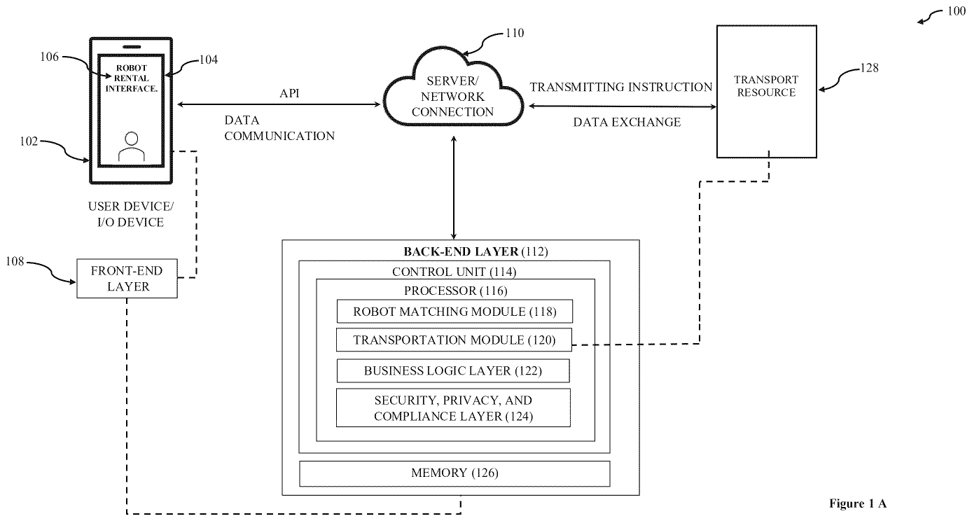

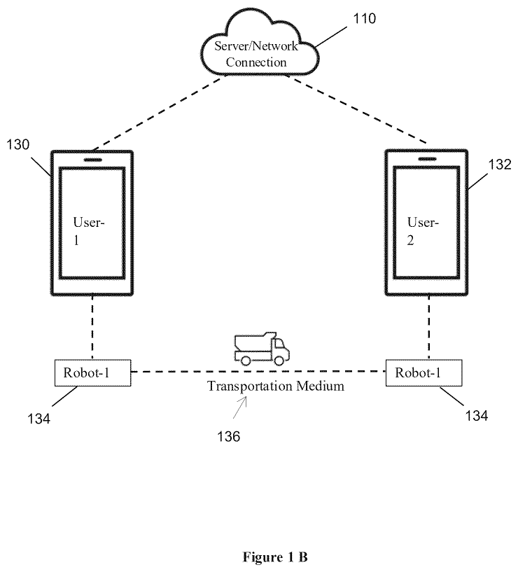

In some exemplary embodiments of the present invention, reference is made to FIG. 1A, illustrating a non-limiting example of a block diagram of a system 100 architecture configured for implementing an automated robot rental and management ecosystem.

In some exemplary embodiments of the present invention, the system 100 may further comprise a user device 102 configured to access and interact with the automated robot rental ecosystem. The user device 102 may include, but is not limited to, a mobile phone, tablet, laptop, desktop computer, wearable device, or any other computing device capable of executing an application or web-based platform associated with the system 100. The user device 102 may enable a user to browse, select, rent, and manage robotic assets through an integrated interface. The communication between the user device 102 and the system 100 may occur via secure wired or wireless connections such as Wi-Fi, 4G/5G, Bluetooth, Real Time Kinematics (RTK) or other suitable communication networks.

In some exemplary embodiments of the present invention, the user device 102 may include a display 104 configured to present a user interface (GUI) of the robot rental and management system 100. The display 104 may be implemented as a touch-sensitive, presence-sensitive, or non-touch display, and may facilitate user interaction through various input means including, but not limited to, fingertip touch, stylus, voice command, or gesture input. The display 104 may visually represent available robots, rental options, notifications, real-time location tracking, and payment confirmations.

In some exemplary embodiments of the present invention, the display 104 may function as both an output and input interface also referred to as I/O device(s), allowing users to initiate or manage robot rentals seamlessly. The display 104 may further include an input/output interface module for receiving commands and providing system responses.

In some exemplary embodiments of the present invention, a robot rental interface 106 may be hosted within the display 104 or accessible via a web-based or native application platform. The robot rental interface 106 may enable a user to perform operations such as requesting a robot, specifying required functionality, viewing nearby available robots, processing payments, etc.

In some exemplary embodiments of the present invention, the interface may also allow robot owners or lessors to list their available robots, set rental conditions, and monitor performance. The robot rental interface 106 may communicate with the backend layer 112 through secure APIs to synchronize data in real time.

In some exemplary embodiments of the present invention, the system 100 may further comprise a plurality of layers and modules to facilitate seamless communication, processing, and execution of robot rental, allocation, and management operations. The one or more layers and modules may include but are not limited to, a frontend application layer 108, a backend management and orchestration layer 112, a data and analytics layer 122, robot matching module 118, transportation module 120, security/authentication layer 124, along with other auxiliary or supporting layers and modules as may be necessary for system functionality, all of which may communicate securely through a server/network connection 110.

In some exemplary embodiments of the present invention, the frontend layer 108 may be operatively connected to the user device 102 and may be responsible for managing all user-facing components of the platform. The frontend layer 108 may render the interface elements visible to the user and handle client-side interactions such as form inputs, button selections, or graphical updates, etc.

In some exemplary embodiments of the present invention, the frontend layer 108 may also facilitate secure data transmission to the backend layer 112, ensuring responsiveness and smooth transition between user actions and system responses. The frontend layer 108 may further include one or more modules for session management, authentication, and notification delivery, and other functionalities necessary for ensuring seamless user interaction and operational efficiency.

In some exemplary embodiments of the present invention, the backend layer 112 may execute business logic, inventory management, insurance computation, scheduling, robot deployment operations, battery management, management of robot accessories and attire, as well as additional processes and supporting infrastructure.

In some exemplary embodiments of the present invention, the backend layer 112 orchestrates the functional operations of the robot rental ecosystem. The backend layer 112 may include a control unit 114 configured to process, analyze, and execute commands received from the frontend layer 108.

In some exemplary embodiments of the present invention, the control unit 114 may host one or more processors 116 capable of running complex algorithms, machine learning models, and data analysis tasks. The control unit 114 may execute functions such as robot matching, scheduling, transportation coordination, and user authentication, and other computational or operational processes necessary for efficient system management and execution.

In some exemplary embodiments of the present invention, the control unit 114 may include one or more processing devices, such as a Central Processing Unit (CPU) or other processors 116, memory 126, and input/output devices. The processing devices may enable the control unit 114 to execute complex algorithms, machine learning models, and decision-making routines in real-time, including robot allocation, matching operations, scheduling, pricing computation, insurance estimation, maintenance coordination, and dynamic operational adjustments.

In some exemplary embodiments of the present invention, the memory 126 of the control unit 114 may be located internally within the system 100, externally in a cloud-based or distributed storage infrastructure, or a combination thereof. The memory 126 may store operational data, user preferences, robotic assets database, robot usage history, rental transaction records, maintenance logs, and other relevant system data. The availability of such stored data may allow the control unit 114 to perform analytics, predictive modeling, and continuous optimization of robot deployment and service quality across multiple sessions and users.

In some exemplary embodiments of the present invention, the memory 126 may be configured to store and manage the information utilized and generated by the autonomous robotic rental ecosystem. The memory 126 may include one or more databases or data repositories configured to store robot-related data, rental transactions, user profiles, operational logs, sensory data, maintenance history, and other relevant information necessary for the execution of the system's functions.

In some exemplary embodiments of the present invention, the memory 126 may comprise one or more forms of storage located internally within the server/network 110 of the system 100 or externally through distributed or cloud-based infrastructure. The memory 126 may include, by way of example, flash memory, random-access memory (RAM), read-only memory (ROM), compact disc read-only memory (CD-ROM), digital versatile disc (DVD), smart card, magneto-optical storage, erasable programmable read-only memory (EPROM), electrically erasable programmable read-only memory (EEPROM), or other equivalent storage media.

In some exemplary embodiments of the present invention, the memory 126 may store executable instructions, program code, or algorithms that enable the system 100 to perform operations including robot allocation, matching operations between customers and available robots, scheduling, pricing computation, insurance estimation, payment processing, and maintenance coordination. The memory 126 may further store communication data exchanged between microservices, including user requests, API transactions, and message-queue events.

In some exemplary embodiments of the present invention, the input/output devices of the control unit 114 may facilitate communication between the control unit 114, frontend interfaces 108, backend services 112, and robots, thereby enabling real-time data exchange, command execution, and monitoring of system performance.

In some exemplary embodiments of the present invention, once a user initiates a robot selection through the robot rental interface 106, the processor 116 may execute a robot matching module 118 configured to analyze the user's request and identify the most suitable robotic asset from the available database. The matching process may involve evaluating parameters such as, but not limited to robot type, capabilities, proximity to the user, operational condition, and expected delivery time. Based on this analysis, the system 100 may determine the optimal match from either a robot storage warehouse, robot factory or a user-owned robot registered within the platform. Upon successful matching, the robot matching module 118 may generate/transmit an allocation/instruction signal to transport resources 128 initiate the transportation coordination process and facilitate robot deployment.

In some exemplary embodiments of the present invention, the robot matching module 118 may be performed using machine learning algorithms or artificial intelligence-based models trained on historical rental data, user preferences, robot performance metrics, and contextual parameters such as location, demand patterns, and environmental conditions, and may further consider human operator or driver-related factors including proximity to the request, available capacity, and familiarity with robot setup and deployment procedures, among other operational attributes. These algorithms may continuously learn and improve the accuracy of robot-to-request assignments over time.

In some exemplary embodiments of the present invention, the models that may be employed for such matching operations can include, for example, classification models such as Decision Trees, Random Forests, or Support Vector Machines (SVMs), clustering algorithms such as K-Means or Hierarchical Clustering; regression models for demand prediction, and deep learning architectures such as Artificial Neural Networks (ANNs) or Recurrent Neural Networks (RNNs) for dynamic allocation and route optimization. The selection of a particular model may depend on factors such as data volume, feature complexity, and real-time processing requirements.

In some exemplary embodiments of the present invention, the backend layer 112 may include a transportation module 120 configured to manage the logistics of robot delivery and retrieval. Upon receiving the allocation signal from the robot matching module 118, the transportation module 120 may determine the most efficient route and mode of transport. The transportation may be executed through various transport resources 128, including in-house vehicles, third-party delivery services, autonomous carriers, or any other appropriate means. The transportation module 120 may also update the system 100 in real time with the robot's transit status, estimated arrival, and delivery confirmation.

In some exemplary embodiments of the present invention, the one or more transport resources 128 may be responsible for physically transferring robots between storage locations, users, and service centers. The transport resources 128 may be managed directly by the robot agency, or indirectly via third-party logistics partners or autonomous transportation mechanisms, and may include human-operated vehicles, autonomous vehicles, or hybrid arrangements. Upon successful matching and approval, the backend layer 112 may trigger a notification to the transport resource 128 to initiate robot movement. If a human driver or human-operated transport resource is unavailable within a defined contingency window, the system may automatically initiate a fallback procedure that re-queues the request, escalates to alternate transport resources (including autonomous transport, partner fleets, or deferred scheduling), or notifies the user of revised ETAs. The transport resource 128 may communicate status updates back to the system 100 for real-time tracking, route optimization, and delivery verification, and in contingency mode, may publish exception codes and updated fulfillment estimates to enable monitoring and recovery workflows.

In some exemplary embodiments of the present invention, the transportation module 120 may leverage the inherent properties of humanoid robots, namely, reusability and compactness, to enable efficient distribution and redeployment. The reusable nature of robots allows them to be circulated between multiple customers without returning to a central warehouse, while their compact structure facilitates convenient storage and low-cost transportation. These attributes may collectively reduce the operational downtime and logistical complexity typically associated with redistributing reusable assets.

In some exemplary embodiments of the present invention, the transportation module 120 may be configured to minimize the need for robots to return to a distribution or maintenance center by facilitating direct transfers between customer locations. For instance, upon completion of a rental session, a robot may be transported directly from one customer's premises to another nearby user who has placed a compatible request. Such peer-to-peer logistics may be managed by the system's 100 backend algorithms, which may determine the most suitable next destination based on proximity, demand priority, and operational readiness of the robot.

In some exemplary embodiments of the present invention, the transportation module 120 may enable multi-modal transport operations. Depending on the delivery distance and robot condition, transportation may be performed by autonomous self-navigation, wherein robots walk or move independently to nearby destinations, third-party ride-sharing or courier services integrated through secure APIs, or dedicated transport vehicles managed by the system operator. The system 100 may dynamically select or combine these modes based on factors such as distance, traffic, terrain, and robot type.

In some exemplary embodiments of the present invention, the transportation module 120 may initiate robot pickup or retrieval based on one or more triggering events, such as, a customer submitting a pickup request through the rental interface, a robot owner requesting retrieval, the expiration of a customer's rental duration without renewal or the identification of a new rental request from a nearby customer for whom the robot is optimally positioned, etc. The module 120 may prioritize pickups using predictive scheduling algorithms or the like, to minimize idle time and transportation costs.

In some exemplary embodiments of the present invention, the transportation module 120 may further manage maintenance-related routing. When a user indicates through the interface that a robot has sustained damage or exhibits reduced performance, the system 100 may classify the condition as “extensive”, or “minor” based on predefined diagnostic parameters. Robots requiring extensive repair may be routed to maintenance facilities, while those in usable condition may be redirected for immediate redeployment. This approach may ensure continuous operational availability with minimal downtime.

In some exemplary embodiments of the present invention, the transportation module 120 may operate in conjunction with a database layer/module 130 and an inventory module. The database module 130 may store all data relevant to robot identification, location history, and transportation logs, while the inventory module may verify the availability of robots, batteries, clothing components, accessories (such as hand attachments, claws, scrubbing tools, or other interchangeable tool attachments) and transportation resources prior to initiating dispatch. These integrated modules may collectively ensure that each transport operation is data-driven, verified, and optimized.

In some exemplary embodiments of the present invention, the transportation module 120 may further include a multi-robot dispatch and fleet optimization mechanism configured to efficiently manage the distribution and movement of robots between users and locations. The transportation module 120 may be adapted to process multiple rental requests simultaneously, analyze robot availability and proximity, and match suitable robots using advanced algorithms such as machine learning-based optimization, clustering, and predictive modeling. The system 100 may prioritize assignments based on parameters including but not limited to delivery time, cost, and reliability, and may group compatible delivery locations to optimize transport resource 128 allocation.

In some exemplary embodiments of the present invention, the transportation module 120 may further generate optimized task sequences for pickup, transfer, and delivery operations, and dispatch multiple transport resources 128 such as autonomous vehicles, third-party logistics services, or robotic carriers to execute these tasks. In some embodiments, the transportation module 120 may enable direct deliveries between customer locations, reducing the need for depot returns and improving fleet efficiency. The module may continuously update the inventory database with real-time robot location, delivery status, and availability, and may further trigger reassignment workflows when a robot completes a rental near another request location. Additionally, the transportation module 120 may include performance monitoring capabilities to evaluate delivery success rates, fleet utilization, and operational efficiency for continuous optimization.

In some exemplary embodiments of the present invention, a business logic layer 122 may be provided to manage, coordinate, and execute all logical operations that occur within the automated on-demand robotic rental ecosystem.

In some exemplary embodiments of the present invention, the business logic layer 122 may be implemented as a microservice-based architecture, wherein each operational process may exist as an independent, loosely coupled service. These services may communicate through secure application programming interfaces (APIs) or an event-driven message broker to ensure high scalability, modularity, and fault tolerance.

In some exemplary embodiments of the present invention, the business logic layer 122 may further comprise a decision-making subsystem that utilizes artificial intelligence (AI) or machine learning (ML) algorithms to optimize allocation and resource distribution. This subsystem may evaluate multiple factors, including customer proximity, robot condition, historical demand data, and environmental constraints, to determine the most efficient fulfillment strategy for each rental request. The engine may also dynamically modify deployment strategies in response to changes in demand, robot status, or network conditions.

In some exemplary embodiments of the present invention, the system 100 may include a database module configured to store, manage, and provide access to data essential for the operation of the automated robot rental and management platform. The database module may maintain structured records related to robot assets, including but not limited to robot identification information, specifications, operational status, current and historical rental data, maintenance history, and geographic location.

In some exemplary embodiments of the present invention, the company or service provider may deploy and maintain multiple robots across various geographic regions or cities. The database module may store inventory data for all such robots, enabling the system 100 to perform real-time lookups of available or soon-to-be-available robots upon receiving a customer's rental request. The module may be configured to execute query operations that retrieve relevant records based on parameters such as robot proximity, functionality, availability time, and ownership type for example, company-owned or user-listed.

In some exemplary embodiments of the present invention, the database module may interact with the robot matching and frontend interface modules 108 to dynamically generate and display to the customer a list of nearby robots along with their respective availability windows, pricing, and operational details. The module may also support predictive querying, wherein the system 100 anticipates near-future availability based on ongoing rentals and estimated return times.

In some exemplary embodiments of the present invention, the database module may be implemented using a distributed or cloud-based database architecture to ensure scalability, redundancy, and low-latency access across multiple service regions. Data synchronization mechanisms may be employed to maintain consistency between local and remote databases, allowing for seamless real-time updates and global data availability. The database module may further incorporate indexing, caching, and data partitioning strategies to optimize query performance and ensure rapid response to high-volume user requests.

In some exemplary embodiments of the present invention, the system 100 may include a deployment module configured to function as an orchestration component responsible for coordinating and executing robot deployment operations. Upon receiving a confirmed request for robot deployment, the deployment module may communicate with other system 100 modules such as the robot matching module 118, transportation module 120, and inventory module to determine the most appropriate sequence of actions required for fulfillment. Based on these interactions, the deployment module may initiate the dispatch of a selected robot from its current location to the designated customer or operational site. The module may further manage real-time status updates, monitor the deployment progress, and handle exception scenarios such as delays or allocation conflicts, thereby ensuring efficient and reliable robot delivery within the automated rental ecosystem.

In some exemplary embodiments of the present invention, the system 100 may include an insurance module configured to perform insurance-related computations and determine the amount payable by a user as a refundable or non-refundable insurance deposit, collision damage waiver (CDW), loss damage waiver (LDW), or liability coverage option prior to robot reservation. The insurance module may further be configured to assess risk factors, coverage tiers, deductible amounts, and damage liability thresholds associated with the robot rental. The insurance module may operate in conjunction with the payment and database modules to calculate, store, and process insurance values, damage waiver terms, coverage limits, and claim-related data corresponding to each rental transaction. In certain embodiments, the insurance module may dynamically adjust insurance premiums or waiver fees based on factors such as rental duration, robot type, user history, geographic location, or assessed risk level.

In some exemplary embodiments of the present invention, the insurance module may compute the insurance fee based on parameters such as the robot's manufacturer's suggested retail price (MSRP), the duration of the rental, and associated risk factors including but not limited to: age of the robot, operational wear and tear metrics, maintenance history, previous damage or repair records, user's rental history and claim record, geographic location or deployment environment (e.g., indoor vs. outdoor, commercial vs. residential), robot model complexity, availability of replacement parts, seasonal demand variations, and anticipated usage intensity. In one embodiment, the insurance cost may be calculated using a function such as the following equation:

$$Insurance Fee = Robot MSRP \times 0.05 \times ( Number of Hours Leased \hat{} 0.05 ) .$$

The module may further update or refine these calculations as more data becomes available or as additional pricing models are introduced.

In some exemplary embodiments of the present invention, the insurance module may employ an artificial intelligence (AI) or machine learning-based risk assessment model to evaluate the renter's reliability and potential risk exposure. The model may compute a Risk Score using weighted parameters such as past rental behavior, security deposit amount, insurance coverage level, and camera authorization preferences. Based on the computed Risk Score, the system 100 may approve, reject, or request additional security before finalizing the rental.

In some exemplary embodiments of the present invention, the insurance module may also manage pre-and post-rental condition assessments of robots. A delivery agent or automated diagnostic system 100 may perform condition analysis optionally supported by photographic or video evidence to verify any reported damage or wear. Depending on the findings, the insurance module may process refunds for deposits or withhold amounts to cover repair or replacement costs.

In some exemplary embodiments of the present invention, the insurance module may allow users to opt into or out of camera-based monitoring during rental. Opting into monitoring may result in a reduced insurance fee, as visual evidence supports claim verification. Additionally, the module may incorporate deductible mechanisms such that in the event of major damage, the insurance covers the loss minus the deductible payable by the customer.

In some exemplary embodiments of the present invention, the system 100 may establish a dedicated insurance entity or partner with third-party insurers to provide specialized robotics insurance services. The insurance module may thus be extended to offer coverage not only for internal rentals but also for external customers or enterprises utilizing similar robotic systems.

In some exemplary embodiments of the present invention, the system 100 may include a pricing module configured to calculate the cost associated with leasing a robot based on dynamic and static parameters. The pricing module may consider variables including, but not limited to, the time of day, demand level, robot type, rental duration, remaining battery life, clothing or accessory requirements, and operational location. The module may utilize real-time data and predictive algorithms to adjust pricing dynamically, ensuring fair valuation and optimal resource utilization across the robot rental ecosystem.

In some exemplary embodiments of the present invention, the system 100 may include a payment module configured to execute financial transactions associated with robot rentals, including charging users, processing refunds, and managing payment authorizations. The payment module may interact with external payment gateways or providers through secure application programming interfaces (APIs) to facilitate transactions in real time. It may further support multiple payment methods, such as, but not limited to, credit or debit cards, digital wallets, or direct bank transfers, and may ensure secure processing through encryption and compliance with financial data protection standards.

In some exemplary embodiments of the present invention, the system 100 may include an admin module configured to provide internal control, monitoring, and analytics functionalities for system administrators. The admin module may enable authorized personnel to track operational metrics such as active rentals, robot utilization rates, maintenance schedules, and financial performance. It may further allow administrative actions including user management, system configuration, and access control. The module may generate real-time dashboards and reports to support decision-making, ensure compliance with operational policies, and maintain overall system 100 integrity and efficiency.

In some exemplary embodiments of the present invention, a security, privacy, and compliance layer 124 may be provided to ensure the protection of user data, robot operation integrity, and adherence to applicable laws and regulations within the automated robotic rental ecosystem. The system 100 may implement safeguards across software, hardware, and communication channels to prevent unauthorized access, data breaches, and misuse of autonomous robots.

In some exemplary embodiments of the present invention, the system 100 may utilize encryption, authentication, and access control protocols for all data transmissions and storage. Communication between frontend layer 108, backend layer 112, robots, and third-party service providers and other system requirements may be encrypted using industry-standard algorithms, and user authentication may include multi-factor verification, digital certificates, or biometric verification methods.

In some exemplary embodiments of the present invention, the framework may support user privacy controls, allowing users to selectively enable or disable data collection features such as camera recording, sensor logging, or interaction monitoring. Data collected during robot operation may be anonymized, aggregated, or encrypted to ensure confidentiality while enabling analytics for system improvement and predictive modeling.

In some exemplary embodiments of the present invention, the compliance module may ensure that the system 100 adheres to regional, national, and international regulations, including data protection laws, safety standards, and consumer protection requirements. The system 100 may maintain audit logs, enforce retention policies, and support automated reporting for regulatory compliance verification.

In some exemplary embodiments of the present invention, the security, privacy, and compliance framework 124 may also integrate with insurance, emergency control, and maintenance systems, ensuring that security incidents, operational anomalies, or policy violations are detected, logged, and addressed in a coordinated manner. Alerts may be generated in real time to notify administrators, users, or service agents of potential breaches or non-compliant actions.

In some exemplary embodiments of the present invention, the security, privacy, and compliance layer/framework 124 may therefore provide a comprehensive, proactive, and adaptable system 100 that safeguards user information, ensures safe robot operation, and maintains regulatory adherence across the autonomous robotic rental ecosystem.

In some exemplary embodiments of the present invention, a comprehensive support and emergency management system may be provided additionally, to ensure user safety, operational reliability, and rapid response for autonomous robot rentals. The system may integrate a helpline for real-time troubleshooting, guidance, and assistance via voice, chat, or video, allowing users to report issues, request guidance, or escalate problems. Minor issues may be addressed remotely through AI-guided instructions, while critical events, such as mechanical failures, software malfunctions, accidents, or safety hazards, may trigger immediate dispatch of service agents or automatic interventions.

In some exemplary embodiments of the present invention, the system 100 may include on-the-go or roadside assistance capabilities, enabling service agents to respond to user-reported issues, malfunctions, or operational anomalies in real time. Service requests may be initiated through the frontend interface 108, and the system 100 may generate estimated response times, assign agents, and track service progress until resolution. The system 100 may also provide users with AI-guided or non-AI guided troubleshooting steps to attempt preliminary fixes before dispatching an agent.

In some exemplary embodiments of the present invention, the system 100 may utilize centralized distribution centers or regional hubs where robots may be routed for more extensive maintenance or repair operations. These centers may house specialized tools, spare parts, and trained personnel to perform hardware replacement, software updates, or calibration. The backend management system may monitor robot usage, performance metrics, and maintenance history to automatically schedule preventive maintenance and predict potential failures.

In some exemplary embodiments of the present invention, the system 100 may include an Andon cord style emergency control, enabling partial or full deactivation of individual robots or entire fleets in response to detected anomalies, environmental hazards, or unauthorized access, with alerts sent to administrators, users, and service personnel. It may feature real-time monitoring, tiered response protocols, configurable safety thresholds, and integration with backend orchestration, maintenance, distribution, and insurance modules for coordinated incident management. Users may also access documentation, FAQs, and historical support data to improve self-service and predictive maintenance. Overall, this unified framework provides proactive, responsive, and flexible support and emergency management, balancing rapid intervention, operational continuity, and regulatory compliance across the autonomous robotic rental ecosystem.

In some exemplary embodiments of the present invention, reference is made to FIG. 1B, which illustrates a non-limiting example of a user-to-user robot dispatch system within the on-demand robot rental platform. FIG. 1B depicts a scenario involving two users User 1 and User 2, each associated with respective user devices 130, 132 that communicate with the central server over the server/network connection 110.

As illustrated, Robot 1 134 is initially in possession of User 1, who has completed or is nearing completion of their rental period. Instead of returning the robot to a central warehouse or hub, the system 100 determines that User 2 has placed a rental request for the same robot model within a nearby geographic location. Through the transportation medium 136, the system 100 facilitates direct robot transfer from User 1 to User 2, optimizing operational efficiency and minimizing idle time or unnecessary transport costs.

In some exemplary embodiments of the present invention, FIG. 1B further demonstrates how both user devices maintain continuous communication with the server/network connection 110, enabling real-time coordination, authentication, and task confirmation during the transfer process. This user-to-user dispatch mechanism allows the platform to execute peer-level logistics, reduce turnaround time, and enhance overall service responsiveness by leveraging network-based and proximity-based robot routing.

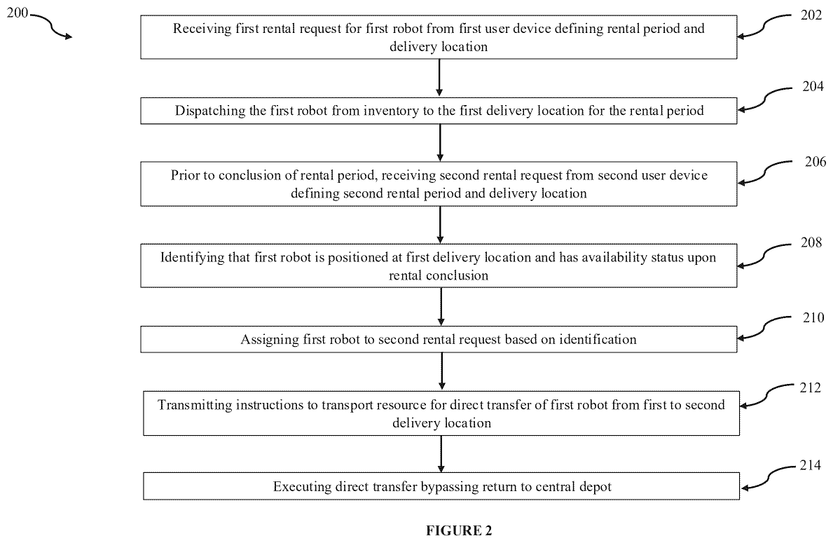

In some exemplary embodiments of the present invention, reference is made to FIG. 2 illustrating a non-limiting example of a method 200 for managing direct transfer of robots between consecutive rental assignments in an on-demand robot rental system. At step 202, the method includes receiving first rental request for first robot from first user device defining rental period and delivery location. In an exemplary embodiment of the present invention, the first rental request processing may encompass comprehensive customer service management including multi-channel request reception through mobile applications and web portals, detailed rental specifications with robot type requirements and functional capabilities, delivery logistics coordination with precise location specifications, temporal scheduling with flexible rental duration options, and customer authentication and verification procedures for secure service delivery.

In some exemplary embodiments of the present invention, the first rental request may be processed through intake systems including real-time availability checking for immediate service confirmation, dynamic pricing calculation based on demand conditions, customer profile integration for personalized service delivery, payment authorization and security verification, or service level agreement establishment for quality assurance and customer satisfaction.

In some exemplary embodiments of the present invention, the first user device may comprise various customer interface technologies including smartphone applications with native iOS and Android support, tablet interfaces optimized for enhanced user experience, web-based portals with responsive design capabilities, voice-activated interfaces for hands-free ordering, or IoT-enabled devices for automated rental triggering based on predefined conditions.

In some exemplary embodiments of the present invention, the rental period definition may include flexible timing options such as hourly rentals for short-term usage, daily rentals for extended projects, weekly or monthly rentals for ongoing needs, seasonal rentals for specific time periods, or custom duration arrangements for specialized customer requirements with automatic extension options.

In some exemplary embodiments of the present invention, the delivery location specification may encompass comprehensive geographic information including GPS coordinates with precision requirements, structured address data with building access codes, landmark-based descriptions for areas without formal addressing, accessibility requirements for specialized delivery needs, or geofenced areas for flexible pickup locations.

At step 204, the method includes dispatching the first robot from inventory to the first delivery location for the rental period. In an exemplary embodiment of the present invention, the robot dispatch system may implement comprehensive logistics management including inventory allocation algorithms for optimal robot selection, transportation resource coordination for efficient delivery, real-time tracking systems for delivery monitoring, customer notification systems for arrival updates, and quality assurance procedures for robot condition verification. The system may further include dynamic re-allocation or re-optimization capabilities, allowing an assignment to be modified prior to the rental time to reduce delivery costs or to address contingencies, such as an allocated robot becoming damaged, inoperable, or unfavorably located.

In some exemplary embodiments of the present invention, the inventory management may utilize advanced allocation algorithms including proximity-based selection for minimized transportation costs, capability matching for customer requirement fulfilment, health assessment verification for operational readiness, availability optimization for maximum fleet utilization, or predictive allocation based on anticipated demand patterns.

In some exemplary embodiments of the present invention, the dispatch process may include comprehensive preparation procedures such as robot functionality testing and calibration, battery charging verification and energy optimization, software updates and configuration customization, cleaning and sanitization protocols for customer safety, or accessory installation based on rental specifications.

In some exemplary embodiments of the present invention, the transportation coordination may encompass various delivery methods including dedicated delivery vehicles with specialized robot handling equipment, third-party logistics partnerships for extended coverage, autonomous delivery systems for cost-effective service, drone delivery networks for rapid deployment, or customer pickup options for flexible service delivery.

At step 206, the method includes receiving second rental request from second user device defining second rental period and delivery location prior to conclusion of first rental period. In an exemplary embodiment of the present invention, the overlapping rental request processing may implement advanced scheduling algorithms including predictive availability analysis, temporal optimization for seamless service transitions, resource allocation planning for continuous utilization, customer communication coordination for delivery scheduling, and contingency planning for potential service conflicts.

In some exemplary embodiments of the present invention, the second rental request processing may include advanced timing coordination such as early notification systems for pending rental conclusions, flexible scheduling options for customer convenience, priority booking systems for premium customers, alternative robot recommendations for immediate availability, or waitlist management for high-demand periods.

In some exemplary embodiments of the present invention, the second user device interaction may encompass comprehensive customer service including real-time availability updates, transparent pricing information with dynamic adjustments, delivery time estimates with traffic integration, customer service support for complex requirements, or loyalty program benefits for repeat customers.

In some exemplary embodiments of the present invention, the second rental period coordination may implement overlap management including buffer time calculation for service transitions, cleaning and inspection scheduling between rentals, maintenance window integration for robot servicing, customer flexibility accommodation for timing adjustments, or automated rescheduling for operational optimization.

At step 208, the method includes identifying that first robot is positioned at first delivery location and has availability status upon rental conclusion. In an exemplary embodiment of the present invention, the robot identification and availability assessment system may implement real-time monitoring including GPS tracking and Real-Time Kinematic (RTK) positioning for precise location verification with centimeter-level accuracy, operational status monitoring for health assessment, customer rental monitoring for completion prediction, availability forecasting for service planning, and automated system integration for seamless transitions. In certain embodiments, the system may utilize RTK-GPS technology to achieve high-precision positioning, which may be particularly advantageous for indoor-outdoor transition tracking, precise drop-off location verification, geofenced area monitoring, or multi-robot coordination in dense deployment environments. The RTK positioning system may operate in conjunction with base station networks or virtual reference station (VRS) systems to provide differential corrections that enhance location accuracy beyond standard GPS capabilities.

In some exemplary embodiments of the present invention, the robot positioning identification may utilize various tracking technologies including high-precision GPS systems, often augmented with Real-Time Kinematic (RTK) corrections for location accuracy, cellular triangulation for urban environment coverage, Wi-Fi positioning for indoor location tracking, IoT sensor networks for environmental monitoring, or hybrid positioning systems combining multiple technologies for reliability.

In some exemplary embodiments of the present invention, the availability status determination may encompass comprehensive assessment including rental period monitoring for completion timing, customer usage patterns for early return prediction, maintenance schedule integration for service availability, health parameter evaluation for operational readiness, or regulatory compliance verification for continued operation.

In some exemplary embodiments of the present invention, the identification system may implement automated verification including location based verification for immutable records, smart contract integration for automated availability triggers, IoT connectivity for real-time status updates, machine learning algorithms for availability prediction, or distributed ledger systems for transparent tracking.

At step 210, the method includes assigning first robot to second rental request based on identification. In an exemplary embodiment of the present invention, the robot assignment system may implement matching algorithms including multi-objective optimization balancing proximity, capability, and cost factors, machine learning models for optimal assignment decisions, constraint satisfaction solving for complex requirements, real-time optimization for dynamic conditions, and customer satisfaction prediction for service quality assurance.

In some exemplary embodiments of the present invention, the assignment decision may consider various optimization criteria including geographic proximity for minimized transportation costs, robot capability matching for customer requirement fulfilment, service continuity for operational efficiency, customer preference accommodation for satisfaction, or strategic positioning for future demand optimization.

In some exemplary embodiments of the present invention, the assignment algorithms may implement advanced techniques including genetic algorithms for evolutionary optimization, simulated annealing for global solution finding, particle swarm optimization for distributed problem solving, reinforcement learning for adaptive assignment strategies, or hybrid approaches combining multiple optimization methods for robust performance.

In some exemplary embodiments of the present invention, the assignment process may include verification procedures such as capability compatibility confirmation, service level requirement validation, insurance and liability verification, customer authorization checks, or regulatory compliance assessment for operational approval.

At step 212, the method includes transmitting instructions to transport resource for direct transfer of first robot from first to second delivery location. In an exemplary embodiment of the present invention, the direct transfer coordination may implement comprehensive logistics management including route optimization for efficient transportation, resource allocation for optimal service delivery, real-time coordination for dynamic conditions, customer communication for transparent service, and exception handling for unexpected situations.

In some exemplary embodiments of the present invention, the transport resource selection may consider various factors including vehicle capacity for robot transportation requirements, geographic coverage for service area accessibility, cost efficiency for operational optimization, reliability based on historical performance, availability for immediate or scheduled dispatch, or specialized equipment for safe robot handling.

In some exemplary embodiments of the present invention, the instruction transmission may include comprehensive operational details such as pickup location coordinates with access instructions, delivery location specifications with customer contact information, handling requirements for robot protection, timing coordination for user availability, or emergency procedures for unexpected complications.

In some exemplary embodiments of the present invention, the direct transfer optimization may implement advanced logistics including traveling salesman problem solving for route efficiency, vehicle routing with time windows for scheduling optimization, capacity planning for resource utilization, traffic pattern integration for timing accuracy, or weather condition consideration for safe transportation.

At step 214, the method includes executing direct transfer bypassing return to central depot. In an exemplary embodiment of the present invention, the depot bypass system may implement comprehensive efficiency optimization including cost reduction through eliminated intermediate transportation, time savings for faster customer service, resource utilization improvement for fleet optimization, environmental impact reduction through minimized transportation, and customer satisfaction enhancement through expedited service delivery.

In some exemplary embodiments of the present invention, the direct transfer execution may include safety protocols such as robot security during transportation, handling procedures for damage prevention, environmental protection for weather exposure, theft prevention measures, or emergency response procedures for incident management.

In some exemplary embodiments of the present invention, the bypass strategy may implement operational benefits including reduced transportation costs through direct routing, improved fleet utilization through continuous deployment, enhanced customer satisfaction through faster service, environmental sustainability through reduced carbon footprint, or competitive advantage through operational efficiency.

In some exemplary embodiments of the present invention, the execution monitoring may include real-time tracking such as GPS monitoring for transfer progress, communication updates from transport resources, milestone notifications for customer updates, exception detection for issue identification, or performance metrics collection for optimization analysis.

In some exemplary embodiments of the present invention, the method concludes the direct transfer process for consecutive robot rental assignments. In an exemplary embodiment of the present invention, the process conclusion may trigger comprehensive evaluation including transfer success assessment, customer satisfaction measurement, operational efficiency analysis, cost-effectiveness evaluation, and continuous improvement planning for service optimization.

In some exemplary embodiments of the present invention, the conclusion may include performance documentation such as transfer completion records, customer satisfaction scores, operational metrics analysis, cost savings calculations, environmental impact assessment, or strategic planning recommendations for future direct transfer optimization and fleet management enhancement.

In some exemplary embodiments of the present invention, the direct transfer methodology described herein with reference to first and second rental requests is exemplary and not limiting. The system may be configured to process and optimize across N rental requests simultaneously, where N may be any positive integer from 1 to the total fleet capacity. Each rental request within the set of N requests may specify requirements for one or more robots of identical, similar, or dissimilar types, and the robot matching module and transportation module may execute multi-objective optimization across the entire request set to determine optimal allocation, routing, and transfer sequences that maximize fleet utilization, minimize transportation costs, and ensure service level compliance across all N requests. The optimization algorithms may implement constraint satisfaction techniques, graph-based matching, or machine learning models trained to handle large-scale multi-request, multi-robot assignment problems with varying temporal, spatial, and capability constraints.

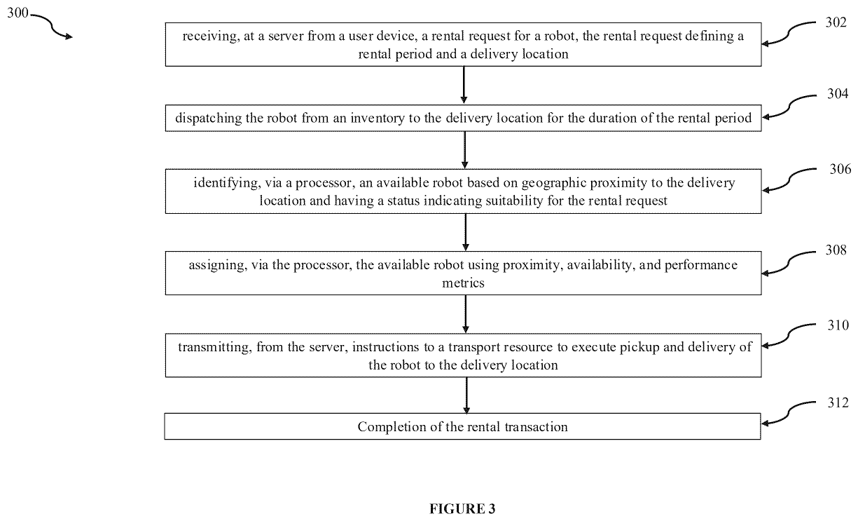

In some exemplary embodiments of the present invention, reference is made to FIG. 3 illustrating a non-limiting example of a method 300 for managing on-demand distribution of one or more robots in a rental system. At step 302, the method includes receiving, at a server from a user device, a rental request for a robot, the rental request defining a rental period and a delivery location. In an exemplary embodiment of the present invention, the rental request may include parameters such as robot type specifications, functional requirements defining capabilities needed for customer tasks, performance parameters specifying operational characteristics the robot must satisfy during the rental period, duration specifications, delivery location coordinates, preferred delivery time windows, and user identification information.

In some exemplary embodiments of the present invention, the rental request may be processed through a frontend application interface that communicates with the entire software ecosystem managing the on-demand commercial rental, distribution, management and storage of autonomous robots.

In some exemplary embodiments of the present invention, the frontend application may comprise one or more of an iOS frontend application, an Android frontend application, a web-based frontend application, a virtual reality frontend application, an augmented reality frontend application, a voice-activated interface, a brain-computer interface (BCI) frontend application, or combinations thereof or combinations thereof.

In some exemplary embodiments of the present invention, the rental request may include robot type requirements defining functional capabilities needed for customer tasks including but not limited to, household cleaning operations, food delivery services, security monitoring functions, entertainment and companionship services, industrial automation tasks, healthcare assistance operations, educational support functions, or combinations thereof. Alternatively, the rental request may be task-based, wherein a user specifies a desired task or outcome (e.g., “clean the dishes”) rather than a specific robot type. In this embodiment, the system is configured to analyze the task, which may involve natural language processing (NLP) capabilities, such as those provided by Large Language Models (LLMs), select the most appropriate robot from the inventory, and automatically configure the robot to execute the specified task upon delivery.

In some exemplary embodiments of the present invention, the robot type specifications may include size parameters defining physical dimensions required for specific operational environments, weight capacity specifications for carrying or moving objects, battery life requirements for extended operational periods, mobility specifications for navigating different terrain types, or environmental operating condition requirements.

In some exemplary embodiments of the present invention, the rental request may be received through a microservice-based architecture comprising multiple backend services including a database module for storing necessary operational data and user information, an inventory module for checking real-time availability of robots, batteries, accessories, and supporting infrastructure, a deployment module acting as an orchestrator for robot deployment operations, an insurance module for performing risk assessments and insurance calculations, a pricing module for calculating dynamic rental costs, a payment module for executing secure financial transactions including charges and refunds, and an admin module for internal tracking, monitoring, and control operations.

In some exemplary embodiments of the present invention, the rental request may include delivery location coordinates specified using GPS coordinates, street addresses, building identifiers, floor specifications, room numbers, landmark references, or geofenced area definitions. In some exemplary embodiments of the present invention, the delivery location may be verified through address validation services, geographic information systems, real-time location verification protocols, or customer-provided location confirmation.

In some exemplary embodiments of the present invention, the rental request may include rental period specifications such as hourly rentals, daily rentals, weekly rentals, monthly rentals, seasonal rentals, or custom duration periods. In some exemplary embodiments of the present invention, the rental period may include specific start times, end times, time zone specifications, recurring rental schedules, or flexible duration options with early return or extension capabilities. The system may additionally apply constraints to the rental period, such as imposing maximum duration limits (e.g., requiring a specific robot type to be rented for less than two weeks) or minimum rental times, based on robot availability, maintenance schedules, or operational policies.

In some exemplary embodiments of the present invention, the rental request may include preferred delivery time windows specifying earliest acceptable delivery times, latest acceptable delivery times, priority delivery options, same-day delivery requests, scheduled future deliveries, or recurring delivery schedules.

In some exemplary embodiments of the present invention, the time specifications may be processed through scheduling algorithms that optimize delivery routes, minimize transportation costs, and maximize fleet utilization efficiency.

In some exemplary embodiments of the present invention, the server may comprise a distributed computing architecture implemented using cloud computing services including Amazon Web Services, Microsoft Azure, Google Cloud Platform, IBM Cloud, Oracle Cloud, or combinations thereof.

In some exemplary embodiments of the present invention, the server infrastructure may include load balancing systems for distributing computational load, auto-scaling capabilities for handling varying demand levels, fault tolerance mechanisms for ensuring system reliability, disaster recovery protocols for business continuity, and security systems for protecting user data and system integrity.

In some exemplary embodiments of the present invention, the user device may comprise one or more of a smartphone device, tablet device, laptop computer, desktop computer, smart watch, voice-activated device such as Amazon Alexa or Google Assistant, augmented reality device, virtual reality device, smart television, or Internet of Things (IoT) enabled device.

In some exemplary embodiments of the present invention, the user device may communicate with the server through secure communication protocols including HTTPS encryption, TLS security protocols, OAuth authentication systems, multi-factor authentication, biometric authentication, or blockchain-based authentication systems.

At step 304, the method includes dispatching the robot from an inventory to the delivery location for the duration of the rental period. In an exemplary embodiment of the present invention, the dispatching process may utilize a comprehensive inventory management system that tracks robot availability, location, operational status, and capability profiles across multiple inventory locations including warehouse, regional distribution centers, local storage facilities, or third-party partner locations.

In some exemplary embodiments of the present invention, the inventory may comprise multiple storage and distribution facilities strategically located to optimize delivery times and transportation costs. In some exemplary embodiments of the present invention, the inventory locations may include central warehouses for long-term storage and maintenance, regional distribution centers for area coverage, local micro-depots or staging areas for rapid deployment, mobile inventory units for dynamic positioning, or partner facilities for extended geographic coverage.

The entirety of these assets comprises the rental fleet. Furthermore, the system is configured to monitor the delivery process in real-time and execute automated exception handling, such as dynamic rerouting of delivery vehicles or dispatching a recovery robot or vehicle, in the event of a delivery failure or inability of the driver to complete the final delivery stage.

In some exemplary embodiments of the present invention, the central warehouses or depots may be referred to as a robot's home location. This home location may function as the primary base for a robot, where it is stored long-term, undergoes major maintenance, and is registered within the inventory. This is distinct from local micro-depots or temporary staging areas, which are used for short-term, dynamic pre-positioning to meet immediate regional demand.

In some exemplary embodiments of the present invention, the dispatching process may include pre-dispatch preparation procedures such as robot functionality testing, battery charging verification, software updates installation, cleaning and sanitization protocols, accessory attachment, configuration customization based on rental requirements, or quality assurance inspections. In some exemplary embodiments of the present invention, the preparation procedures may be customized based on robot type, customer requirements, rental duration, or previous usage history.

In some exemplary embodiments of the present invention, the dispatching may utilize various transportation methods including dedicated delivery vehicles, third-party logistics providers, autonomous delivery systems, drone delivery networks, courier services, or customer pickup options. In some exemplary embodiments of the present invention, the transportation method selection may be based on factors such as delivery location, robot size and weight, delivery urgency, transportation costs, environmental conditions, or customer preferences.

In some exemplary embodiments of the present invention, the dispatching process may include real-time tracking and monitoring systems that provide visibility into robot location, transportation status, estimated delivery times, and potential delays or issues.

In some exemplary embodiments of the present invention, the tracking systems may utilize GPS tracking, cellular communication, IoT sensors, barcode scanning, RFID technology, or blockchain-based tracking for supply chain transparency.

In some exemplary embodiments of the present invention, the dispatching may include coordination with delivery personnel or automated systems including driver assignment, route optimization, delivery instructions, customer contact information, special handling requirements, or emergency procedures.

In some exemplary embodiments of the present invention, the coordination may be automated through dispatching algorithms that consider multiple factors such as personnel availability, vehicle capacity, traffic conditions, and delivery priorities.

At step 306, the method includes identifying, via a processor, an available robot based on geographic proximity to the delivery location and having a status indicating suitability for the rental request. In an exemplary embodiment of the present invention, the identification process may utilize advanced matching algorithms that evaluate multiple criteria including location proximity, robot availability, capability compatibility, and performance metrics to select the optimal robot for each rental request.

In some exemplary embodiments of the present invention, the processor may comprise one or more central processing units (CPUs), graphics processing units (GPUs) for parallel processing, field-programmable gate arrays (FPGAs) for specialized computations, application-specific integrated circuits (ASICs) for optimized performance, tensor processing units (TPUs) for machine learning workloads, or quantum processing units (QPUs) for advanced computational tasks. In some exemplary embodiments of the present invention, the processor may implement distributed computing architectures, edge computing capabilities, or hybrid cloud-edge processing systems.

In some exemplary embodiments of the present invention, the geographic proximity analysis may utilize various distance calculation methods including Euclidean distance formulas for straight-line measurements, Manhattan distance calculations for grid-based routing, Haversine formulas for spherical distance calculations, road network routing algorithms for actual travel distances, or multi-modal transportation route optimization considering various transportation methods.

In some exemplary embodiments of the present invention, the proximity calculations may account for factors such as traffic congestion patterns, road closures and construction, vehicle restrictions and regulations, seasonal accessibility variations, or environmental conditions affecting transportation.

In some exemplary embodiments of the present invention, the status indicating suitability may encompass multiple operational parameters including availability status such as “ready for deployment,” “maintenance completed,” “charged and operational,” or “quality assured,” operational health indicators including battery level above minimum thresholds, system diagnostics showing no critical errors, sensor functionality verification, actuator performance within specifications, or communication system connectivity confirmed.

In some exemplary embodiments of the present invention, the suitability assessment may include predictive analysis based on historical performance data, failure patterns, or maintenance schedules.

In some exemplary embodiments of the present invention, the robot identification process may include capability matching algorithms that verify robot specifications against rental requirements including physical dimensions for space constraints, weight capacity for carrying tasks, battery life for rental duration, mobility features for terrain navigation, sensor arrays for environmental awareness, processing power for computational tasks, communication protocols for connectivity requirements, or specialized attachments for specific functions.

In some exemplary embodiments of the present invention, the identification process may utilize machine learning algorithms trained on historical rental data, customer satisfaction feedback, operational performance metrics, or failure patterns to predict optimal robot-customer matches.

In some exemplary embodiments of the present invention, the machine learning models may include neural networks, decision trees, random forests, support vector machines, clustering algorithms, or ensemble methods for improved prediction accuracy.

At step 308, the method includes assigning, via the processor, the available robot using proximity, availability, and performance metrics. In an exemplary embodiment of the present invention, the assignment process may implement optimization algorithms that balance multiple competing objectives including delivery speed optimization, cost efficiency maximization, service quality assurance, customer satisfaction enhancement, fleet utilization optimization, or environmental impact minimization.

In some exemplary embodiments of the present invention, the proximity metrics used in the assignment process may comprise geographic proximity measurements between the available robot current location and the customer delivery location, transport resource proximity for efficient pickup and delivery operations, maintenance facility proximity for post-rental servicing, and charging infrastructure proximity for battery management.

In some exemplary embodiments of the present invention, the proximity calculations may be weighted based on factors such as transportation costs, delivery urgency, environmental conditions, or operational efficiency targets.

In some exemplary embodiments of the present invention, the availability metrics may include current availability status verification, scheduled availability windows, maintenance calendar integration, charging schedule coordination, and conflict resolution with existing reservations or maintenance requirements.

In some exemplary embodiments of the present invention, the availability assessment may include buffer time calculations for preparation, transportation, and post-rental processing activities.

In some exemplary embodiments of the present invention, the performance metrics may encompass historical performance data including successful deployment rates, customer satisfaction scores, operational uptime percentages, task completion success rates, maintenance frequency indicators, energy efficiency measurements, or safety incident records.

In some exemplary embodiments of the present invention, the performance metrics may be calculated over various time periods such as daily, weekly, monthly, quarterly, or annual averages to identify trends and patterns.

In some exemplary embodiments of the present invention, the assignment algorithms may implement multi-objective optimization techniques including linear programming for resource allocation, genetic algorithms for evolutionary optimization, simulated annealing for global optimization, particle swarm optimization for swarm intelligence, ant colony optimization for pathfinding, or reinforcement learning for adaptive optimization based on environmental feedback.

In some exemplary embodiments of the present invention, the assignment process may include constraint satisfaction algorithms ensuring various operational constraints are met including transport resource capacity limitations, driver working hour regulations and labor law compliance, geographic service area boundaries and coverage limitations, regulatory compliance requirements for robot operations, insurance coverage requirements, or customer-specific constraints and preferences.

In some exemplary embodiments of the present invention, the assignment may include dynamic reallocation capabilities for handling unexpected situations such as transport resource cancellations, robot malfunctions, weather-related delays, traffic incidents, customer rescheduling requests, or emergency situations requiring immediate resource redeployment. In some exemplary embodiments of the present invention, the reallocation may utilize backup resource pools, alternative routing options, or escalation procedures.

At step 310, the method includes transmitting, from the server, instructions to a transport resource to execute pickup and delivery of the robot to the delivery location. In an exemplary embodiment of the present invention, the transmission process may generate comprehensive operational instructions including detailed task sequences, routing information, safety protocols, handling procedures, customer interaction guidelines, and emergency response procedures for transport resource operators.

In some exemplary embodiments of the present invention, the transport resource may be selected from a pool of available resources including company-owned delivery vehicles, third-party logistics partners, independent contractor drivers, autonomous delivery vehicles, drone delivery systems, robotic delivery platforms, or combinations thereof based on factors such as availability, cost efficiency, delivery speed requirements, handling capabilities, or geographic coverage.

In some exemplary embodiments of the present invention, the instructions may include generating detailed task sequences for robot pickup operations including inventory location navigation, robot identification and verification procedures, loading and securing protocols, transportation safety measures, route optimization guidance, delivery location identification, customer contact procedures, unloading and setup instructions, or completion confirmation requirements.

In some exemplary embodiments of the present invention, the routing information transmitted may include optimized travel routes that minimize travel time and operational costs while maintaining service quality standards, safety requirements, regulatory compliance, and customer satisfaction targets.

In some exemplary embodiments of the present invention, the routing information may include turn-by-turn navigation directions, alternative route options, traffic condition updates, checkpoint locations for progress monitoring, estimated arrival times with confidence intervals, or contact information for relevant parties including customers and support personnel.

In some exemplary embodiments of the present invention, the instructions may include comprehensive safety protocols for robot handling during transportation including proper lifting techniques to prevent injury, securing methods to prevent damage during transit, environmental protection measures for weather or hazard exposure, theft prevention procedures, emergency procedures for accidents or incidents, and communication protocols for reporting issues or delays.

In some exemplary embodiments of the present invention, the transmission may include providing exception handling protocols for managing various operational challenges including failed pickup attempts due to access issues, robot malfunctions discovered during pickup, transportation delays due to traffic or weather, delivery location access problems, customer unavailability, equipment damage during transport, or communication system failures.

In some exemplary embodiments of the present invention, the transport resource communication may utilize multiple communication channels including mobile applications for real-time updates, SMS messaging for critical alerts, voice communication for complex coordination, email for detailed instructions and documentation, GPS tracking for location monitoring, or IoT connectivity for automated status reporting.

In some exemplary embodiments of the present invention, the method may include real-time monitoring of the pickup and delivery process through tracking systems that provide visibility into transport resource location, robot status, delivery progress, estimated completion times, and identification of potential issues or delays. In some exemplary embodiments of the present invention, the monitoring may trigger automated customer notifications, internal alerts for operational issues, or escalation procedures for service recovery.

In some exemplary embodiments of the present invention, the pickup and delivery execution may include quality assurance procedures such as robot functionality verification before pickup, condition documentation through photos or videos, customer delivery confirmation with digital signatures, post-delivery functionality testing, or customer satisfaction surveys for continuous improvement.

At step 312, the method includes completing the rental transaction and ending the process. In an exemplary embodiment of the present invention, the completion may include various finalization procedures such as customer confirmation of successful delivery, payment processing and settlement, rental agreement activation, insurance policy initiation, customer onboarding and orientation, monitoring system activation, or customer support availability confirmation.

In some exemplary embodiments of the present invention, the rental transaction completion may include payment processing through integrated financial service modules that perform real-time authorization verification for customer payment methods, automated billing calculations based on rental terms and dynamic pricing, electronic settlement processes for secure fund transfers, tax calculations for compliance requirements, or invoice generation for customer records.

In some exemplary embodiments of the present invention, the completion process may include security deposit processing including authorization of deposit amounts against customer financial accounts, establishment of hold periods for damage assessment, automated release procedures upon successful rental conclusion, or dispute resolution processes for contested charges.

In some exemplary embodiments of the present invention, the method may include activating ongoing monitoring and support services such as 24/7 customer support availability, technical assistance for robot operation, maintenance scheduling and coordination, performance monitoring and optimization, usage analytics and reporting, or proactive issue identification and resolution.

In some exemplary embodiments of the present invention, the rental completion may include documentation and record-keeping procedures such as rental agreement archival, transaction history maintenance, customer interaction logging, operational metrics recording, compliance documentation for regulatory requirements, or data analytics preparation for business intelligence and process improvement.

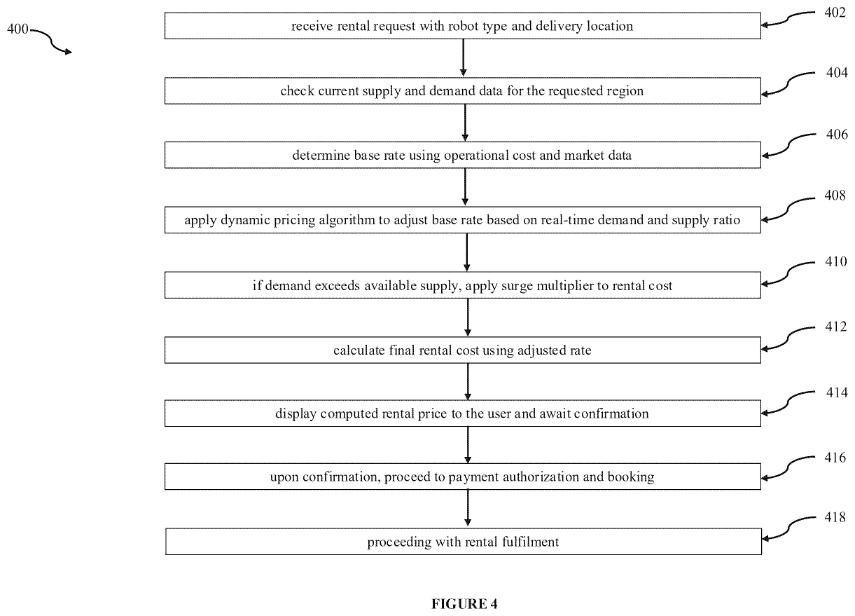

In some exemplary embodiments of the present invention, Reference is made to FIG. 4 illustrating a non-limiting example of a method 400 for implementing dynamic pricing algorithms in an on-demand robot rental system. At step 402, the method includes receiving a rental request with robot type and delivery location specifications. In an exemplary embodiment of the present invention, the rental request may include comprehensive parameters such as specific robot type requirements, functional capability specifications, delivery location coordinates with precision requirements, rental duration parameters, performance specifications, environmental operating conditions, and customer preference indicators.

In some exemplary embodiments of the present invention, the rental request reception may be processed through a multi-channel interface system supporting various customer touchpoints including mobile applications for iOS and Android platforms, web-based portals with responsive design, voice-activated interfaces compatible with Amazon Alexa and Google Assistant, chatbot systems with natural language processing, API endpoints for third-party integrations, or IoT device interfaces for smart home automation systems.

In some exemplary embodiments of the present invention, the request processing may include input validation, data sanitization, format standardization, and initial feasibility assessment.

In some exemplary embodiments of the present invention, the robot type specifications may encompass a comprehensive taxonomy of robot categories including household service robots for cleaning and maintenance tasks, delivery robots for logistics and transportation services, security robots for surveillance and monitoring applications, healthcare assistant robots for patient care and medical support, entertainment robots for recreational and social interaction, industrial robots for specialized manufacturing or construction tasks, educational robots for learning and development activities, or hybrid multi-purpose robots capable of performing various functions.

In some exemplary embodiments of the present invention, the delivery location specifications may include detailed geographic information such as GPS coordinates with accuracy specifications, street addresses with apartment or unit numbers, building access codes and entry procedures, parking availability and restrictions, elevator access requirements, specific room or area designations, geographic constraints such as urban versus rural locations, or accessibility requirements for robot deployment and operation.

In some exemplary embodiments of the present invention, the rental request may include temporal specifications such as immediate delivery requirements, scheduled future delivery appointments, recurring rental patterns for regular customers, seasonal usage preferences, flexible timing with acceptable delivery windows, or priority service level selections. In some exemplary embodiments of the present invention, the temporal processing may account for time zone differences, daylight saving time adjustments, holiday schedules, or regional business hour variations.

At step 404, the method includes checking current supply and demand data for the requested region. In an exemplary embodiment of the present invention, the supply and demand analysis may utilize comprehensive data sources including real-time robot availability across multiple inventory locations, historical demand patterns for the specific geographic region, current active rentals and their projected completion times, transportation resource availability and capacity, seasonal demand fluctuations, and regional market conditions affecting pricing and availability.

In some exemplary embodiments of the present invention, the supply data collection may encompass robot inventory levels across multiple storage and distribution facilities including central warehouses with large-capacity storage, regional distribution centers for area coverage, local micro-depots for rapid deployment, mobile inventory units for dynamic positioning, third-party partner facilities for extended coverage, or customer return locations for efficient fleet redistribution. In some exemplary embodiments of the present invention, the supply tracking may include real-time status monitoring, maintenance schedules, charging requirements, and transportation logistics coordination.

In some exemplary embodiments of the present invention, the demand data analysis may incorporate multiple data sources and analytical methods including historical rental patterns with seasonal adjustments, current active rental requests and their duration, pending reservations and their timing, demographic analysis of customer base in the region, economic indicators affecting consumer spending, local events or activities driving demand spikes, weather conditions impacting robot usage patterns, or competitive analysis of alternative service providers.

In some exemplary embodiments of the present invention, the regional analysis may be conducted at various geographic scales including neighborhood-level micro-analysis for hyperlocal demand patterns, city-wide analysis for urban market dynamics, metropolitan area analysis for regional trends, state or province-level analysis for regulatory and economic factors, or national analysis for strategic planning and resource allocation. In some exemplary embodiments of the present invention, the geographic segmentation may account for population density, economic demographics, technological adoption rates, or infrastructure capabilities.

In some exemplary embodiments of the present invention, the supply and demand checking may utilize advanced analytics including machine learning algorithms trained on historical data, predictive modeling for demand forecasting, time series analysis for trend identification, clustering algorithms for market segmentation, correlation analysis for factor identification, or ensemble methods combining multiple analytical approaches for improved accuracy.

At step 406, the method includes determining a base rate using operational cost and market data. In an exemplary embodiment of the present invention, the base rate calculation may incorporate comprehensive cost analysis including robot acquisition and depreciation costs, maintenance and repair expenses, insurance and liability costs, storage and warehousing expenses, transportation and logistics costs, personnel and operational overhead, technology infrastructure costs, and regulatory compliance expenses.

In some exemplary embodiments of the present invention, the operational cost analysis may include direct costs specifically attributable to robot operations and rental transactions such as robot purchase or lease costs amortized over expected service life, battery replacement and charging costs based on usage patterns, cleaning and sanitization expenses between rentals, customer support costs, delivery fees, payment processing fees, software licensing fees for robot operating systems and applications, sensor calibration and replacement costs, or specialized equipment and accessory costs for specific robot functions.

In some exemplary embodiments of the present invention, the operational cost calculation may include indirect costs supporting the overall service delivery including facility rental or ownership costs for storage and distribution centers, utility costs for power, heating, cooling, and lighting, personnel salaries and benefits for operational staff, management, and support functions, insurance premiums for liability, property, and business interruption coverage, marketing and customer acquisition expenses, or technology development and maintenance costs.

In some exemplary embodiments of the present invention, the market data analysis may incorporate competitive intelligence including pricing strategies of direct competitors offering similar robot rental services, substitute service pricing for alternative solutions, market positioning analysis for premium or budget service tiers, customer willingness-to-pay studies based on market research, economic indicators affecting disposable income and spending patterns, or regulatory changes impacting cost structure or pricing flexibility.

In some exemplary embodiments of the present invention, the base rate determination may utilize financial modeling techniques including activity-based costing for accurate cost allocation, discounted cash flow analysis for long-term profitability assessment, sensitivity analysis for key variable impact assessment, scenario modeling for various market conditions, break-even analysis for pricing floor determination, or return on investment calculations for strategic decision-making.

At step 408, the method includes applying dynamic pricing algorithms to adjust the base rate based on real-time demand and supply ratios. In an exemplary embodiment of the present invention, the dynamic pricing algorithms may implement mathematical models including demand elasticity calculations, supply constraint optimization, market equilibrium analysis, consumer surplus maximization, revenue optimization techniques, and competitive response modeling to achieve optimal pricing outcomes.

In some exemplary embodiments of the present invention, the dynamic pricing algorithms may incorporate multiple algorithmic approaches including linear programming for optimization under constraints, machine learning models such as neural networks for pattern recognition and prediction, genetic algorithms for evolutionary optimization, fuzzy logic systems for handling uncertainty and imprecision, reinforcement learning for adaptive pricing based on market feedback, or ensemble methods combining multiple approaches for robust performance.

In some exemplary embodiments of the present invention, the real-time demand analysis may consider multiple demand indicators including current request volume and rate of change, pending requests awaiting fulfilment, historical demand patterns for similar time periods, seasonal adjustments based on calendar effects, local event impacts such as conferences or festivals, weather condition effects on robot usage, economic news or events affecting consumer spending, or demographic shifts in the target market.

In some exemplary embodiments of the present invention, the supply ratio calculations may account for available robot inventory levels, transportation capacity constraints, personnel availability for deployment operations, maintenance schedule impacts on availability, geographic distribution of supply relative to demand, battery charging infrastructure capacity, or third-party partner resource availability for extended service coverage.

In some exemplary embodiments of the present invention, the pricing adjustment algorithms may implement various pricing strategies including penetration pricing for market entry, premium pricing for high-value services, psychological pricing using pricing anchors and references, bundling strategies for multiple service combinations, loyalty pricing for repeat customers, or dynamic segmentation pricing based on customer characteristics and behavior patterns.

At step 410, the method includes applying a surge multiplier (also referred to as a demand multiplier) to the rental cost if demand exceeds available supply. In an exemplary embodiment of the present invention, the surge pricing mechanism may implement carefully designed algorithms that balance revenue optimization with customer satisfaction, market positioning, and long-term business sustainability while ensuring transparent communication of pricing changes to customers.

In some exemplary embodiments of the present invention, the demand-supply comparison may utilize threshold algorithms including absolute shortage calculations based on inventory levels versus request volume, relative shortage assessments considering normal demand patterns, time-based shortage analysis accounting for rental duration overlap, geographic shortage evaluation for location-specific imbalances, or predictive shortage modelling based on trend analysis and forecasting. This comparison may be performed based on the total demand within a geographic region, and/or for a specific robot type specification, allowing the system to create a surge price in response to high demand for a particular robot model even if other models are available.

In some exemplary embodiments of the present invention, the surge multiplier calculation may incorporate multiple factors including severity of supply shortage with graduated multiplier levels, duration of expected shortage based on supply replenishment forecasts, historical customer response to surge pricing for demand elasticity estimation, competitive pricing analysis to maintain market competitiveness, customer segment analysis for differentiated pricing strategies, or regulatory constraints on maximum pricing increases.

In some exemplary embodiments of the present invention, the surge pricing implementation may include customer communication protocols such as advance notification of potential surge periods, transparent explanation of surge pricing rationale, alternative timing suggestions for cost-conscious customers, waitlist options for customers preferring regular pricing, or loyalty program benefits to offset surge pricing impact for valued customers.

In some exemplary embodiments of the present invention, the surge multiplier may be implemented with various constraint mechanisms including maximum multiplier caps to prevent excessive pricing, gradual multiplier increases to allow customer adaptation, time-limited surge periods to maintain fairness, geographic limitations to surge areas with actual shortages, or customer segment exemptions for essential services or vulnerable populations.

At step 412, the method includes calculating the final rental cost using the adjusted rate. In an exemplary embodiment of the present invention, the final cost calculation may incorporate all relevant pricing components including the base rate derived from operational costs, dynamic pricing adjustments based on supply and demand conditions, surge multipliers if applicable, taxes and regulatory fees, insurance components, and any applicable discounts or promotions.

In some exemplary embodiments of the present invention, the final cost calculation may include comprehensive fee structures such as rental fees based on duration and robot type, delivery fees calculated based on distance and transportation costs, setup fees for robot configuration and customer orientation, cleaning fees for post-rental sanitization, insurance fees based on risk assessment and coverage levels, damage deposit calculations based on robot value and customer risk profile, or convenience fees for premium service features.

In some exemplary embodiments of the present invention, the cost calculation may incorporate discount mechanisms including volume discounts for extended rental periods, loyalty discounts for repeat customers, promotional discounts for new customer acquisition, seasonal discounts for off-peak periods, bundle discounts for multiple robot rentals, referral discounts for customer recommendations, or corporate discounts for business accounts.

In some exemplary embodiments of the present invention, the final pricing may include transparency features such as itemized cost breakdowns showing each pricing component, comparison with standard pricing to highlight dynamic adjustments, total cost summaries with clear payment terms, alternative pricing options for different service levels, or cost estimation tools for future rental planning.

At step 414, the method includes displaying the computed rental price to the user and awaiting confirmation. In an exemplary embodiment of the present invention, the price display interface may provide comprehensive pricing information, payment options, service details, terms and conditions, and interactive elements allowing customers to modify their rental requirements and observe pricing impacts in real-time.

In some exemplary embodiments of the present invention, the price display may utilize user experience optimization techniques including clear visual hierarchy for pricing information, prominent display of total costs with breakdown availability, comparison tools showing price differences for various options, mobile-responsive design for cross-device accessibility, accessibility features for users with disabilities, or multilingual support for diverse customer bases.

In some exemplary embodiments of the present invention, the price confirmation interface may include interactive elements such as rental modification options allowing customers to adjust duration, delivery time, or robot type to see pricing impacts, alternative suggestion engines recommending lower-cost options, price alert systems for customers preferring to wait for better pricing, or savings calculators showing cost benefits of different rental strategies.

In some exemplary embodiments of the present invention, the user interface may provide comprehensive service information including detailed robot specifications and capabilities, estimated delivery timeframes with tracking information, customer support contact information, cancellation and modification policies, insurance coverage details, or user guides and tutorials for robot operation.

At step 416, the method includes proceeding to payment authorization and booking upon customer confirmation. In an exemplary embodiment of the present invention, the payment and booking process may implement comprehensive financial transaction management including secure payment processing, fraud detection, customer authentication, booking confirmation, inventory allocation, and service delivery coordination.

In some exemplary embodiments of the present invention, the payment authorization may utilize multiple secure payment methods including credit and debit card processing with PCI DSS compliance, digital wallet integration with services like PayPal, Apple Pay, or Google Pay, cryptocurrency payment options for tech-savvy customers, bank transfer systems for large transactions, installment payment plans for expensive rentals, or corporate billing systems for business accounts.

In some exemplary embodiments of the present invention, the booking process may include comprehensive reservation management such as inventory allocation and hold procedures, delivery scheduling with resource coordination, customer confirmation with booking details, integration with customer relationship management systems, automatic reminder systems for upcoming deliveries, or modification and cancellation processing capabilities.

In some exemplary embodiments of the present invention, the payment processing may incorporate fraud detection and security measures including machine learning algorithms for transaction pattern analysis, device fingerprinting for identity verification, geolocation verification for transaction authenticity, velocity checking for unusual transaction patterns, blacklist screening against known fraudulent accounts, or multi-factor authentication for high-value transactions.

At step 418, the method concludes the dynamic pricing process and proceeds with rental fulfilment. In an exemplary embodiment of the present invention, the process conclusion may trigger various downstream operations including inventory management updates, deployment scheduling, customer communication, payment settlement, performance monitoring, and continuous improvement data collection for algorithm optimization.

In some exemplary embodiments of the present invention, the conclusion may include comprehensive audit trail generation for transaction history, pricing decision documentation, customer interaction logging, system performance metrics collection, regulatory compliance record-keeping, or business intelligence data preparation for strategic analysis and pricing algorithm improvement.

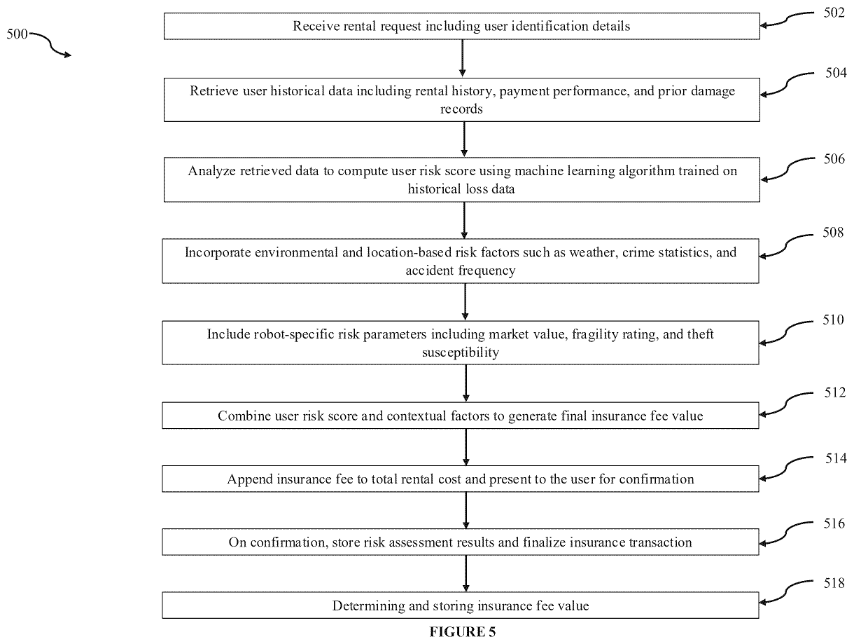

In some exemplary embodiments of the present invention, reference is made to FIG. 5 illustrating a non-limiting example of a method 500 for calculating insurance fees in an on-demand robot rental system based on comprehensive risk assessment. At step 502, the method includes receiving a rental request including user identification details. In an exemplary embodiment of the present invention, the rental request reception may encompass comprehensive user identification and authentication processes including personal identification verification, contact information validation, financial account verification, identity document authentication, and behavioral biometric analysis for fraud prevention.

In some exemplary embodiments of the present invention, the user identification details may comprise multiple layers of identity verification including government-issued identification such as driver's licenses, passports, or national identity cards, biometric authentication using fingerprints, facial recognition, or voice patterns, digital identity verification through social media profiles or digital footprint analysis, financial identity confirmation through bank account verification or credit checks, or multi-factor authentication combining multiple identification methods for enhanced security.

In some exemplary embodiments of the present invention, the rental request processing may utilize advanced security protocols including encrypted data transmission using TLS or SSL protocols, secure data storage with encryption at rest, identity verification APIs integrated with government databases or credit agencies, fraud detection algorithms analyzing request patterns and user behavior, geolocation verification to confirm user location authenticity, or device fingerprinting to identify potential fraudulent devices or accounts.

In some exemplary embodiments of the present invention, the user identification system may implement privacy protection measures including data minimization principles collecting only necessary information, consent management systems allowing users to control data usage, anonymization techniques for sensitive personal information, data retention policies with automatic deletion schedules, compliance with privacy regulations such as GDPR or CCPA, or user rights management for data access and correction requests.

In some exemplary embodiments of the present invention, the identification details may include demographic information such as age for risk profiling, geographic location for regional risk assessment, occupation or profession for liability considerations, rental purpose specification for usage-based risk evaluation, emergency contact information for safety protocols, or accessibility requirements for specialized service accommodations.

At step 504, the method includes retrieving user historical data including rental history, payment performance, and prior damage records. In an exemplary embodiment of the present invention, the historical data retrieval may access comprehensive databases containing longitudinal user information spanning multiple rental transactions, payment interactions, customer service encounters, damage incidents, insurance claims, and behavioral patterns to construct detailed user risk profiles.

In some exemplary embodiments of the present invention, the rental history analysis may encompass detailed transaction records including total number of previous rentals across different time periods, types of robots rented with frequency analysis, rental durations and usage patterns, geographic locations of rentals, seasonal rental patterns, early returns or extensions, cancellation history with reasons, or customer feedback and satisfaction scores from previous rentals.

In some exemplary embodiments of the present invention, the payment performance evaluation may include comprehensive financial behavior analysis such as payment method preferences and reliability, payment timing patterns including on-time payments versus late payments, payment failure history with reasons and resolution patterns, chargeback or dispute history, refund processing history, security deposit interactions, or credit utilization patterns for customers using credit-based payments.

In some exemplary embodiments of the present invention, the prior damage records may encompass detailed incident documentation including damage type classification such as mechanical damage, cosmetic damage, software issues, or theft incidents, damage severity levels with cost implications, damage cause analysis including user error, environmental factors, or manufacturing defects, repair costs and timelines, insurance claim processing history, or damage prevention measures taken by users.

In some exemplary embodiments of the present invention, the historical data retrieval may utilize advanced data management systems including distributed databases for scalable data storage, data warehousing solutions for analytical processing, real-time data streaming for up-to-date information, data quality management ensuring accuracy and completeness, data integration from multiple sources including payment processors and insurance providers, or data archival systems for long-term historical analysis.

In some exemplary embodiments of the present invention, the historical data analysis may incorporate temporal considerations such as recent behavior weighting more heavily than older patterns, seasonal adjustments for usage patterns, trend analysis to identify improving or deteriorating user behavior, lifecycle analysis for customer relationship stages, or predictive modelling to forecast future behavior based on historical patterns.

At step 506, the method includes analyzing retrieved data to compute a user risk score using machine learning algorithms trained on historical loss data. In an exemplary embodiment of the present invention, the risk score computation may utilize machine learning models including supervised learning algorithms trained on labelled historical data, unsupervised learning for pattern discovery, ensemble methods combining multiple algorithms, deep learning neural networks for complex pattern recognition, or reinforcement learning for adaptive risk assessment based on ongoing user interactions.

In some exemplary embodiments of the present invention, the machine learning algorithms may include various model types such as logistic regression for binary risk classification, random forest algorithms for handling complex feature interactions, gradient boosting machines for sequential learning improvement, support vector machines for high-dimensional data processing, neural networks for non-linear pattern recognition, or ensemble methods combining multiple algorithms for improved prediction accuracy and robustness.

In some exemplary embodiments of the present invention, the historical loss data used for training may encompass comprehensive loss event records including financial losses from damage incidents, theft or total loss events, insurance claim payouts, recovery costs and success rates, legal costs from liability incidents, business interruption costs, or customer compensation payments for service failures.

In some exemplary embodiments of the present invention, the risk score computation may incorporate feature engineering techniques including categorical variable encoding for non-numeric data, numerical feature scaling for algorithm compatibility, interaction feature creation to capture complex relationships, dimensionality reduction for computational efficiency, feature selection for identifying most predictive variables, or time-based feature engineering for temporal pattern analysis.

In some exemplary embodiments of the present invention, the machine learning model training may implement advanced techniques including cross-validation for model performance assessment, hyperparameter optimization for algorithm tuning, regularization techniques for overfitting prevention, class balancing for handling imbalanced datasets, online learning for continuous model updating, or transfer learning for leveraging related domain knowledge.

In some exemplary embodiments of the present invention, the user risk score may be calculated as a continuous numerical value, categorical risk level designation, probability distribution over risk categories, confidence interval with uncertainty quantification, or multi-dimensional risk vector capturing different risk aspects such as damage risk, theft risk, payment risk, or operational risk.

At step 508, the method includes incorporating environmental and location-based risk factors such as weather, crime statistics, and accident frequency. In an exemplary embodiment of the present invention, the environmental risk assessment may utilize comprehensive external data sources including meteorological services for weather data, law enforcement agencies for crime statistics, transportation authorities for accident data, geographic information systems for terrain analysis, and environmental monitoring systems for hazard detection.

In some exemplary embodiments of the present invention, the weather risk factors may include current weather conditions such as precipitation, wind speed, temperature extremes, or visibility conditions, weather forecasts for the rental period including storm predictions or severe weather warnings, seasonal weather patterns affecting robot operation, historical weather impact data on robot performance or damage rates, or climate-specific considerations such as humidity, UV exposure, or air quality affecting robot components.

In some exemplary embodiments of the present invention, the crime statistics analysis may encompass various crime categories including theft rates for personal property or vehicles, vandalism incidents in the target area, break-in or burglary statistics for buildings, street crime rates affecting outdoor robot operation, organized crime activity levels, or law enforcement presence and response times affecting recovery probability in case of theft or damage.

In some exemplary embodiments of the present invention, the accident frequency data may include traffic accident statistics for areas where robots may operate, pedestrian accident rates for sidewalk or indoor navigation, construction site accident rates for industrial robot applications, equipment failure rates in similar environments, emergency service response times affecting damage mitigation, or infrastructure reliability data such as power outages or communication failures.

In some exemplary embodiments of the present invention, the location-based risk assessment may consider geographic factors such as urban versus rural environments with different risk profiles, proximity to emergency services for rapid response, accessibility of the location for robot recovery, terrain difficulty affecting robot operation, building security levels for indoor deployments, or neighborhood socioeconomic factors correlated with risk levels.

In some exemplary embodiments of the present invention, the environmental data integration may utilize real-time data feeds including weather APIs for current conditions, crime reporting systems for recent incident data, traffic monitoring systems for current road conditions, social media monitoring for emerging risks or events, news feeds for relevant local events, or IoT sensors for environmental monitoring in real-time.

At step 510, the method includes incorporating robot-specific risk parameters including market value, fragility rating, and theft susceptibility. In an exemplary embodiment of the present invention, the robot-specific risk assessment may evaluate intrinsic characteristics of each robot model including manufacturing cost and current market value, component fragility and repair complexity, theft attractiveness based on resale value and portability, operational complexity affecting user-induced damage risk, and maintenance requirements affecting reliability during rental periods.

In some exemplary embodiments of the present invention, the market value assessment may include original retail price and depreciation schedules, current secondary market value, replacement cost for identical or equivalent models, component value for potential parts theft, collectible or specialty value for rare or limited-edition models, or regional price variations affecting theft attractiveness in different markets.

In some exemplary embodiments of the present invention, the fragility rating may encompass mechanical component vulnerability including joint mechanisms, sensors, or actuators susceptible to damage, environmental sensitivity to moisture, dust, temperature, or electromagnetic interference, software vulnerability to corruption or unauthorized access, battery system fragility and fire risk, or overall build quality and durability ratings based on manufacturer specifications and testing data.

In some exemplary embodiments of the present invention, the theft susceptibility analysis may consider factors such as robot size and weight affecting portability, security features including GPS tracking, remote disable capabilities, or anti-theft alarms, recognizability of the robot model affecting resale difficulty, component modularity enabling partial theft, or historical theft data for similar robot models in comparable environments, and environmental factors such as the current geographic location or influence from recent local or world events that may impact security risks.

In some exemplary embodiments of the present invention, the robot-specific parameters may include operational risk factors such as complexity of user interface affecting misuse probability, safety features and fail-safe mechanisms, autonomous operation capabilities and associated risks, human-robot interaction protocols and safety measures, or specialized function risks such as chemical handling, heavy lifting, or precision operations.

In some exemplary embodiments of the present invention, the robot risk assessment may incorporate manufacturer data including warranty terms and coverage, recall history or known defects, recommended usage guidelines and restrictions, maintenance schedules and requirements, or safety certifications and compliance with relevant standards.

At step 512, the method includes combining user risk score and contextual factors to generate a final insurance fee value. In an exemplary embodiment of the present invention, the fee calculation may utilize mathematical models that integrate multiple risk dimensions including user-specific behavioral risk, environmental and contextual risk factors, robot-specific technical and market risks, temporal risk variations, and interaction effects between different risk categories to produce a comprehensive and fair insurance fee.

In some exemplary embodiments of the present invention, the combination methodology may employ various mathematical approaches including weighted linear combinations where different risk factors are assigned importance weights based on historical correlation with losses, non-linear combinations using polynomial or exponential functions to capture complex risk interactions, machine learning models that learn optimal combination strategies from historical data, or Bayesian methods that incorporate prior knowledge and update risk assessments based on new information.

In some exemplary embodiments of the present invention, the final insurance fee calculation may incorporate business considerations including minimum fee floors to ensure cost coverage, maximum fee caps to maintain market competitiveness, fee structures that encourage safe behavior through discounts for low-risk users, seasonal adjustments for time-varying risks, volume discounts for frequent or long-term users, or promotional pricing for customer acquisition and retention.

In some exemplary embodiments of the present invention, the fee generation may include transparency features such as itemized fee breakdowns showing contribution of different risk factors, comparison with baseline or standard fees to highlight personalization, explanation of fee calculation methodology for customer understanding, sensitivity analysis showing how fee changes with different risk factors, or recommendations for users to reduce their risk profile and associated fees.

In some exemplary embodiments of the present invention, the insurance fee structure may accommodate different coverage levels including basic coverage for essential protection, comprehensive coverage for full protection, premium coverage with additional benefits, or customizable coverage allowing users to select specific protection elements based on their needs and budget constraints.

At step 514, the method includes appending the insurance fee to the total rental cost and presenting it to the user for confirmation. In an exemplary embodiment of the present invention, the fee presentation may utilize user-friendly interfaces that clearly communicate the insurance value proposition, break down cost components, provide comparison options, and enable interactive exploration of different coverage levels and associated costs.

In some exemplary embodiments of the present invention, the cost presentation interface may include visual elements such as clear cost breakdowns with graphical representations, comparison tools showing costs with and without insurance, interactive sliders allowing users to adjust coverage levels and see cost impacts, educational content explaining insurance benefits and risk mitigation, or testimonials and case studies demonstrating insurance value.

In some exemplary embodiments of the present invention, the user confirmation process may include various options such as insurance acceptance with full coverage, insurance declination with risk acknowledgment, partial insurance with selected coverage elements, deferred decision with option to add insurance later, or alternative risk mitigation options such as increased security deposits or restricted usage terms.

In some exemplary embodiments of the present invention, the presentation may include legal and regulatory disclosures such as terms and conditions for insurance coverage, exclusions and limitations clearly stated, claim procedures and requirements, dispute resolution mechanisms, or regulatory compliance information for insurance products and consumer protection.

At step 516, the method includes storing risk assessment results and finalizing the insurance transaction upon confirmation. In an exemplary embodiment of the present invention, the finalization process may encompass comprehensive record-keeping, policy activation, system integration, customer communication, and monitoring setup to ensure effective insurance coverage throughout the rental period.

In some exemplary embodiments of the present invention, the risk assessment storage may utilize secure data management systems including encrypted databases for sensitive risk information, audit trails for regulatory compliance and dispute resolution, version control for tracking risk assessment changes over time, backup systems for data protection, integration with insurance partner systems for claim processing, or analytics databases for continuous improvement of risk models.

In some exemplary embodiments of the present invention, the insurance transaction finalization may include policy document generation with detailed coverage terms, premium collection and payment processing, policy activation with effective date and time, coverage confirmation to customer and relevant parties, or integration with claims processing systems for future incident handling.

In some exemplary embodiments of the present invention, the system may implement ongoing risk monitoring including real-time tracking of insured robots for security and loss prevention, automated alerts for high-risk situations or policy violations, periodic risk reassessment for long-term rentals, incident reporting and documentation systems, or customer communication regarding risk management best practices.

In some exemplary embodiments of the present invention, the finalization process may include quality assurance measures such as risk assessment validation checks, fee calculation verification, policy terms accuracy confirmation, regulatory compliance verification, or customer satisfaction surveys to ensure the insurance process meets customer needs and expectations.

At step 518, the method concludes the insurance fee calculation process. In an exemplary embodiment of the present invention, the conclusion may trigger various post-processing activities including system updates, reporting generation, performance monitoring, continuous improvement data collection, and preparation for ongoing risk management throughout the rental period.

In some exemplary embodiments of the present invention, the process conclusion may include comprehensive documentation including transaction records for audit purposes, risk assessment archives for historical analysis, customer interaction logs for service improvement, system performance metrics for process optimization, or regulatory reporting requirements for insurance and consumer protection compliance.

In some exemplary embodiments of the present invention, the system 100 may include a subscription management module configured to enable recurring rental arrangements wherein customers subscribe to ongoing robot access rather than initiating individual transactional rentals. The subscription model may provide customers with predictable pricing, guaranteed availability, and simplified booking procedures while enabling the platform to achieve improved revenue predictability, enhanced fleet utilization planning, and strengthened customer retention.

In some exemplary embodiments of the present invention, the subscription management module may support various subscription tiers including basic subscriptions providing access to standard robot types with predetermined usage limits, premium subscriptions offering priority access to advanced robot models with extended usage allowances, enterprise subscriptions designed for corporate customers with bulk allocation and dedicated support, or custom subscriptions with tailored terms negotiated for specific customer requirements and usage patterns.

In some exemplary embodiments of the present invention, subscription plans may be structured based on multiple billing parameters including time-based subscriptions with monthly, quarterly, or annual billing cycles, usage-based subscriptions charging per operational hour or task completion, hybrid subscriptions combining fixed fees with variable usage components, or credit-based subscriptions where customers pre-purchase usage credits redeemable for robot rentals with potential volume discounts.

In some exemplary embodiments of the present invention, the subscription module may implement automated renewal management including scheduled billing cycles with automatic payment processing, renewal notification systems alerting customers prior to billing dates, grace period handling for payment failures with temporary service continuation, upgrade and downgrade workflows enabling plan modifications, or cancellation processing with prorated refunds based on unused subscription periods.

In some exemplary embodiments of the present invention, subscription benefits may include guaranteed robot availability with reserved capacity allocation, priority dispatch during high-demand periods, reduced per-rental pricing compared to transactional rates, waived or reduced delivery fees for subscription members, or enhanced customer support with dedicated service channels and expedited issue resolution.

In some exemplary embodiments of the present invention, the subscription management module may integrate with the inventory module to reserve capacity for subscribers, ensuring that a designated portion of the fleet remains available exclusively for subscription fulfilment. The reservation algorithm may implement dynamic capacity allocation that adjusts reserved inventory based on subscriber usage patterns, historical demand data, and predictive analytics forecasting future subscription utilization to optimize the balance between subscription service level guarantees and transactional rental availability.

In some exemplary embodiments of the present invention, subscription analytics capabilities may include usage tracking dashboards showing customers their consumption patterns, cost analysis comparing subscription value against equivalent transactional pricing, utilization optimization recommendations suggesting plan adjustments based on actual usage, or predictive notifications alerting customers when approaching usage limits with options to purchase additional capacity or upgrade subscription tiers.

In some exemplary embodiments of the present invention, the subscription module may implement flexible booking mechanisms including standing reservations for recurring time slots, on-demand booking with guaranteed availability within specified response times, calendar integration for scheduling future robot usage, or swap-out options allowing subscribers to exchange one robot type for another within their subscription tier.

In some exemplary embodiments of the present invention, subscription pricing may be dynamically adjusted based on various factors including market demand conditions with seasonal pricing variations, subscriber tenure with loyalty discounts for long-term members, commitment level with reduced rates for longer subscription periods, or portfolio optimization across the subscriber base to maximize revenue while maintaining competitive pricing structures.

In some exemplary embodiments of the present invention, the system may implement trial subscription offerings enabling prospective customers to experience subscription benefits for limited periods, conversion mechanisms facilitating transition from transactional to subscription models with incentive pricing, or referral programs wherein existing subscribers receive benefits for recruiting new subscription members.

In some exemplary embodiments of the present invention, for third-party robot owners, the subscription module may enable participation in subscription fulfilment with guaranteed minimum rental commitments, stabilized revenue streams through regular subscription assignments, or preferential commission rates for robots dedicated to subscription service pools.

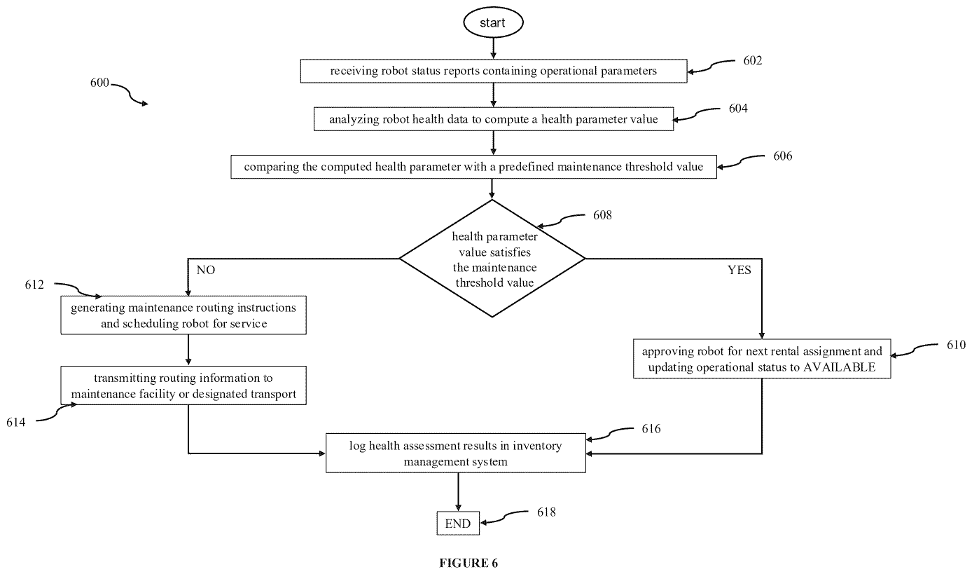

In some exemplary embodiments of the present invention, reference is made to FIG. 6 illustrating a non-limiting example of a method 600 for robot health assessment and maintenance routing in an on-demand robot rental system. At step 602, the method includes, receiving robot status reports containing operational parameters including battery level, system diagnostics, and sensor data. In an exemplary embodiment of the present invention, the robot status reporting may encompass comprehensive telemetry data collection including real-time operational metrics, environmental monitoring data, performance indicators, error logs, maintenance alerts, and predictive analytics data for proactive maintenance scheduling.

In some exemplary embodiments of the present invention, the robot status report may be transmitted through various communication channels including cellular networks for wide-area connectivity, Wi-Fi networks for high-bandwidth data transmission, Bluetooth connections for short-range device pairing, satellite communication for remote area coverage, mesh networking protocols for robot-to-robot communication, or IoT-specific protocols such as LoRaWAN or NB-IoT for low-power, long-range communication.

In some exemplary embodiments of the present invention, the operational parameters may include comprehensive system metrics such as CPU utilization and processing load, memory usage and available storage capacity, network connectivity strength and data transmission rates, motor performance including torque output and efficiency ratings, sensor accuracy and calibration status, or thermal management data including operating temperatures and cooling system performance.

In some exemplary embodiments of the present invention, the battery level monitoring may encompass detailed battery analytics including current charge percentage, remaining operational time estimates, charging cycle count and battery degradation analysis, power consumption patterns and efficiency metrics, battery temperature monitoring for safety and performance optimization, or predictive battery life modelling based on usage patterns and environmental conditions. These analytics further comprise operational metrics such as the estimated time until the next necessary recharge and the required charging duration to complete a subsequent scheduled task.

In some exemplary embodiments of the present invention, the system diagnostics may include comprehensive health monitoring such as hardware component status including actuators, sensors, and mechanical systems, software system integrity including operating system health and application performance, communication system functionality including network connectivity and data transmission reliability, security system status including encryption and authentication mechanisms, or environmental protection status including water resistance and dust protection integrity.

In some exemplary embodiments of the present invention, the sensor data collection may encompass various sensor types including but not limited to sensors for acceleration, gyroscopic, and positional data, proximity sensors for obstacle detection and navigation assistance, camera systems for visual processing and surveillance capabilities, audio sensors for sound recognition and communication, or specialized sensors for specific robot functions such as chemical detection or biometric scanning.

In some exemplary embodiments of the present invention, the status report transmission may implement data compression and optimization techniques including lossy compression for non-critical data to reduce bandwidth usage, lossless compression for critical diagnostic information, data prioritization for transmitting urgent information first, batch processing for non-urgent data transmission during off-peak hours, or adaptive transmission protocols that adjust data frequency based on robot status and operational requirements.

At step 604, the method includes analyzing robot health data to compute a health parameter value. In an exemplary embodiment of the present invention, the health parameter computation may utilize advanced analytics including machine learning algorithms trained on historical robot performance data, statistical analysis for trend identification and anomaly detection, predictive modelling for anticipating potential failures, multi-dimensional health scoring incorporating various system components, and risk assessment algorithms for maintenance priority determination.

In some exemplary embodiments of the present invention, the health data analysis may employ various analytical techniques including time series analysis for identifying performance trends over time, anomaly detection algorithms for identifying unusual behavior patterns, correlation analysis for understanding relationships between different system parameters, clustering algorithms for grouping robots with similar health profiles, or ensemble methods combining multiple analytical approaches for improved accuracy and reliability.

In some exemplary embodiments of the present invention, the health parameter computation may incorporate weighted scoring systems where different system components are assigned importance weights based on their criticality to robot operation, failure impact on user experience, repair complexity and cost, safety implications for users and bystanders, or availability of replacement parts and repair services.

In some exemplary embodiments of the present invention, the health parameter may be calculated using various mathematical models including linear combinations of individual component scores, non-linear functions capturing complex interactions between components, fuzzy logic systems for handling uncertainty and imprecision in health assessment, Bayesian networks for probabilistic health modelling, or neural networks for learning complex patterns from historical health and failure data.

In some exemplary embodiments of the present invention, the health analysis may incorporate temporal considerations including recent performance trends weighted more heavily than historical averages, degradation rate analysis for predicting future health decline, seasonal adjustments for environmental impacts on robot performance, usage intensity factors for high-utilization versus low-utilization robots, or maintenance history integration for understanding repair effectiveness and recurring issues.

In some exemplary embodiments of the present invention, the health parameter computation may include confidence intervals and uncertainty quantification providing not just a point estimate of health but also information about the reliability of the assessment, potential error ranges, data quality indicators affecting assessment accuracy, or recommendation confidence levels for maintenance decisions.

At step 606, the method includes comparing the computed health parameter with a predefined maintenance threshold. In an exemplary embodiment of the present invention, the threshold comparison may utilize decision-making algorithms including dynamic threshold adjustment based on operational conditions, multi-level threshold systems for different maintenance urgency levels, contextual threshold modification based on robot utilization and availability, and predictive threshold adjustment based on anticipated usage patterns and maintenance capacity.

In some exemplary embodiments of the present invention, the predefined maintenance threshold may be established using various methodologies including statistical analysis of historical failure data to identify optimal intervention points, cost-benefit analysis balancing maintenance costs against potential failure costs, reliability engineering principles for maximizing system uptime, safety analysis ensuring user and bystander protection, or regulatory compliance requirements for robotic system maintenance. In further embodiments, artificial intelligence models may be utilized to dynamically determine and adjust these optimal thresholds based on real-time fleet health, anticipated usage patterns, and predictive failure analysis.

In some exemplary embodiments of the present invention, the threshold system may implement multiple static or dynamically-determined threshold levels including critical thresholds requiring immediate maintenance intervention, warning thresholds indicating increased monitoring and preventive maintenance scheduling, optimal thresholds for routine maintenance during natural service breaks, or informational thresholds for data collection and trend analysis without immediate action requirements.

In some exemplary embodiments of the present invention, the threshold comparison may account for contextual factors such as current rental demand affecting maintenance timing flexibility, availability of maintenance resources including technicians and facilities, robot criticality based on fleet size and customer commitments, seasonal factors affecting maintenance scheduling, or geographic location impacting maintenance accessibility and costs.

In some exemplary embodiments of the present invention, the threshold evaluation may incorporate risk assessment including probability of failure if maintenance is delayed, potential consequences of in-service failures including safety risks and customer impact, cost implications of emergency repairs versus scheduled maintenance, reputation risks from service interruptions, or insurance and liability considerations for operating robots with degraded health parameters.

At step 608, the method includes a decision point determining whether the health parameter satisfies the maintenance threshold. In an exemplary embodiment of the present invention, the decision logic may implement evaluation criteria including Boolean decision rules for clear-cut threshold violations, probabilistic decision-making for cases with uncertainty, multi-criteria decision analysis incorporating various factors beyond simple threshold comparison, and adaptive decision-making that learns from historical maintenance outcomes.

In some exemplary embodiments of the present invention, the decision point may include tie-breaking rules for cases where health parameters are very close to threshold values, incorporating secondary factors such as upcoming rental schedules, maintenance resource availability, robot strategic importance to fleet operations, or customer service level agreements requiring specific uptime guarantees.

In some exemplary embodiments of the present invention, the decision logic may implement override mechanisms allowing human operators or advanced artificial intelligence (AI) systems such as large language models (LLMs) to override automated decisions based on contextual information not captured in the algorithmic assessment, emergency situations requiring immediate robot deployment despite health concerns, or strategic business decisions prioritizing customer service over optimal maintenance timing.

For the “No” path (health parameter does not satisfy threshold), at step 612, the method includes generating maintenance routing instructions and scheduling robot for service. In an exemplary embodiment of the present invention, the maintenance routing may utilize optimization algorithms including shortest path algorithms for minimizing travel time to maintenance facilities, multi-objective optimization balancing travel time, maintenance capacity, and service quality, dynamic routing accounting for real-time traffic conditions and facility availability, or predictive routing considering anticipated maintenance duration and resource requirements.

In some exemplary embodiments of the present invention, the maintenance scheduling may incorporate capacity management including maintenance facility workload balancing, technician skill matching for specific robot types or issues, parts inventory verification ensuring necessary components are available, equipment availability for specialized maintenance tools, or priority scheduling for high-value or critical robots.

In some exemplary embodiments of the present invention, the routing instructions may include comprehensive navigation information such as turn-by-turn directions to maintenance facilities, alternative route options for traffic avoidance, facility contact information and operating hours, special handling instructions for damaged or malfunctioning robots, or safety protocols for transporting robots with specific health issues.

At step 614, the method includes transmitting routing information to maintenance facility or designated transport. In an exemplary embodiment of the present invention, the information transmission may utilize multiple communication channels including automated dispatch systems for immediate notification, mobile applications for field technician coordination, email systems for detailed maintenance documentation, SMS alerts for urgent maintenance requests, or integrated logistics systems for transport coordination.

In some exemplary embodiments of the present invention, the routing information transmission may include comprehensive maintenance documentation such as detailed health assessment reports, specific symptoms or issues requiring attention, maintenance history and previous repair records, parts replacement recommendations, estimated maintenance duration and complexity, or special tools or expertise required for the maintenance work.

For the “Yes” path (health parameter satisfies threshold), at step 610, the method includes approving robot for next rental assignment and updating operational status to AVAILABLE. In an exemplary embodiment of the present invention, the approval process may include final system checks including battery readiness assessment, which may involve current charge verification or a prediction of future availability based on the time required to achieve a sufficient charge level for the next scheduled assignment, sensor calibration confirmation, software update status, cleaning and sanitization verification, or cosmetic inspection for customer presentation.

In some exemplary embodiments of the present invention, the operational status update may trigger various system activities including inventory management system updates for robot availability, scheduling system notifications for potential rental assignments, customer notification systems for delivery time estimates, or fleet management dashboards for operational visibility and planning.

In some exemplary embodiments of the present invention, the approval process may include performance optimization including battery charging to optimal levels, software updates or patches installation, configuration reset to default settings, accessory attachment or removal based on next assignment requirements, or positioning for optimal deployment logistics.

At step 616, both paths converge to log health assessment results in inventory management system. In an exemplary embodiment of the present invention, the logging system may maintain comprehensive records including timestamped health assessment data, decision rationale and supporting analysis, maintenance actions taken or scheduled, operational status changes, and performance trend data for long-term analysis.

In some exemplary embodiments of the present invention, the inventory management system logging may include data integration with various systems such as customer relationship management for service impact tracking, financial systems for maintenance cost accounting, predictive analytics systems for future planning, regulatory compliance systems for safety and maintenance records, or business intelligence systems for operational performance analysis.

In some exemplary embodiments of the present invention, the logging system may implement data quality assurance including data validation for accuracy and completeness, backup systems for data protection, audit trails for regulatory compliance, data encryption for sensitive operational information, or data retention policies for long-term historical analysis.

In some exemplary embodiments of the present invention, the health assessment logging may support various analytical capabilities including trend analysis for fleet health monitoring, comparative analysis for identifying high-performing versus problematic robot models, predictive modelling for maintenance planning and resource allocation, cost analysis for maintenance optimization, or performance benchmarking against industry standards.

In some exemplary embodiments of the present invention, the logging system may provide real-time dashboards and reporting including fleet health overview displays, maintenance schedule visibility, cost tracking and budgeting tools, performance metrics and key performance indicators, or alerts and notifications for critical health events requiring immediate attention.

At step 618, the method concludes the robot health assessment and maintenance routing process. In an exemplary embodiment of the present invention, the process conclusion may trigger follow-up activities including automated scheduling of next health assessment, customer communication regarding robot availability, fleet optimization analysis for resource allocation, maintenance effectiveness evaluation, or continuous improvement data collection for process enhancement.

In some exemplary embodiments of the present invention, the process conclusion may include quality assurance measures such as health assessment accuracy verification through follow-up monitoring, maintenance decision effectiveness evaluation through outcome tracking, customer satisfaction impact assessment, cost-effectiveness analysis of maintenance decisions, or safety incident prevention validation.

In some exemplary embodiments of the present invention, the conclusion may involve strategic planning activities including fleet health trend analysis for replacement planning, maintenance resource optimization for capacity planning, predictive maintenance model refinement based on actual outcomes, technology upgrade planning for improved health monitoring capabilities, or partnership evaluation for maintenance service providers.

In some exemplary embodiments of the present invention, the process may include knowledge management activities such as maintenance outcome documentation for institutional learning, best practices identification and sharing, failure mode analysis for prevention strategies, technician feedback integration for process improvement, or industry benchmarking for competitive advantage.

In some exemplary embodiments of the present invention, the health assessment process may support regulatory compliance including safety inspection documentation, maintenance record keeping for regulatory audits, incident reporting for safety agencies, environmental compliance for robot disposal or recycling, or certification maintenance for specialized robot operations.

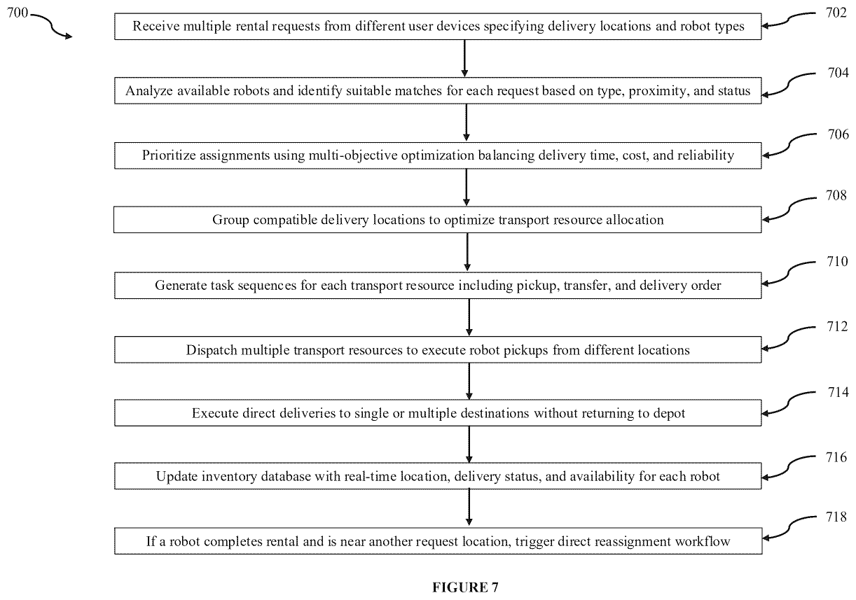

Reference is made to FIG. 7 illustrating a non-limiting example of a method 700 for multi-robot dispatch, direct delivery, and dynamic reassignment in an on-demand robot rental system. At step 702, the method includes receiving multiple rental requests from different user devices specifying delivery locations and robot types. In an exemplary embodiment of the present invention, the request intake system may implement high-capacity, multi-channel interfaces including web portals, mobile applications, API integrations, and third-party service partnerships, capable of handling peak concurrent submissions and automatically parsing request parameters such as desired robot functions, required delivery windows, and location preferences.

In some exemplary embodiments, the intake system enforces digital identity verification, request deduplication, and preliminary eligibility checks; further, it can buffer, queue, or batch requests for optimal processing and scheduling efficiency, especially in high-volume urban service regions or during special event surges.

At step 704, the method includes analyzing available robots and identifying suitable matches for each request based on type, proximity, and status. The allocation engine may cross-reference a live-updated inventory including current robot locations (resolved via GPS, Wi-Fi triangulation, or beacons), robot health and charge status, and capability profiles (hardware modules, software licenses, and maintenance records).

In some embodiments, advanced matching algorithms blend k-nearest-neighbor searches for proximity, weighted scoring for functional suitability (i.e., matching tasks/job requirements to robot capabilities), and real-time status assessment (in-service, ready, charging, maintenance hold, en route, reserved). Robots out of optimal operational parameters are flagged for maintenance and excluded from assignment.

At step 706, the method includes prioritizing assignments using multi-objective optimization balancing delivery time, cost, and reliability. Optimization may be achieved using linear programming, simulated annealing, or other heuristic methods, taking into account SLA targets (for expedited or guaranteed windows), preferred customer tiers (e.g., business or loyalty programs), resource constraints, and cost-minimization objectives for fuel, staffing, and vehicle reallocation.

In some exemplary embodiments, the optimization engine can dynamically re-prioritize dispatch in response to traffic/route predictions, expected weather disruptions, transport resource status, and the presence of high-value or perishable cargo.

At step 708, the method includes grouping compatible delivery locations to optimize transport resource allocation. The system implements spatial clustering such as k-means or density-based algorithms to group multiple delivery endpoints into efficient, feasible delivery tours, minimizing backtracking and optimizing drop route geometry.

In further embodiments, the grouping logic adapts to changing operational constraints (vehicle capacity, assigned drivers, regulatory compliance for driving time, and local delivery restrictions) and can support hybrid models with both scheduled and on-demand pickups/deliveries.

At step 710, the method includes generating task sequences for each transport resource including pickup, transfer, and delivery order. Algorithms generate detailed multi-stop itineraries, optimize between time-constrained deliveries and vehicle utilization, and automatically allocate robots to specific runs, factoring in estimated robot setup and tear-down times at the origin and destination locations. Task sequences include not only optimized route manifests but also special handling instructions, access protocols, and automated triggers for check-in/out at each operational waypoint.

In exemplary systems, task plans can be modified in real time in response to route updates, robot readiness state fluctuations, or customer cancellations, with re-optimized manifests communicated to drivers and updated in the system of record.

At step 712, the method includes dispatching multiple transport resources to execute robot pickups from different locations. The dispatch engine coordinates parallel vehicle and personnel deployment, ensuring synchronization with robot readiness and availability, as well as efficient load balancing across different service areas.

Transport resources may comprise a heterogeneous fleetvans, self-driving vehicles, drones and dispatch criteria may privilege proximity, ongoing tour alignment, or resource-specific constraints such as range, clearance, or urban access.

At step 714, the method includes executing direct deliveries to single or multiple destinations without returning to depot. Robots can be routed sequentially from one rental customer to the next when request windows align geographically and temporally, bypassing central depots to maximize operational efficiency, reduce energy expenditure, and decrease turnaround times.

Execution monitoring ensures robots pass through any required inspection, charging, or cleaning checkpoints between assignments if dictated by service protocols or customer contracts, and can automatically insert such stops en route.

At step 716, the method includes updating the inventory database with real-time location, delivery status, and availability for each robot. Every robot and vehicle is continuously tracked using GPS, cellular, or short-range wireless means; delivery/pickup/completion events are logged in the platform, and robot status (in-use, available, maintenance, cleaning) is immediately updated, providing operational transparency to both internal teams and customers.

The central database enables anomaly detection (e.g., mis-routed, stuck, or inactive robots), automated alerting for late/failed deliveries, and continuous service quality benchmarking.

At step 718, the method includes, if a robot completes rental and is near another request location, triggering direct reassignment workflow. The inventory management engine automatically detects geographic and temporal co-location of available robots and new requests, permitting seamless cross-customer handoff, with all required verifications, notifications, and reconfiguration steps initiated for uninterrupted service.

In some exemplary embodiments, the reassignment workflow includes verification of robot health, request compatibility, and, if needed, transient servicing; the system may also handle exception cases, such as robot or transport unavailability, requiring fallback to depot or alternative resource dispatch.

Embodiments can include fleet analytics and historical performance review for continual refinement of multi-robot dispatch strategies, reassignment thresholds, and clustering/grouping algorithms to continually increase efficiency and customer satisfaction.

In some exemplary embodiments of the present invention, the multi-objective optimization and task sequencing may be further enhanced through a “block matching” algorithm. Block matching refers to a process wherein the system, instead of processing rental requests individually as they are received, aggregates multiple concurrent or near-future requests into a single “block” for batch processing. This block may be defined by parameters such as a specific time window (e.g., all requests for the 9:00 AM to 11:00 AM period) or a specific geographic zone (e.g., all requests within a particular neighborhood or zip code). Once a block of requests is defined, the optimization engine analyses the entire set of tasks simultaneously. It identifies the optimal number of robots and transport resources required to service the entire block, treating the problem as a complex multi-robot vehicle routing problem. This method allows the system to generate highly efficient, sequential task chains, such as assigning a single robot to perform a direct transfer from User A to User B, and then immediately to User C, all within the same optimized route. This proactive, block-based matching significantly reduces anticipated delivery costs, minimizes robot idle time, and maximizes fleet utilization, moving beyond simple one-to-one or A-to-B matching to a more holistic fleet-wide optimization.

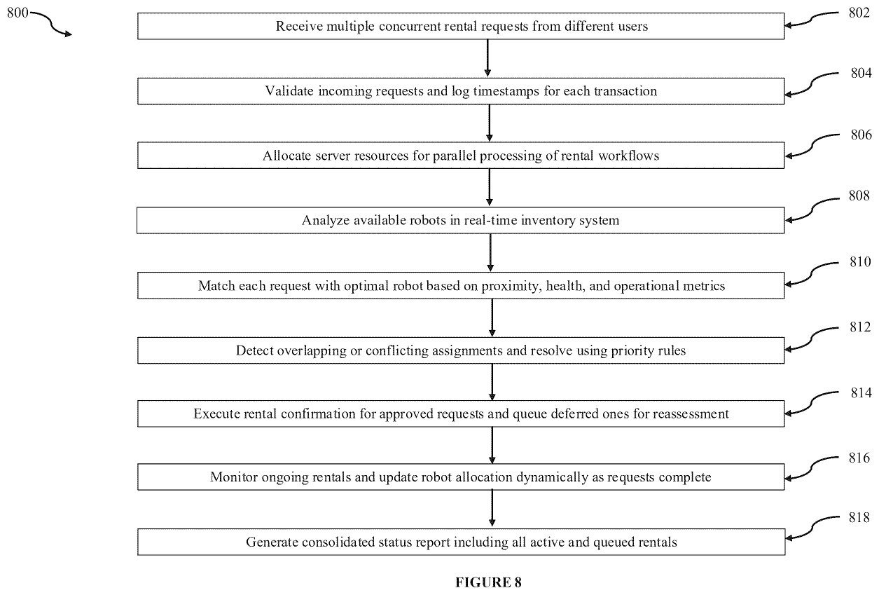

In some exemplary embodiments of the present invention, reference is made to FIG. 8 illustrating a non-limiting example of a method 800 for handling concurrent rental requests and parallel workflow processing in an on-demand robot rental system. At step 802, the method includes receiving multiple concurrent rental requests from different users. In an exemplary embodiment of the present invention, the concurrent request handling may utilize advanced distributed computing architectures including multi-threaded processing systems for simultaneous request handling, load balancing mechanisms for equitable resource distribution, scalability frameworks for varying demand levels, fault tolerance systems for maintaining service continuity, and real-time monitoring capabilities for performance optimization.

In some exemplary embodiments of the present invention, the multiple concurrent requests may be managed through queue management systems including priority queues for service level differentiation, circular buffers for fair processing distribution, adaptive queuing strategies based on system load conditions, message queuing systems for asynchronous processing, or distributed queue architectures for high-availability processing across multiple servers.

In some exemplary embodiments of the present invention, the concurrent request reception may implement various communication protocols including RESTful API endpoints for web and mobile applications, WebSocket connections for real-time bidirectional communication, message queue protocols such as AMQP or MQTT for reliable message delivery, gRPC for high-performance remote procedure calls, or GraphQL interfaces for flexible data querying and manipulation.

In some exemplary embodiments of the present invention, the different user sources may encompass diverse customer channels including individual consumer mobile applications, corporate enterprise portals for bulk rentals, third-party platform integrations through API partnerships, voice-activated interfaces for hands-free ordering, IoT device integrations for automated rental triggers, or emergency services interfaces for urgent robot deployment needs.

In some exemplary embodiments of the present invention, the concurrent processing architecture may utilize cloud computing platforms including auto-scaling server instances for demand adaptation, containerized microservices for modular processing, serverless computing functions for event-driven processing, distributed caching systems for performance optimization, or content delivery networks for global request distribution.

In some exemplary embodiments of the present invention, the system may implement advanced concurrency control mechanisms including optimistic locking for high-throughput scenarios, pessimistic locking for critical resource protection, atomic operations for data consistency, distributed transaction management for multi-system coordination, or event-driven architectures for loosely coupled system components.

At step 804, the method includes validating incoming requests and logging timestamps for each transaction. In an exemplary embodiment of the present invention, the validation and logging system may implement comprehensive security and audit mechanisms including input sanitization for security protection, schema validation for data integrity, authentication verification for user identity confirmation, authorization checks for access control, and comprehensive audit trails for regulatory compliance and system monitoring.

In some exemplary embodiments of the present invention, the request validation may encompass multiple validation layers including syntax validation for proper data formatting, semantic validation for business rule compliance, security validation for fraud detection and prevention, resource availability validation for feasibility assessment, or customer eligibility validation for service authorization.

In some exemplary embodiments of the present invention, the timestamp logging may utilize high-precision timing systems including nanosecond precision timestamps for detailed performance analysis, UTC time standardization for global consistency, time zone handling for multi-regional operations, network time protocol synchronization for distributed system coordination, or blockchain-based timestamping for immutable audit trails.

In some exemplary embodiments of the present invention, the transaction logging may include comprehensive metadata capture such as request source identification, user demographic information, device fingerprinting for security analysis, geolocation data for geographic analysis, session information for user behavior tracking, or referral source data for marketing analytics.

In some exemplary embodiments of the present invention, the validation system may implement rate limiting mechanisms including per-user request throttling to prevent abuse, IP-based rate limiting for network security, sliding window algorithms for flexible rate control, token bucket algorithms for burst traffic handling, or adaptive rate limiting based on system capacity and performance metrics.

In some exemplary embodiments of the present invention, the logging infrastructure may utilize distributed logging systems including centralized log aggregation for unified analysis, structured logging with standardized formats, log rotation and archival for storage management, real-time log streaming for immediate analysis, or log analytics platforms for business intelligence and operational insights.

At step 806, the method includes allocating server resources for parallel processing of rental workflows. In an exemplary embodiment of the present invention, the resource allocation system may implement workload distribution including dynamic resource provisioning based on current demand, predictive scaling using historical patterns and forecasting, resource pooling for efficient utilization, priority-based allocation for service level management, and performance monitoring for optimization feedback.

In some exemplary embodiments of the present invention, the parallel processing architecture may utilize various computational models including multi-core CPU processing for concurrent thread execution, GPU computing for massively parallel operations, distributed computing clusters for large-scale processing, hybrid cloud architectures combining on-premises and cloud resources, or edge computing for reduced latency and improved performance.

In some exemplary embodiments of the present invention, the server resource allocation may implement container orchestration systems including Kubernetes for automated container management, Docker for application containerization, service mesh or internal APIs mesh architectures for microservice communication, auto-scaling policies for demand-responsive resource allocation, or resource quotas and limits for fair resource distribution.

In some exemplary embodiments of the present invention, the workflow processing may utilize advanced scheduling algorithms including round-robin scheduling for fair resource distribution, priority-based scheduling for service level differentiation, deadline-aware scheduling for time-sensitive requests, load-balanced scheduling for optimal resource utilization, or machine learning-based scheduling for adaptive performance optimization.

In some exemplary embodiments of the present invention, the resource monitoring may include comprehensive performance metrics tracking such as CPU utilization and memory consumption, network bandwidth and latency measurements, storage I/O performance and capacity utilization, database query performance and connection pooling, or application-specific metrics for business logic optimization.

At step 808, the method includes analyzing available robots in real-time inventory system. In an exemplary embodiment of the present invention, the real-time inventory analysis may utilize advanced database systems including in-memory databases for ultra-fast access, distributed databases for scalability and availability, real-time data streaming for immediate updates, caching mechanisms for performance optimization, and data replication for fault tolerance and geographic distribution.

In some exemplary embodiments of the present invention, the inventory system may implement comprehensive robot tracking including GPS-based location monitoring with sub-meter accuracy, operational status tracking with real-time health metrics, availability scheduling with maintenance integration, capability profiling with dynamic updates, or predictive availability forecasting based on usage patterns and maintenance schedules.

In some exemplary embodiments of the present invention, the real-time analysis may utilize advanced data processing techniques including stream processing for continuous data updates, complex event processing for pattern recognition, time-series databases for temporal data management, graph databases for relationship modelling, or distributed analytics for large-scale data processing.

In some exemplary embodiments of the present invention, the inventory data may include comprehensive robot information such as technical specifications including payload capacity and operational parameters, current condition assessment with health scores, maintenance history and scheduled service requirements, geographic location with accuracy and update frequency, or customer assignment status with rental period details.

In some exemplary embodiments of the present invention, the analysis system may implement filtering and search capabilities including multi-criteria filtering for complex requirement matching, geospatial queries for location-based searches, temporal queries for availability window analysis, similarity searches for alternative robot recommendations, or machine learning-based matching for optimal robot-customer pairing.

At step 810, the method includes matching each request with an optimal robot based on proximity, health, and operational metrics. In an exemplary embodiment of the present invention, the matching optimization may utilize algorithms including multi-objective optimization for balanced decision-making, machine learning models trained on historical success data, constraint satisfaction solving for complex requirement handling, game theory approaches for competitive resource allocation, and fuzzy logic systems for handling uncertainty and partial matches.

In some exemplary embodiments of the present invention, the proximity calculations may incorporate various distance metrics including Euclidean distance for straight-line measurements, Manhattan distance for grid-based urban environments, road network distances for actual travel routes, time-based proximity considering traffic and transportation modes, or cost-based proximity incorporating transportation expenses and logistics complexity.

In some exemplary embodiments of the present invention, the health assessment may encompass comprehensive robot condition evaluation including battery level and charging status, mechanical component wear and maintenance requirements, software system integrity and update status, sensor calibration and functionality verification, or predictive health modelling based on usage patterns and environmental exposure.

In some exemplary embodiments of the present invention, the operational metrics may include performance indicators such as task completion success rates, energy efficiency measurements, customer satisfaction scores from previous rentals, maintenance frequency and reliability data, or specialized capability ratings for specific robot functions and applications.

In some exemplary embodiments of the present invention, the matching algorithm may implement learning mechanisms including reinforcement learning for adaptive optimization, collaborative filtering for recommendation improvements, neural networks for pattern recognition, genetic algorithms for evolutionary optimization, or ensemble methods combining multiple approaches for robust performance.

In some exemplary embodiments of the present invention, the optimization process may consider contextual factors including customer priority levels and service tier agreements, seasonal demand patterns and resource constraints, regulatory requirements and safety considerations, insurance implications and liability factors, or environmental conditions affecting robot operation and transportation.

At step 812, the method includes detecting overlapping or conflicting assignments and resolving using priority rules. In an exemplary embodiment of the present invention, the conflict detection and resolution system may implement advanced algorithms including graph-based conflict modelling, constraint programming for solution finding, auction mechanisms for resource allocation, negotiation protocols for multi-party optimization, and escalation procedures for complex conflict situations.

In some exemplary embodiments of the present invention, the overlapping assignment detection may utilize temporal analysis including time window overlap calculations, resource availability conflict identification, scheduling constraint violations, capacity limitation breaches, or dependency chain analysis for cascading effect assessment.

In some exemplary embodiments of the present invention, the conflict resolution may implement various priority systems including customer tier-based priorities for service level differentiation, first-come-first-served fairness principles, revenue-based prioritization for business optimization, urgency-based priorities for emergency situations, or dynamic priority adjustment based on real-time conditions and customer needs.

In some exemplary embodiments of the present invention, the priority rules may incorporate multiple factors including customer relationship value and loyalty status, order value and profitability considerations, delivery urgency and time sensitivity, geographic efficiency and logistics optimization, or social impact and accessibility requirements for underserved communities.

In some exemplary embodiments of the present invention, the resolution mechanisms may include alternative solutions such as substitute robot recommendations with equivalent capabilities, adjusted delivery timing for optimal resource utilization, upgraded service offerings with premium robots, compensation packages for delayed or modified service, or partnership arrangements with third-party providers for capacity expansion.

At step 814, the method includes executing rental confirmation for approved requests and queuing deferred ones for reassessment. In an exemplary embodiment of the present invention, the execution and queuing system may implement comprehensive workflow management including automated confirmation processing, customer notification systems, payment authorization and processing, resource allocation and scheduling, and continuous monitoring for service delivery assurance.

In some exemplary embodiments of the present invention, the rental confirmation may include detailed customer communication such as booking confirmation with rental details, payment confirmation and receipt generation, delivery scheduling with time estimates, customer preparation instructions for robot reception, or terms and conditions acknowledgment for legal compliance.

In some exemplary embodiments of the present invention, the deferred request queuing may implement management including priority-based queue positioning, automatic reassessment triggers based on resource availability, customer notification regarding queue status and estimated fulfilment times, alternative option recommendations for immediate service, or queue optimization algorithms for fair and efficient processing.

In some exemplary embodiments of the present invention, the execution system may include quality assurance measures such as double-verification of resource allocation, automated testing of system components, backup resource identification for contingency planning, customer service escalation for complex situations, or performance monitoring for service level compliance.

At step 816, the method includes monitoring ongoing rentals and updating robot allocation dynamically as requests complete. In an exemplary embodiment of the present invention, the dynamic monitoring and allocation system may implement real-time tracking including GPS-based location monitoring, operational status surveillance, customer interaction tracking, performance metrics collection, and predictive analytics for proactive management and optimization.

In some exemplary embodiments of the present invention, the ongoing rental monitoring may utilize IoT technologies including sensor networks for comprehensive robot monitoring, cellular and Wi-Fi connectivity for continuous communication, edge computing for real-time data processing, cloud integration for centralized management, or blockchain technology for immutable transaction and usage records.

In some exemplary embodiments of the present invention, the dynamic allocation updates may implement event-driven processing including completion event triggers for immediate reallocation, early return processing for expedited robot availability, extension request handling for flexible rental periods, emergency recall procedures for urgent situations, or maintenance scheduling integration for optimal fleet management.

In some exemplary embodiments of the present invention, the monitoring system may include predictive capabilities such as completion time estimation based on usage patterns, maintenance requirement forecasting, demand pattern analysis for resource positioning, customer behavior prediction for service optimization, or failure prediction for preventive intervention.

At step 818, the method includes generating consolidated status reports summarizing all active and queued rentals. In an exemplary embodiment of the present invention, the reporting system may implement comprehensive analytics including real-time dashboards for operational visibility, executive summaries for strategic decision-making, detailed operational reports for performance analysis, customer-facing status updates for transparency, and regulatory compliance documentation for audit requirements.

In some exemplary embodiments of the present invention, the consolidated reporting may include various report formats such as graphical dashboards with interactive visualizations, tabular reports with detailed data breakdowns, executive summaries with key performance indicators, real-time alerts for critical situations, or mobile-optimized reports for field operations and management.

In some exemplary embodiments of the present invention, the status reports may encompass comprehensive information including fleet utilization statistics, customer satisfaction metrics, financial performance indicators, operational efficiency measurements, maintenance and health statistics, or geographic distribution analysis for strategic planning.

In some exemplary embodiments of the present invention, the reporting system may implement automation features including scheduled report generation and distribution, automated alert triggers for threshold breaches, customizable report templates for different stakeholder needs, data export capabilities for external analysis, or integration with business intelligence platforms for advanced analytics.

In some exemplary embodiments of the present invention, the method concludes the concurrent request handling and parallel processing workflow. In an exemplary embodiment of the present invention, the process conclusion may trigger comprehensive performance evaluation including system performance analysis, customer satisfaction assessment, operational efficiency measurement, cost-effectiveness evaluation, and continuous improvement planning for future optimization.

In some exemplary embodiments of the present invention, the conclusion may include cleanup and optimization activities such as resource deallocation for cost efficiency, cache clearing and system maintenance, performance metrics archival, lesson learned documentation, or system configuration updates based on operational insights and improvement opportunities.

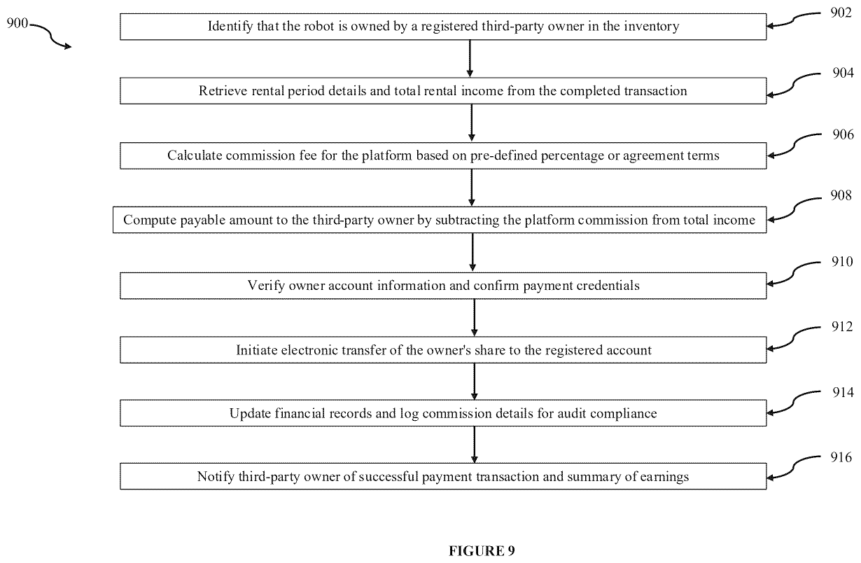

Reference is made to FIG. 9 illustrating a non-limiting example of a method 900 for third-party owner commission processing in an on-demand robot rental platform. At step 902, the method includes identifying that the robot is owned by a registered third-party owner in the inventory. In an exemplary embodiment of the present invention, the third-party owner identification system may utilize comprehensive database management including owner registration and verification systems with identity confirmation procedures, asset verification protocols for robot authenticity and condition assessment, ownership documentation with legal title verification, and integrated multi-party platform capabilities enabling third-party robot owners to list robots for rental in the inventory.

In some exemplary embodiments of the present invention, the third-party owner registration may encompass multiple verification layers including individual owner verification through government-issued identification documents such as driver's licenses or passports, corporate owner verification through business registration and incorporation documents, financial verification including bank account validation and credit assessment, insurance verification for adequate liability and asset coverage, or technical competency assessment for robot maintenance and operational knowledge.

In some exemplary embodiments of the present invention, the robot registration process may include comprehensive asset documentation such as robot model specifications with manufacturer certifications, serial number verification and anti-theft registration, condition assessment with detailed inspection reports, valuation documentation for insurance and rental pricing purposes, maintenance history and service records for operational reliability assessment, or compliance verification ensuring robots meet safety and operational standards.

In some exemplary embodiments of the present invention, the inventory management system may implement ownership tracking mechanisms including blockchain-based ownership records for immutable asset tracking, smart contracts for automated ownership verification and transaction processing, digital certificates for robot authenticity and provenance, distributed ledger systems for transparent ownership history and transaction records, or real-time ownership status monitoring for platform integrity.

In some exemplary embodiments of the present invention, the third-party platform may include owner onboarding processes such as comprehensive application procedures with background checks, training programs for platform usage and robot management best practices, compliance verification ensuring robots meet safety and operational standards, contract negotiation and agreement execution with transparent terms, performance monitoring systems for ongoing owner evaluation and platform optimization, or owner registration and verification systems with identity confirmation and asset verification.

In some exemplary embodiments of the present invention, the identification system may utilize various technological approaches including RFID tags or NFC chips embedded in robots for quick identification, QR codes or barcode systems for quick identification and verification during transactions, GPS tracking systems for location-based ownership verification and asset security, biometric systems for owner authentication during robot interactions, or IoT connectivity for continuous ownership monitoring and asset security.

At step 904, the method includes retrieving rental period details and total rental income from the completed transaction. In an exemplary embodiment of the present invention, the transaction data retrieval system may implement comprehensive financial record management including detailed rental transaction logging with timestamps and duration tracking, revenue calculation and breakdown analysis, payment processing integration with multiple payment methods, tax calculation and compliance management, and real-time financial reporting for transparent income tracking.

In some exemplary embodiments of the present invention, the rental period tracking may include precise timing mechanisms such as blockchain-based timestamping for immutable rental period records, automated start and end time logging through IoT connectivity, customer interaction logging for rental initiation and completion verification, predictive completion time estimation based on usage patterns and customer behavior analysis, or buffer time calculations for service transitions between consecutive rentals.

In some exemplary embodiments of the present invention, the rental income calculation may encompass various revenue components including base rental fees calculated by duration and robot type, dynamic pricing adjustments based on supply and demand conditions, time of day, and prevailing weather conditions, additional service fees for delivery, setup, or premium features, insurance fees collected for coverage protection, surge pricing multipliers applied during high-demand periods, or geographic pricing adjustments determined by delivery distance and regional market conditions.

In some exemplary embodiments of the present invention, the transaction documentation may include comprehensive record-keeping such as customer identification and contact information, rental agreement terms and conditions, payment method details and authorization confirmations, service delivery confirmation with digital signatures or photos, customer satisfaction ratings and feedback, or dispute resolution records for any customer service issues or claims.

In some exemplary embodiments of the present invention, the financial data integration may connect with various systems including enterprise resource planning systems for comprehensive business management, customer relationship management systems for service history tracking, accounting software for financial reporting and tax compliance, business intelligence platforms for revenue analysis and performance optimization, or regulatory reporting systems for compliance documentation.

In some exemplary embodiments of the present invention, the income tracking may implement real-time monitoring including live dashboard displays for ongoing rental revenue, automated alerts for significant revenue events or thresholds, predictive revenue forecasting based on current rentals and pipeline, comparative analysis against historical performance and market benchmarks, or trend analysis for identifying revenue patterns and optimization opportunities.

At step 906, the method includes calculating platform fee for the platform based on pre-defined percentage or agreement terms. In the context of a third-party owner, this platform fee may be calculated as a commission fee. In an exemplary embodiment of the present invention, the commission calculation system may implement sophisticated fee structures including tiered commission rates based on owner performance metrics, volume-based discounts for high-performing owners, loyalty programs with reduced commission rates for long-term partners, performance bonuses for exceptional customer service or robot maintenance, and dynamic commission adjustments based on market conditions and platform value provided.

In some exemplary embodiments of the present invention, the commission percentage determination may consider multiple factors including robot category and market demand with premium rates for high-demand robot types, owner service level and customer satisfaction ratings, geographic market conditions and competitive positioning, seasonal adjustments for demand fluctuations, promotional rates for new owner onboarding and platform growth, or strategic partnership considerations for business development.

In some exemplary embodiments of the present invention, the agreement terms may include comprehensive contract provisions such as commission rate schedules with clear percentage breakdowns, payment timing and frequency specifications including weekly or monthly settlement cycles, minimum performance requirements for commission eligibility, dispute resolution procedures for commission-related conflicts, modification procedures for updating commission structures based on changing market conditions, or termination clauses with notice periods and final settlement terms.

In some exemplary embodiments of the present invention, the calculation algorithms may implement various mathematical models including linear commission structures with fixed percentages, progressive commission tiers with increasing rates for higher volumes, performance-based adjustments using customer satisfaction and reliability metrics, market-responsive commission rates that adjust based on supply and demand dynamics, or hybrid models combining multiple commission structures for optimal revenue sharing.

In some exemplary embodiments of the present invention, the fee structure may include transparency features such as detailed commission breakdowns showing calculation methodology, comparison tools showing commission rates across different robot types or performance levels, predictive commission calculators for owners to estimate earnings, historical commission reporting for performance tracking and optimization, or benchmark comparisons against industry standards and competitive platforms.

At step 908, the method includes computing payable amount to the third-party owner by subtracting the platform commission from total income. In an exemplary embodiment of the present invention, the payable amount calculation may implement comprehensive financial processing including detailed income and expense breakdowns, tax withholding calculations for compliance requirements, real-time currency conversion for customer transactions, currency conversion for international owners, payment processing fee deductions, and transparent accounting with detailed statements for owner review and verification.

In some exemplary embodiments of the present invention, the calculation process may include additional deductions such as maintenance or repair costs incurred by the platform during the rental period, cleaning or sanitization fees for robot preparation between rentals, insurance deductions for coverage provided by the platform, storage or warehousing fees for robot housing between rentals, transportation costs for robot deployment and retrieval, or damage penalty assessments for robot condition issues.

In some exemplary embodiments of the present invention, the payable amount may include bonus payments such as performance bonuses for exceptional customer service ratings, utilization bonuses for high-demand robot availability, loyalty bonuses for long-term platform participation, referral bonuses for bringing new owners to the platform, quality bonuses for maintaining robots in excellent condition, or innovation bonuses for introducing new robot capabilities or features.

In some exemplary embodiments of the present invention, the calculation system may implement error checking and validation including automated calculation verification through multiple algorithmic approaches, manual review processes for high-value transactions, audit trails for all calculation steps and modifications, exception handling for unusual transaction patterns, or dispute resolution mechanisms for challenging calculation results.

At step 910, the method includes verifying owner account information and confirming payment credentials. In an exemplary embodiment of the present invention, the verification system may implement comprehensive identity and financial authentication including multi-factor authentication for account security, bank account verification through micro-deposits or API integration, identity verification through government databases or credit agencies, fraud detection algorithms analyzing payment patterns and account behavior, and regulatory compliance verification for anti-money laundering and know-your-customer requirements.

In some exemplary embodiments of the present invention, the account verification may include multiple validation layers such as primary bank account verification through ACH micro-transactions, secondary payment method backup verification, identity document verification using OCR and document authentication technologies, address verification through postal or utility records, phone number verification through SMS or voice confirmation, or email verification through confirmation links.

In some exemplary embodiments of the present invention, the payment credentials confirmation may encompass various security measures including encryption of financial data during transmission and storage, tokenization of sensitive payment information, secure API connections with banking and payment processing partners, regular security audits and penetration testing, compliance with financial industry security standards such as PCI DSS, or two-factor authentication for sensitive account modifications.

In some exemplary embodiments of the present invention, the verification process may include risk assessment components such as credit checks for financial reliability evaluation, background checks for security and trustworthiness assessment, business verification for corporate owners including tax ID validation, insurance verification for adequate coverage, reference checks from previous business relationships or partnerships, or ongoing monitoring for account status changes or suspicious activities.

At step 912, the method includes initiating electronic transfer of the owner's share to the registered account. In an exemplary embodiment of the present invention, the electronic transfer system may implement secure financial transaction processing including multiple payment method support such as ACH transfers, wire transfers, or digital wallet payments, real-time transaction processing for immediate payment delivery, international payment capabilities with currency conversion, payment tracking and confirmation systems, and integration with major banking networks and financial institutions.

In some exemplary embodiments of the present invention, the electronic transfer may utilize various payment networks including domestic ACH networks for efficient bank-to-bank transfers, international SWIFT networks for global payments, real-time payment systems such as FedNow or RTP for immediate settlement, digital payment platforms such as PayPal or Stripe for flexible payment options, cryptocurrency networks for alternative payment methods, or mobile payment systems for convenient fund access. The system may further be configured to dynamically disallow or restrict certain transaction types for a given use case based on the nature of the transaction or its associated risk profile.

In some exemplary embodiments of the present invention, the transfer process may include security measures such as transaction encryption using advanced cryptographic protocols, multi-signature authorization for high-value payments, fraud detection monitoring during transaction processing, transaction limits and velocity checks for security protection, backup payment methods in case of primary payment failure, or secure audit trails for regulatory compliance and dispute resolution.

In some exemplary embodiments of the present invention, the payment processing may implement various timing options including immediate payment for urgent requests or premium service tiers, scheduled payment on regular intervals such as weekly or monthly cycles, batch processing for efficient transaction handling and reduced processing costs, flexible payment timing based on owner preferences and cash flow needs, or milestone-based payments tied to rental completion or performance targets.

At step 914, the method includes updating financial records and logging commission details for audit compliance. In an exemplary embodiment of the present invention, the financial record management system may implement comprehensive accounting and compliance mechanisms including detailed transaction logging with immutable audit trails, regulatory compliance documentation for tax reporting and financial oversight, automated bookkeeping with integration to accounting software, financial reporting generation for business analysis and stakeholder communication, and data retention policies for long-term record preservation.

In some exemplary embodiments of the present invention, the financial logging may include comprehensive transaction details such as complete payment histories with amounts, dates, and recipients, commission calculation breakdowns showing methodology and rates applied, tax withholding records for compliance reporting, currency conversion details for international transactions, dispute and adjustment records for transparency and audit purposes, or reconciliation reports for accounting verification.

In some exemplary embodiments of the present invention, the audit compliance may encompass various regulatory requirements including Generally Accepted Accounting Principles (GAAP) compliance for financial reporting, Sarbanes-Oxley compliance for public company requirements, international financial reporting standards for global operations, tax authority compliance for various jurisdictions, industry-specific regulations for financial technology and platform businesses, or consumer protection regulations for marketplace platforms.

In some exemplary embodiments of the present invention, the record management may implement advanced technologies such as blockchain-based immutable record keeping, distributed ledger systems for transparent financial tracking, automated compliance checking using rule engines, machine learning for anomaly detection in financial patterns, integration with regulatory reporting systems for automated compliance submission, or real-time dashboard analytics for financial performance monitoring.

At step 916, the method includes notifying third-party owner of successful payment transaction and summary of earnings. In an exemplary embodiment of the present invention, the notification system may implement comprehensive communication mechanisms including multi-channel notification delivery through email, SMS, mobile app push notifications, or dashboard alerts, detailed earnings statements with complete transaction breakdowns, performance analytics showing rental statistics and trends, and customer service integration for payment-related questions or issues.

In some exemplary embodiments of the present invention, the notification content may include comprehensive earnings information such as detailed payment summaries with gross income, commission deductions, and net payments, rental performance metrics including utilization rates and customer satisfaction scores, comparative analysis showing performance against previous periods or platform averages, predictive earnings forecasts based on current rental pipeline, recommendations for optimization and increased earnings, or tax documentation for owner compliance requirements.

In some exemplary embodiments of the present invention, the communication system may implement personalization features including customized reporting formats based on owner preferences, language localization for international owners, mobile-optimized notifications for on-the-go access, integration with third-party accounting software for seamless financial management, or interactive dashboards for detailed earnings exploration and analysis.

In some exemplary embodiments of the present invention, the earnings summary may include analytical insights such as trends analysis showing growth or decline patterns, seasonal patterns affecting rental demand and earnings, customer feedback compilation for service improvement insights, market analysis comparing owner performance against platform benchmarks and industry standards, or strategic recommendations for robot positioning, pricing optimization, or service enhancement.

In some exemplary embodiments of the present invention, the process concludes the third-party owner commission processing workflow with various follow-up activities including performance evaluation for owner assessment, relationship management for ongoing partnership optimization, data analytics for platform improvement, and strategic planning for owner network expansion and platform growth.

In some exemplary embodiments of the present invention, the conclusion may include quality assurance measures such as payment accuracy verification through automated and manual checks, customer satisfaction surveys for commission and payment process feedback, process improvement analysis for workflow optimization, or compliance verification ensuring all regulatory requirements were met during the commission processing cycle.

In some exemplary embodiments of the present invention, the commission processing module may be configured to manage third-party owner payments within the on-demand robot rental platform. The module may identify robots owned by registered third-party owners, verify ownership through multi-layer authentication systems, and retrieve transaction details including rental duration and total income. It may then calculate the platform's commission based on predefined rates, performance metrics, and agreement terms, followed by computing the payable amount to each owner after applicable deductions such as maintenance, insurance, or transport costs.

In some exemplary embodiments of the present invention, the module may securely verify owner account credentials, initiate electronic fund transfers via integrated payment gateways, and log all financial transactions for audit compliance and reporting. Additionally, the commission processing module may generate detailed earnings summaries and notify owners of successful payments while maintaining transparent records through advanced technologies such as blockchain or distributed ledgers. This ensures accurate, secure, and efficient financial management of third-party owner commissions within the system.

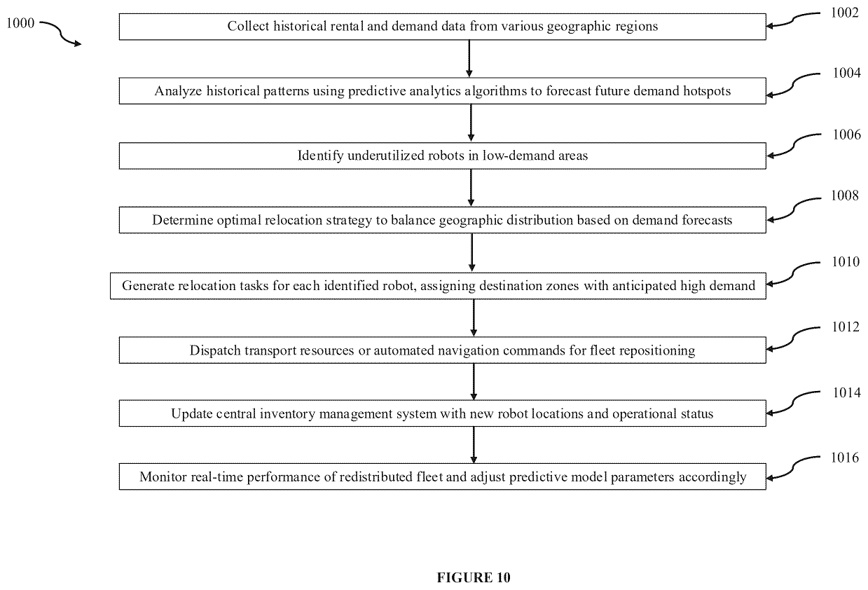

In some exemplary embodiments of the present invention, reference is made to FIG. 10 illustrating a non-limiting example of a method 1000 for implementing predictive analytics and fleet redistribution operations, also known as robot pre-positioning, in an on-demand robot rental system. At step 1002, the method includes collecting historical rental and demand data from various geographic regions. In an exemplary embodiment of the present invention, the data collection system may implement a comprehensive analytics infrastructure including multi-regional data aggregation from distributed sources, temporal data warehousing for longitudinal analysis, geospatial data integration for location-based insights, customer behavior analytics for demand pattern recognition, and real-time data streaming for continuous monitoring and analysis.

In some exemplary embodiments of the present invention, the historical rental data collection may encompass comprehensive transaction records including detailed rental histories with timestamps and duration tracking, customer demographics and behavior patterns, robot type preferences and usage statistics, seasonal demand variations and cyclical patterns, geographic distribution of rentals across service areas, or pricing elasticity data showing demand response to pricing changes.

In some exemplary embodiments of the present invention, the demand data aggregation may utilize various data sources including customer request logs with unfulfilled demand tracking, competitor analysis data for market intelligence, economic indicators affecting consumer spending patterns, demographic data for population-based demand modelling, event calendars for demand spike predictions, or social media sentiment analysis for trend identification and market forecasting.

In some exemplary embodiments of the present invention, the geographic data collection may implement advanced geospatial analytics including GPS coordinate tracking for precise location analysis, administrative boundary mapping for regional analysis, transportation network data for accessibility assessment, demographic mapping for market segmentation, urban development data for growth pattern analysis, or climate data for environmental impact assessment on demand patterns.

In some exemplary embodiments of the present invention, the data collection infrastructure may utilize distributed computing systems including Apache Spark for large-scale data processing, Hadoop ecosystems for big data storage and analysis, cloud data warehouses such as Amazon Redshift or Google BigQuery, streaming analytics platforms for real-time processing, or data lakes for storing structured and unstructured data from multiple sources.

In some exemplary embodiments of the present invention, the data quality management may implement comprehensive validation including data cleansing algorithms for error detection and correction, duplicate detection and removal procedures, missing data imputation using statistical methods, outlier detection and handling procedures, or data lineage tracking for audit trails and quality assurance.

At step 1004, the method includes analyzing historical patterns using predictive analytics algorithms to forecast future demand hotspots. In an exemplary embodiment of the present invention, the predictive analytics system may implement machine learning models including time series forecasting algorithms such as ARIMA or Prophet, neural network models for complex pattern recognition, ensemble methods combining multiple prediction algorithms, deep learning models for high-dimensional pattern analysis, and reinforcement learning for adaptive prediction based on feedback and outcomes.

In some exemplary embodiments of the present invention, the predictive algorithms may incorporate various analytical techniques including seasonal decomposition for identifying cyclical patterns, trend analysis for long-term growth or decline identification, correlation analysis for identifying demand drivers and relationships, clustering algorithms for geographic market segmentation, or anomaly detection for identifying unusual demand patterns or market disruptions.

In some exemplary embodiments of the present invention, the demand forecasting may consider multiple predictive factors including historical demand patterns with weighted recent data, weather forecasts affecting outdoor robot usage, economic indicators impacting consumer spending, local events and festivals driving demand spikes, construction and development projects affecting geographic demand, or competitive analysis for market share predictions.

In some exemplary embodiments of the present invention, the hotspot identification may utilize spatial analytics including heat mapping for visual demand intensity representation, geographic clustering for identifying demand concentration areas, accessibility analysis for evaluating service coverage gaps, proximity analysis for optimal resource positioning, or network analysis for understanding demand flow patterns and customer movement.

In some exemplary embodiments of the present invention, the forecasting models may implement various temporal horizons including short-term forecasts for operational planning within days or weeks, medium-term forecasts for tactical resource allocation within months, long-term forecasts for strategic planning and fleet expansion, or real-time forecasts for immediate demand response and dynamic pricing adjustments.

In some exemplary embodiments of the present invention, the predictive system may incorporate external data sources including economic indicators from government agencies, weather data from meteorological services, traffic patterns from transportation authorities, demographic trends from census data, or industry reports for market intelligence and competitive analysis.

At step 1006, the method includes identifying underutilized robots in low-demand areas for repositioning. In an exemplary embodiment of the present invention, the underutilization identification system may implement comprehensive fleet analysis including utilization rate calculations across different time periods and geographic regions, idle time analysis for identifying robots with excessive downtime, comparative performance analysis against fleet averages and targets, cost-benefit analysis for repositioning decisions, and predictive modelling for anticipated utilization in current versus alternative locations.

In some exemplary embodiments of the present invention, the underutilization metrics may include various performance indicators such as rental frequency compared to fleet averages, idle time percentages during peak and off-peak periods, revenue generation per robot per time period, customer demand fulfilment rates in current locations, maintenance costs relative to utilization levels, or opportunity cost analysis for alternative deployment scenarios.

In some exemplary embodiments of the present invention, the low-demand area identification may utilize geospatial analysis including demand density mapping for identifying sparse demand regions, competitive analysis for market saturation assessment, demographic analysis for understanding customer base limitations, infrastructure analysis for service delivery challenges, or economic analysis for market viability assessment.

In some exemplary embodiments of the present invention, the robot selection for repositioning may consider various factors including robot health and maintenance status for relocation readiness, transportation costs and logistics complexity for cost-effective moves, robot type suitability for target market demand, customer service impact during transition periods, or strategic value for market expansion and competitive positioning.

In some exemplary embodiments of the present invention, the identification algorithms may implement optimization techniques including linear programming for resource allocation optimization, genetic algorithms for complex multi-variable optimization, machine learning models for pattern-based identification, simulation modeling for scenario analysis and impact assessment, or decision trees for structured decision-making processes.

At step 1008, the method includes determining optimal relocation strategy to balance geographic distribution based on demand forecasts. In an exemplary embodiment of the present invention, the relocation strategy optimization may implement decision-making frameworks including multi-objective optimization balancing utilization, costs, and service levels, constraint programming for handling logistics limitations, game theory approaches for competitive positioning, dynamic programming for sequential decision optimization, and Monte Carlo simulation for uncertainty analysis and risk assessment. This strategy may encompass both tactical, short-term repositioning of individual robots and strategic, long-term planning, such as using predictive algorithms to identify optimal locations for new central warehouses or local micro-depots to minimize future delivery costs and response times.

In some exemplary embodiments of the present invention, the geographic distribution balancing may consider various strategic objectives including optimizing fleet coverage, market coverage optimization for maximum service area penetration, demand-supply matching for optimal utilization rates, response time minimization for customer satisfaction, cost efficiency through transportation optimization, or competitive positioning for market share protection and growth.

In some exemplary embodiments of the present invention, the relocation strategy may incorporate various constraints including transportation capacity limitations and vehicle availability, budget constraints for relocation operations, time constraints for urgent market opportunities, regulatory restrictions on robot movement or operation, or operational constraints such as maintenance schedules and robot availability.

In some exemplary embodiments of the present invention, the optimization algorithms may evaluate multiple scenarios including incremental repositioning for gradual fleet adjustment, bulk repositioning for major market shifts, seasonal repositioning for cyclical demand patterns, emergency repositioning for unexpected demand spikes, or strategic repositioning for market expansion and competitive response.

In some exemplary embodiments of the present invention, the strategy determination may implement risk assessment including demand forecast uncertainty analysis, competitive response prediction, operational risk evaluation for relocation activities, financial risk assessment for repositioning investments, or market risk evaluation for new geographic areas.

At step 1010, the method includes generating relocation tasks for each identified robot, assigning destination zones with anticipated high demand. In an exemplary embodiment of the present invention, the task generation system may implement comprehensive logistics planning including detailed relocation instructions with pickup and delivery coordinates, timeline specifications with scheduling optimization, resource allocation for transportation and personnel, priority assignment for urgent relocations, and contingency planning for unexpected delays or issues.

In some exemplary embodiments of the present invention, the destination zone assignment may utilize advanced matching algorithms including demand-capacity matching for optimal resource allocation, distance optimization for cost-effective transportation, market penetration strategies for competitive positioning, customer segment matching for robot type optimization, or infrastructure compatibility assessment for operational feasibility.

In some exemplary embodiments of the present invention, the relocation tasks may include comprehensive operational details such as robot preparation procedures including cleaning and maintenance checks, transportation logistics including vehicle selection and route optimization, destination setup requirements including local partnerships or storage arrangements, timeline coordination with current rental commitments, or documentation requirements for audit trails and compliance.

In some exemplary embodiments of the present invention, the task prioritization may consider various factors including urgency based on demand forecasts and market opportunities, cost efficiency for budget optimization, strategic importance for competitive positioning, operational complexity for resource planning, or customer impact for service continuity and satisfaction.

In some exemplary embodiments of the present invention, the destination zone analysis may include market assessment such as demand density analysis for target area selection, competitor presence evaluation for strategic positioning, infrastructure readiness assessment for operational support, regulatory compliance verification for legal operation, or partnership opportunities for local market penetration.

At step 1012, the method includes dispatching transport resources or automated navigation commands for fleet repositioning. In an exemplary embodiment of the present invention, the dispatch system may implement comprehensive transportation management including multi-modal transportation options such as trucks, autonomous vehicles, or self-navigation for capable robots, route optimization for time and cost efficiency, real-time tracking and monitoring systems, communication protocols for coordination and updates, and exception handling for delays or complications.

In some exemplary embodiments of the present invention, the transport resource selection may consider various factors including cargo capacity for robot size and weight requirements, geographic coverage for service area accessibility, cost efficiency for budget optimization, reliability based on historical performance metrics, availability for immediate or scheduled dispatch, or specialized equipment for robot handling and protection.

In some exemplary embodiments of the present invention, the automated navigation commands may include comprehensive routing instructions such as GPS waypoints and navigation paths, traffic optimization with real-time traffic data integration, safety protocols for autonomous travel, charging station locations for battery management during long journeys, or emergency procedures for unexpected situations or system failures.

In some exemplary embodiments of the present invention, the dispatch coordination may implement various communication systems including real-time GPS tracking for location monitoring, mobile communication for driver or robot coordination, automated status updates for system integration, customer notification systems for service impact communication, or escalation procedures for handling delays or issues.

At step 1014, the method includes updating central inventory management system with new robot locations and operational status. In an exemplary embodiment of the present invention, the inventory update system may implement real-time database management including synchronized multi-location database updates, transactional integrity for data consistency, audit trails for change tracking, automated status monitoring, and integration with various operational systems for comprehensive fleet visibility.

In some exemplary embodiments of the present invention, the location tracking may utilize various technologies including GPS systems for precise location monitoring, cellular networks for communication and updates, IoT sensors for environmental and operational data, RFID or NFC technology for proximity-based tracking, or blockchain technology for immutable location and status records.

In some exemplary embodiments of the present invention, the operational status updates may include comprehensive robot information such as current availability for rental assignments, maintenance status and service requirements, battery level and charging needs, health parameters and diagnostic data, or capability status for different service types and customer requirements.

In some exemplary embodiments of the present invention, the inventory integration may connect with various systems including customer relationship management for service delivery coordination, financial systems for cost tracking and billing, maintenance management for service scheduling, business intelligence for performance analysis, or regulatory compliance systems for operational reporting.

At step 1016, the method includes monitoring real-time performance of redistributed fleet and adjusting predictive model parameters accordingly. In an exemplary embodiment of the present invention, the performance monitoring system may implement comprehensive analytics including real-time dashboard displays with key performance indicators, automated performance alerts for threshold breaches, comparative analysis against predictions and targets, trend analysis for identifying performance patterns, and feedback loops for continuous model improvement and optimization.

In a further embodiment, the data aggregated and analyzed by the predictive analytics module 1000 may be used to generate fleet composition recommendations. By correlating historical demand hotspots with the specific robot types requested (e.g., cleaning vs. delivery) in those areas, the system can provide strategic insights to administrators, such as recommending the purchase of more robots of a specific capability profile to service an emerging market, or suggesting the retirement of underutilized models, thereby optimizing the capital investment in the overall fleet composition.

In some exemplary embodiments of the present invention, the real-time monitoring may track various performance metrics including utilization rates in new locations compared to predictions, customer satisfaction scores for relocated robots, revenue generation and profitability analysis, operational efficiency metrics for relocation activities, or market penetration success in target areas.

In some exemplary embodiments of the present invention, the predictive model adjustment may implement machine learning techniques including online learning for continuous model updates, reinforcement learning for performance-based optimization, ensemble methods for combining multiple models, hyperparameter tuning for model optimization, or A/B testing for comparing different prediction approaches.

In some exemplary embodiments of the present invention, the performance feedback may include various data sources such as customer usage patterns and satisfaction feedback, operational metrics from relocated robots, financial performance data including revenue and costs, competitive intelligence on market response, or external factors affecting performance such as economic or weather conditions.

In some exemplary embodiments of the present invention, the method concludes the predictive analytics and fleet redistribution process. In an exemplary embodiment of the present invention, the process conclusion may trigger comprehensive evaluation activities including redistribution success assessment through performance metrics analysis, cost-benefit evaluation of relocation activities, customer impact assessment for service quality, competitive positioning analysis for market effectiveness, and strategic planning for future redistribution activities and fleet optimization.

In some exemplary embodiments of the present invention, the conclusion may include reporting and documentation such as redistribution performance reports with detailed metrics and analysis, lessons learned documentation for process improvement, financial impact assessment for business planning, customer feedback compilation for service enhancement, or strategic recommendations for future fleet management and market expansion activities.

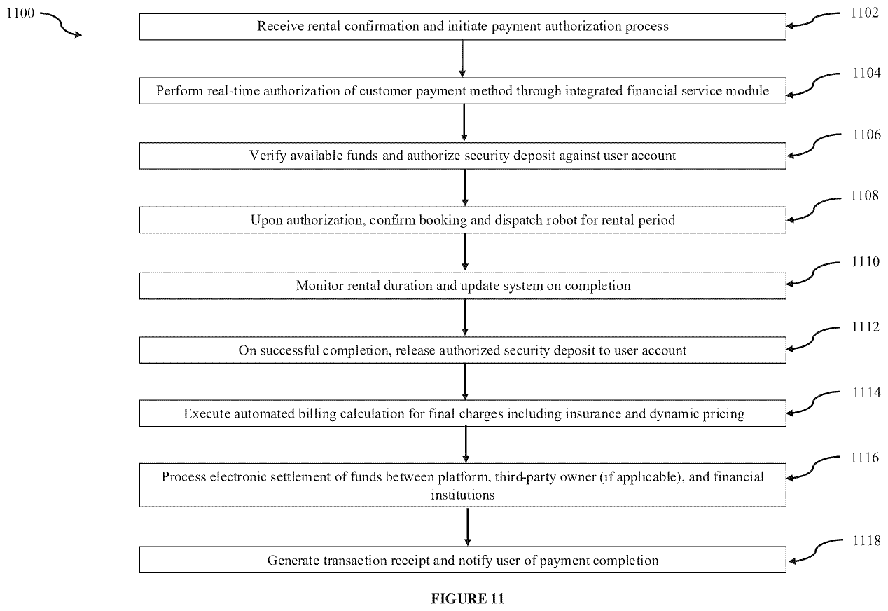

In some exemplary embodiments of the present invention, reference is made to FIG. 11 illustrating a non-limiting example of a method 1100 for payment authorization and settlement processing in an on-demand robot rental system. At step 1102, the method includes receiving rental confirmation and initiating payment authorization process. In an exemplary embodiment of the present invention, the payment authorization system may implement comprehensive financial transaction management including multi-layered security protocols for fraud prevention, real-time payment processing integration with major financial institutions, comprehensive customer verification procedures, automated billing system coordination, and regulatory compliance mechanisms for financial services and consumer protection.

In some exemplary embodiments of the present invention, the rental confirmation reception may utilize secure communication protocols including encrypted data transmission using TLS/SSL encryption, digital signature verification for transaction authenticity, multi-factor authentication for customer identity confirmation, tokenization of sensitive payment information, or blockchain-based transaction recording for immutable audit trails and dispute resolution.

In some exemplary embodiments of the present invention, the payment authorization initiation may encompass comprehensive transaction preparation including customer payment method validation, rental cost calculation with all applicable fees and taxes, terms and conditions acceptance verification, legal compliance checking for consumer protection regulations, or risk assessment analysis for fraud detection and prevention.

In some exemplary embodiments of the present invention, the authorization process may implement various security measures including device fingerprinting for fraud detection, IP geolocation verification for transaction authenticity, velocity checking for unusual transaction patterns, machine learning algorithms for behavioral analysis, or real-time blacklist screening against known fraudulent accounts or payment methods.

In some exemplary embodiments of the present invention, the payment system integration may support multiple financial service providers including major credit card networks such as Visa, Mastercard, and American Express, digital payment platforms such as PayPal, Apple Pay, and Google Pay, banking networks for direct account debits, cryptocurrency payment processors, or installment payment services for flexible customer financing options.

In some exemplary embodiments of the present invention, the confirmation processing may include comprehensive record-keeping such as transaction timestamp logging with nanosecond precision, customer interaction history, rental agreement terms and conditions, service delivery specifications, or audit trail generation for regulatory compliance and dispute resolution.

At step 1104, the method includes performing real-time authorization of customer payment method through integrated financial service module. In an exemplary embodiment of the present invention, the real-time authorization system may implement financial processing including instant payment method verification, fund availability checking, credit limit assessment, regulatory compliance verification, fraud detection algorithms, and seamless integration with banking networks and payment processors for immediate transaction approval or decline.

In some exemplary embodiments of the present invention, the real-time authorization may utilize various payment processing networks including automated clearing house (ACH) networks for bank account verification, credit card processing networks for immediate authorization, real-time payment systems such as FedNow or RTP for instant settlement, international payment networks for global customer support, or alternative payment method processors for digital wallets and cryptocurrency.

In some exemplary embodiments of the present invention, the financial service module integration may implement comprehensive APIs including secure REST APIs for payment processor communication, webhook integration for real-time status updates, error handling and retry mechanisms for network reliability, rate limiting for system protection, or load balancing for high-volume transaction processing.

In some exemplary embodiments of the present invention, the authorization process may include multiple validation layers such as payment method authenticity verification, customer identity confirmation through bank verification, available balance or credit limit checking, transaction amount validation against account limits, or regulatory compliance checking for anti-money laundering and know-your-customer requirements.

In some exemplary embodiments of the present invention, the real-time processing may implement advanced technologies including machine learning algorithms for fraud detection and risk assessment, artificial intelligence for pattern recognition and anomaly detection, blockchain technology for secure transaction recording, quantum encryption for enhanced security, or distributed processing for scalability and fault tolerance.

In some exemplary embodiments of the present invention, the authorization system may include comprehensive error handling including graceful degradation for partial system failures, automatic retry mechanisms for transient errors, customer notification systems for authorization issues, alternative payment method suggestions for declined transactions, or customer service integration for complex authorization problems.

At step 1106, the method includes verifying available funds and authorizing security deposit against user account. In an exemplary embodiment of the present invention, the fund verification and deposit authorization system may implement financial risk management including dynamic deposit calculation based on robot value and customer risk profile, temporary fund holding mechanisms, escrow services for secure deposit management, automated release procedures, and comprehensive dispute resolution processes for deposit-related issues.

In some exemplary embodiments of the present invention, the available funds verification may utilize various checking mechanisms including real-time balance inquiries through banking APIs, credit limit verification for credit card transactions, overdraft protection assessment, account status verification for active and valid accounts, or transaction history analysis for spending pattern validation.

In some exemplary embodiments of the present invention, the security deposit calculation may consider multiple risk factors including robot market value and replacement cost, customer credit score and payment history, rental duration and usage risk assessment, geographic risk factors based on location, historical damage rates for similar rentals, or insurance coverage levels and deductibles.

In some exemplary embodiments of the present invention, the deposit authorization may implement various hold mechanisms including credit card pre-authorization holds, bank account fund reservations, digital wallet balance holds, cryptocurrency escrow services, or letter of credit arrangements for corporate customers with established credit relationships.

In some exemplary embodiments of the present invention, the fund verification process may include compliance measures such as regulatory limit checking for transaction amounts, suspicious activity monitoring for unusual deposit patterns, international compliance for cross-border transactions, or tax withholding considerations for certain transaction types or customer categories.

In some exemplary embodiments of the present invention, the deposit management may implement customer communication features including clear deposit amount disclosure, hold duration explanation, release condition specification, dispute procedures for deposit disagreements, or alternative deposit options such as insurance coverage or third-party guarantees.

At step 1108, the method includes confirming booking and dispatching robot for rental period upon successful authorization. In an exemplary embodiment of the present invention, the booking confirmation and robot dispatch system may implement comprehensive operational coordination including automated inventory allocation, real-time scheduling optimization, customer notification systems, service delivery coordination, and quality assurance procedures for seamless customer experience.

In some exemplary embodiments of the present invention, the booking confirmation may include detailed customer communication such as rental agreement confirmation with complete terms and conditions, robot specifications and capability descriptions, delivery scheduling with estimated arrival times, customer preparation instructions for robot reception, or customer service contact information for support during the rental period.

In some exemplary embodiments of the present invention, the robot dispatch process may coordinate multiple operational elements including inventory management system updates for robot allocation, transport resource scheduling for delivery logistics, robot preparation procedures including cleaning and configuration, route optimization for efficient delivery, or tracking system activation for real-time monitoring throughout the rental period.

In some exemplary embodiments of the present invention, the dispatch authorization may implement verification procedures such as final payment confirmation, customer identity verification, delivery location accessibility assessment, robot health and readiness verification, or insurance coverage activation for liability protection during the rental period.

In some exemplary embodiments of the present invention, the operational coordination may include integration with various systems such as customer relationship management for service history tracking, fleet management for optimal robot allocation, maintenance scheduling for service coordination, financial systems for revenue recognition, or business intelligence for performance analytics and optimization.

At step 1110, the method includes monitoring rental duration and updating system on completion. In an exemplary embodiment of the present invention, the rental monitoring system may implement comprehensive tracking including real-time robot status monitoring, customer usage analytics, operational performance measurement, predictive completion analysis, and automated system updates for efficient fleet management and customer service.

In some exemplary embodiments of the present invention, the rental duration monitoring may utilize various tracking technologies including GPS tracking for location monitoring, IoT sensors for operational status, cellular communication for real-time updates, usage analytics for customer behavior patterns, or predictive algorithms for completion time estimation based on usage patterns.

In some exemplary embodiments of the present invention, the system updates may include comprehensive data management such as real-time inventory status updates, customer rental history recording, robot utilization statistics, maintenance schedule adjustments, or financial transaction logging for accounting and billing purposes.

In some exemplary embodiments of the present invention, the monitoring system may implement automated alerts including rental period expiration notifications, early return processing, extension request handling, emergency situation detection, or customer service escalation for issues requiring human intervention.

In some exemplary embodiments of the present invention, the completion detection may utilize various signals such as customer-initiated return procedures, automated robot return to designated locations, time-based completion triggers, usage pattern analysis indicating rental conclusion, or manual confirmation through customer service interactions.

At step 1112, the method includes releasing authorized security deposit to user account upon successful completion. In an exemplary embodiment of the present invention, the deposit release system may implement automated financial processing including damage assessment verification, final billing calculation, automated refund processing, customer notification procedures, and audit trail generation for financial compliance and customer service.

In some exemplary embodiments of the present invention, the deposit release process may include comprehensive verification procedures such as robot condition assessment through inspection reports, damage claim processing if applicable, final usage charges calculation, customer dispute resolution, or regulatory compliance checking for refund processing.

In some exemplary embodiments of the present invention, the successful completion criteria may encompass various requirements including timely robot return, satisfactory robot condition upon return, compliance with rental terms and conditions, resolution of any customer service issues, or completion of customer satisfaction surveys for service quality assessment.

In some exemplary embodiments of the present invention, the deposit release mechanism may utilize various refund methods including credit card refund processing, bank account direct deposit, digital wallet credit, check payment for alternative payment preferences, or credit toward future rentals for customer retention and loyalty programs.

In some exemplary embodiments of the present invention, the release processing may implement timing considerations such as immediate release for successful completions, holding periods for damage assessment, escalation procedures for disputed charges, or regulatory compliance timelines for refund processing requirements.

At step 1114, the method includes executing automated billing calculation for final charges including insurance and dynamic pricing. In an exemplary embodiment of the present invention, the automated billing system may implement comprehensive financial calculation including base rental fee computation, dynamic pricing adjustments, insurance premium calculation, additional service charges, tax calculations, discount applications, and transparent billing statement generation for customer review and payment processing.

In some exemplary embodiments of the present invention, the billing calculation may incorporate various charge components such as time-based rental fees calculated by duration, usage-based charges for specific robot functions, delivery and pickup fees based on distance and logistics complexity, insurance premiums based on risk assessment, or surge pricing multipliers applied during high-demand periods.

In some exemplary embodiments of the present invention, the dynamic pricing integration may utilize real-time market data including current supply and demand conditions, competitive pricing analysis, seasonal adjustments, geographic pricing variations, or customer segment pricing for loyalty or premium service tiers.

In some exemplary embodiments of the present invention, the insurance calculation may consider multiple factors such as customer risk profile, robot value and type, rental duration and usage patterns, geographic risk factors, or coverage level selections chosen by the customer during the booking process.

In some exemplary embodiments of the present invention, the billing automation may implement quality assurance measures including calculation verification through multiple algorithms, manual review thresholds for high-value transactions, customer notification of billing details, dispute resolution procedures, or audit trail generation for regulatory compliance.

At step 1116, the method includes processing electronic settlement of funds between platform, third-party owner (if applicable), and financial institutions. In an exemplary embodiment of the present invention, the electronic settlement system may implement multi-party financial processing including automated fund distribution calculations, regulatory compliance verification, international payment processing, tax calculation and withholding, and comprehensive audit trail generation for financial reporting and regulatory compliance.

In some exemplary embodiments of the present invention, the multi-party settlement may coordinate various payment flows including platform commission retention, third-party owner payment processing, payment processor fee deductions, tax withholding for regulatory compliance, or charitable contribution processing for corporate social responsibility programs.

In some exemplary embodiments of the present invention, the electronic settlement may utilize various payment networks including domestic ACH for efficient bank transfers, international wire transfer systems, real-time payment networks for immediate settlement, blockchain-based settlement for transparency and security, or digital asset settlement for cryptocurrency transactions.

In some exemplary embodiments of the present invention, the settlement processing may implement security measures such as multi-signature authorization for high-value transfers, encryption of financial data, fraud monitoring during settlement, regulatory reporting for suspicious activity, or backup settlement procedures for system failures.

At step 1118, the method includes generating transaction receipt and notifying user of payment completion. In an exemplary embodiment of the present invention, the receipt generation and notification system may implement comprehensive customer communication including detailed transaction summaries, regulatory disclosure requirements, customer service integration, multiple communication channels, and record retention for customer access and regulatory compliance.

In some exemplary embodiments of the present invention, the transaction receipt may include comprehensive information such as itemized charge breakdowns, payment method details, transaction timestamps, regulatory disclosures, customer service contact information, or digital receipt options for environmental sustainability and customer convenience.

In some exemplary embodiments of the present invention, the customer notification may utilize multiple communication channels including email receipts with detailed transaction information, SMS notifications for immediate confirmation, mobile app push notifications, paper receipt options for customer preference, or integration with customer accounting software for business customers.

In some exemplary embodiments of the present invention, the receipt generation may implement various formats including PDF receipts for professional documentation, HTML receipts for interactive elements, mobile-optimized receipts for smartphone viewing, printed receipts for physical documentation, or API-compatible receipts for third-party system integration.

In some exemplary embodiments of the present invention, the method concludes the payment authorization and settlement process. In an exemplary embodiment of the present invention, the process conclusion may trigger various follow-up activities including customer satisfaction surveys, loyalty program updates, financial reconciliation procedures, regulatory reporting requirements, and analytics data collection for business intelligence and process optimization.

In some exemplary embodiments of the present invention, the conclusion may include comprehensive record archival such as transaction history storage, audit trail preservation, customer interaction logging, financial compliance documentation, or business analytics data preparation for strategic planning and operational improvement.

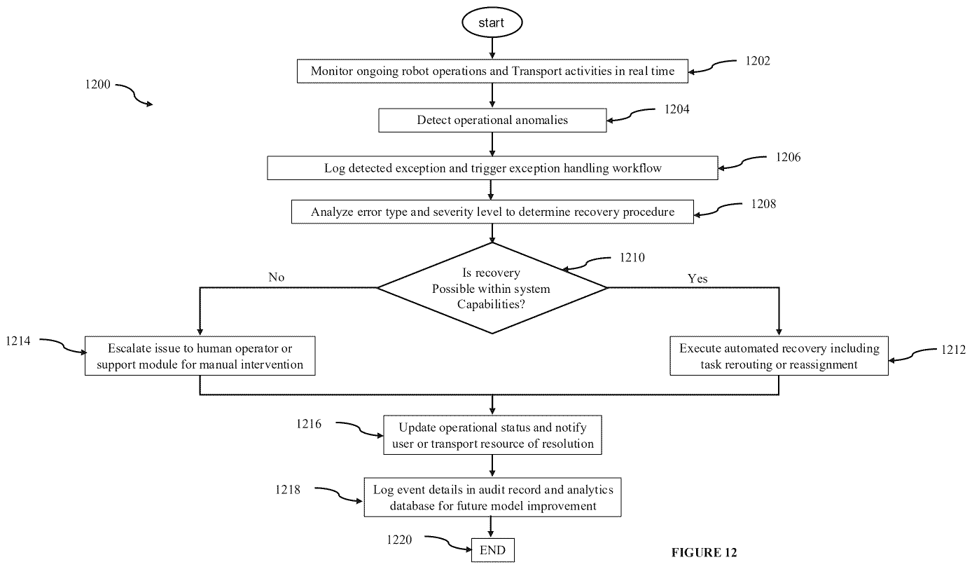

In some exemplary embodiments of the present invention, reference is made to FIG. 12 illustrating a non-limiting example of a method 1200 for exception handling and failure recovery in an on-demand robot rental system. At step 1202, the method includes monitoring ongoing robot operations and transport activities in real-time. In an exemplary embodiment of the present invention, the real-time monitoring system may implement comprehensive surveillance infrastructure including distributed sensor networks for multi-parameter tracking, IoT connectivity for continuous data streaming, cloud-based analytics for pattern recognition, artificial intelligence algorithms for anomaly detection, and automated alerting systems for immediate response to operational deviations.

In some exemplary embodiments of the present invention, the ongoing robot operations monitoring may encompass comprehensive operational metrics including battery level and power consumption tracking, GPS location monitoring with geofencing capabilities, operational status indicators for system health assessment, customer interaction monitoring for service quality assurance, environmental sensor data for safety and performance optimization, or task completion progress tracking for service delivery verification.

In some exemplary embodiments of the present invention, the transport activities monitoring may include comprehensive logistics tracking such as vehicle location and route adherence monitoring, driver communication and status updates, delivery timeline tracking with predictive arrival estimates, cargo security monitoring for robot protection during transport, traffic and weather condition integration for route optimization, or fuel consumption and vehicle performance monitoring for operational efficiency.

In some exemplary embodiments of the present invention, the real-time monitoring infrastructure may utilize various technologies including cellular networks for wide-area connectivity, satellite communication for remote area coverage, Wi-Fi networks for high-bandwidth data transmission, Bluetooth connectivity for short-range device communication, LoRaWAN for low-power long-range IoT connectivity, or edge computing systems for local data processing and reduced latency.

In some exemplary embodiments of the present invention, the monitoring system may implement data collection optimization including data compression algorithms for bandwidth efficiency, prioritized data transmission for critical information, adaptive sampling rates based on operational conditions, data caching mechanisms for network interruption tolerance, or redundant communication paths for high-availability data transmission.

In some exemplary embodiments of the present invention, the operational monitoring may include predictive analytics such as failure prediction algorithms based on operational patterns, maintenance requirement forecasting, performance degradation trend analysis, customer satisfaction prediction based on service metrics, or demand pattern analysis for operational optimization and resource planning.

At step 1204, the method includes detecting operational anomalies such as communication failure, delayed pickup, or route deviation. In an exemplary embodiment of the present invention, the anomaly detection system may implement pattern recognition including machine learning algorithms trained on historical operational data, statistical analysis for outlier identification, rule-based detection for known failure patterns, multi-dimensional analysis for complex anomaly recognition, and real-time scoring systems for anomaly severity assessment and prioritization.

In some exemplary embodiments of the present invention, the communication failure detection may utilize various indicators including network connectivity loss detection, heartbeat signal monitoring for device responsiveness, communication latency threshold monitoring, data transmission error rate analysis, protocol-specific failure detection for different communication methods, or backup communication system activation for redundancy and reliability.

In some exemplary embodiments of the present invention, the delayed pickup detection may implement time-based analysis including scheduled time comparison with actual pickup times, traffic condition integration for realistic time expectations, customer notification analysis for delivery window adherence, historical performance benchmarking for context-aware detection, or predictive delay modeling based on current operational conditions.

In some exemplary embodiments of the present invention, the route deviation detection may utilize geospatial analysis including GPS trajectory monitoring against planned routes, geofencing violation detection for unauthorized area entry, speed pattern analysis for unusual behavior, waypoint adherence monitoring for delivery compliance, or traffic optimization assessment for route efficiency evaluation.

In some exemplary embodiments of the present invention, the anomaly detection algorithms may implement various analytical techniques including clustering algorithms for identifying unusual operational patterns, time series analysis for trend-based anomaly detection, neural networks for complex pattern recognition, decision trees for structured anomaly classification, or ensemble methods combining multiple detection approaches for improved accuracy.

In some exemplary embodiments of the present invention, the detection system may incorporate contextual analysis including weather condition correlation for environment-related anomalies, time-of-day patterns for temporal anomaly assessment, geographic location analysis for area-specific anomaly patterns, customer type correlation for service-level anomaly evaluation, or seasonal pattern integration for cyclical anomaly recognition.

At step 1206, the method includes logging detected exception and triggering exception handling workflow upon anomaly detection. In an exemplary embodiment of the present invention, the exception logging and workflow triggering system may implement comprehensive incident management including detailed exception documentation, automated workflow initiation, priority-based response coordination, multi-system integration for coordinated response, and audit trail generation for compliance and continuous improvement.

In some exemplary embodiments of the present invention, the exception logging may include comprehensive incident documentation such as timestamp and duration recording with high precision, affected system and component identification, anomaly type classification and severity assessment, contextual information including operational conditions at time of occurrence, customer impact analysis, or related system state snapshots for root cause analysis.

In some exemplary embodiments of the present invention, the exception handling workflow triggering may implement automated response systems including rule-based workflow selection based on exception type and severity, escalation procedures for complex or critical exceptions, parallel workflow execution for comprehensive response coordination, timeout mechanisms for ensuring timely response, or manual override capabilities for human intervention when necessary.

In some exemplary embodiments of the present invention, the workflow coordination may integrate with various systems including customer relationship management for customer communication, fleet management for resource reallocation, maintenance systems for technical support, financial systems for cost tracking and billing adjustments, or business intelligence systems for performance impact analysis.

At step 1208, the method includes analyzing error type and severity level to determine recovery procedure. In an exemplary embodiment of the present invention, the error analysis and recovery determination system may implement decision-making including multi-criteria analysis for comprehensive error assessment, machine learning models for optimal recovery strategy selection, cost-benefit analysis for resource allocation decisions, risk assessment for minimizing impact escalation, and adaptive procedures that improve based on historical recovery success rates.

In some exemplary embodiments of the present invention, the error type classification may encompass various categories including technical failures such as hardware malfunctions or software errors, operational failures including process deviations or service interruptions, communication failures affecting connectivity or data transmission, logistics failures involving transportation or delivery issues, customer-related issues including service requests or complaints, or external factors such as weather or infrastructure problems.

In some exemplary embodiments of the present invention, the severity level assessment may utilize multi-dimensional scoring including customer impact severity ranging from minor inconvenience to service disruption, business impact including revenue loss or operational efficiency reduction, safety implications for customer or public safety concerns, regulatory compliance impact for legal or regulatory violations, or reputation risk for brand and customer relationship effects.

In some exemplary embodiments of the present invention, the recovery procedure determination may implement various decision-making algorithms including decision trees for structured procedure selection, expert systems encoding domain knowledge for optimal response, machine learning models trained on historical recovery outcomes, optimization algorithms for resource allocation efficiency, or hybrid approaches combining automated decision-making with human expertise.

In some exemplary embodiments of the present invention, the analysis system may incorporate predictive modeling including failure escalation prediction for proactive intervention, recovery time estimation for customer communication, resource requirement forecasting for capacity planning, success probability assessment for strategy evaluation, or secondary failure risk analysis for comprehensive impact assessment.

At step 1210, the method includes a decision point determining whether recovery is possible within system capabilities. In an exemplary embodiment of the present invention, the recovery feasibility assessment may implement comprehensive capability analysis including resource availability evaluation, technical capability assessment, time constraint analysis, cost-effectiveness evaluation, and risk-benefit analysis to determine optimal response strategies.

In some exemplary embodiments of the present invention, the recovery possibility assessment may consider various factors including available backup systems and redundancy options, spare resource inventory including robots and transportation capacity, technical expertise availability for complex recovery procedures, customer tolerance and flexibility for service adjustments, or alternative service options for maintaining customer satisfaction.

In some exemplary embodiments of the present invention, the decision criteria may include quantitative thresholds such as recovery time limits based on customer service agreements, cost limits for economically viable recovery, resource availability requirements for successful execution, or success probability thresholds for worthwhile recovery attempts.

For the “Yes” path (recovery is possible), at step 1212, the method includes executing automated recovery including task rerouting or reassignment. In an exemplary embodiment of the present invention, the automated recovery system may implement resource reallocation including dynamic task redistribution algorithms, alternative resource identification and deployment, route optimization for service continuity, customer communication for transparency, and performance monitoring for recovery effectiveness verification.

In some exemplary embodiments of the present invention, the task rerouting may utilize various optimization techniques including shortest path algorithms for efficient route recalculation, real-time traffic integration for optimal timing, multi-objective optimization balancing time, cost, and service quality, dynamic programming for sequential decision optimization, or machine learning models for pattern-based route prediction.

In some exemplary embodiments of the present invention, the task reassignment may implement resource matching algorithms including capability-based assignment for optimal robot-task pairing, proximity-based assignment for efficient resource utilization, load balancing algorithms for equitable resource distribution, priority-based assignment for customer service level maintenance, or predictive assignment based on anticipated resource availability.

In some exemplary embodiments of the present invention, the automated recovery may include customer service integration such as proactive customer notification of service adjustments, alternative service option presentation, compensation or credit processing for service disruption, estimated recovery time communication, or customer preference accommodation for service delivery modifications.

For the “No” path (recovery is not possible), at step 1214, the method includes escalating issue to human operator or support module for manual intervention. In an exemplary embodiment of the present invention, the escalation system may implement comprehensive human resource coordination including expert technician assignment based on issue type and complexity, customer service representative engagement for customer communication, management escalation for high-impact issues, vendor coordination for external support requirements, and emergency response procedures for critical safety or security concerns.

In some exemplary embodiments of the present invention, the human operator escalation may include detailed information transfer such as comprehensive exception documentation, attempted recovery history, customer information and service requirements, technical specifications and system status, or recommended action plans based on automated analysis.

In some exemplary embodiments of the present invention, the manual intervention may coordinate various expert resources including field technicians for on-site robot repair or recovery, customer service specialists for customer relationship management, logistics coordinators for alternative transportation arrangements, technical support engineers for complex system issues, or emergency response personnel for safety-critical situations.

In some exemplary embodiments of the present invention, the escalation process may implement priority queuing including urgency-based operator assignment, skill-based routing for expert technician matching, geographic proximity consideration for efficient response, customer tier consideration for service level compliance, or workload balancing for optimal resource utilization.

At step 1216, both recovery paths converge to update operational status and notify user or transport resource of resolution. In an exemplary embodiment of the present invention, the status update and notification system may implement comprehensive communication management including multi-channel customer notification, real-time status dashboard updates, automated documentation generation, performance metrics recording, and stakeholder communication for transparency and accountability.

In some exemplary embodiments of the present invention, the operational status updates may include comprehensive information such as current service status and recovery progress, estimated completion times for service restoration, alternative service arrangements if applicable, compensation or credit information for service disruption, or contact information for additional customer support.

In some exemplary embodiments of the present invention, the notification system may utilize multiple communication channels including SMS alerts for immediate notification, email updates with detailed information, mobile app push notifications, voice calls for urgent communications, or in-app messaging for real-time customer interaction.

In some exemplary embodiments of the present invention, the user notification may include personalized communication such as customer-specific service impact explanation, alternative option recommendations based on customer history, loyalty program benefits for service disruption compensation, or proactive customer service outreach for satisfaction assurance.

At step 1218, the method includes logging event details in audit record and analytics database for future model improvement. In an exemplary embodiment of the present invention, the event logging and analytics system may implement comprehensive data management including detailed incident documentation, root cause analysis data collection, recovery effectiveness measurement, customer satisfaction impact assessment, and continuous improvement data aggregation for predictive model enhancement.

In some exemplary embodiments of the present invention, the audit record documentation may include comprehensive event information such as complete timeline of exception occurrence and resolution, all automated and manual actions taken during recovery, resource utilization and cost impact, customer communication history, or outcome assessment including service restoration success and customer satisfaction.

In some exemplary embodiments of the present invention, the analytics database may support various analytical capabilities including trend analysis for identifying recurring exception patterns, root cause analysis for systematic improvement opportunities, performance benchmarking for service level optimization, predictive modelling for proactive exception prevention, or machine learning model training for enhanced automated response capabilities.

In some exemplary embodiments of the present invention, the future model improvement may utilize various data science techniques including feature engineering for improved anomaly detection, algorithm optimization for better recovery strategy selection, ensemble methods for combining multiple prediction models, reinforcement learning for adaptive recovery procedures, or transfer learning for applying successful recovery patterns across different scenarios.

At step 1220, the method concludes the exception handling and failure recovery process. In an exemplary embodiment of the present invention, the process conclusion may trigger comprehensive evaluation including recovery success assessment, customer satisfaction measurement, operational impact analysis, cost-effectiveness evaluation, and strategic planning for system resilience improvement and exception prevention.

In some exemplary embodiments of the present invention, the conclusion may include reporting and documentation such as exception handling performance reports, lessons learned documentation, customer impact assessments, financial impact analysis, or recommendations for system improvement and exception prevention strategies for enhanced service reliability and customer satisfaction.

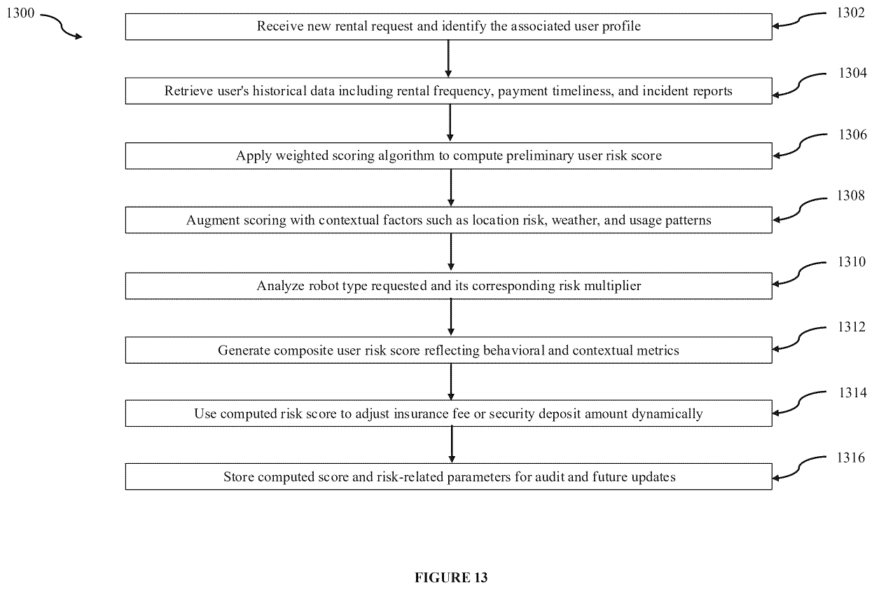

In some exemplary embodiments of the present invention, reference is made to FIG. 13 illustrating a non-limiting example of a method 1300 for user scoring and risk assessment in an on-demand robot rental system. At step 1302, the method includes receiving a new rental request and identifying the associated user profile. In an exemplary embodiment of the present invention, the user identification and profile management system may implement comprehensive customer relationship management including multi-factor authentication for secure user identification, profile data aggregation from multiple sources, behavioral pattern recognition for user characterization, privacy-compliant data handling, and real-time profile enhancement for improved service personalization.

In some exemplary embodiments of the present invention, the rental request reception may utilize secure communication protocols including encrypted data transmission using advanced cryptographic standards, digital signature verification for request authenticity, API rate limiting for security protection, request validation for data integrity, or distributed denial-of-service protection for system availability and security.

In some exemplary embodiments of the present invention, the user profile identification may encompass multiple verification layers including primary authentication through username and password combinations, secondary authentication through mobile device verification or biometric authentication, tertiary verification through linked social media or professional accounts, financial account verification for payment method validation, or device fingerprinting for fraud detection and prevention.

In some exemplary embodiments of the present invention, the associated user profile may include comprehensive customer information such as demographic data including age, location, and occupation, rental history with detailed transaction records, payment behavior patterns and financial reliability indicators, customer service interactions and satisfaction ratings, or device and platform usage preferences for personalized service delivery.

In some exemplary embodiments of the present invention, the profile management system may implement privacy protection measures including data anonymization techniques for sensitive information protection, consent management for data usage permissions, access control mechanisms for authorized personnel only, audit trails for data access tracking, or compliance with privacy regulations such as GDPR, CCPA, or industry-specific privacy requirements.

In some exemplary embodiments of the present invention, the user identification may utilize advanced technologies including machine learning algorithms for behavioral pattern recognition, artificial intelligence for fraud detection, blockchain technology for secure identity verification, natural language processing for communication analysis, or computer vision for document verification and authentication.

At step 1304, the method includes retrieving user's historical data including rental frequency, payment timeliness, and incident reports. In an exemplary embodiment of the present invention, the historical data retrieval system may implement comprehensive data analytics including longitudinal behavior analysis, temporal pattern recognition, risk indicator identification, performance benchmarking against user populations, and predictive modelling for future behavior assessment based on historical patterns.

In some exemplary embodiments of the present invention, the rental frequency analysis may encompass various usage metrics including total number of rentals over different time periods, seasonal usage patterns and cyclical behavior, rental duration preferences and usage intensity, robot type preferences and specialization patterns, geographic usage distribution across service areas, or time-of-day preferences for rental initiation and completion.

In some exemplary embodiments of the present invention, the payment timeliness evaluation may include comprehensive financial behavior assessment such as payment processing speed and reliability, late payment frequency and duration, payment method preferences and stability, dispute and chargeback history, refund processing behavior, or credit utilization patterns for customers using credit-based payment methods.

In some exemplary embodiments of the present invention, the incident reports analysis may encompass various service-related events including robot damage incidents with severity and cause analysis, theft or loss incidents with recovery outcomes, customer service complaints and resolution effectiveness, safety violations or regulatory non-compliance events, insurance claims and settlement history, or operational disruptions caused by customer actions.

In some exemplary embodiments of the present invention, the historical data retrieval may utilize advanced database technologies including distributed data warehouses for scalable storage, time-series databases for temporal analysis, graph databases for relationship modelling, in-memory databases for real-time processing, or cloud-based analytics platforms for comprehensive data analysis.

In some exemplary embodiments of the present invention, the data analysis may implement various statistical methods including descriptive statistics for behavior summarization, correlation analysis for identifying behavior relationships, regression analysis for trend identification, time series forecasting for behavior prediction, or multivariate analysis for complex behavior pattern recognition.

At step 1306, the method includes applying weighted scoring algorithm to compute preliminary user risk score. In an exemplary embodiment of the present invention, the weighted scoring system may implement risk assessment including multi-dimensional risk evaluation, dynamic weight adjustment based on market conditions, machine learning model integration for adaptive scoring, ensemble methods combining multiple scoring approaches, and continuous model validation for accuracy optimization.

In some exemplary embodiments of the present invention, the weighted scoring algorithm may incorporate various behavioral factors including rental history reliability with higher weights for consistent positive behavior, payment performance with emphasis on timeliness and completeness, incident frequency with penalty weighting for negative events, customer service interactions with positive weighting for cooperative behavior, or length of customer relationship with loyalty bonus considerations.

In some exemplary embodiments of the present invention, the scoring methodology may utilize various mathematical approaches including linear weighted combinations for straightforward factor integration, non-linear scoring functions for complex behavior relationships, fuzzy logic systems for handling uncertainty and partial information, Bayesian models for probabilistic risk assessment, or neural network models for learning complex patterns from historical data.

In some exemplary embodiments of the present invention, the preliminary risk score computation may implement normalization techniques including z-score standardization for consistent factor scaling, percentile ranking for population-based comparison, min-max normalization for bounded score ranges, robust scaling for outlier handling, or industry-standard benchmarking for competitive risk assessment.

In some exemplary embodiments of the present invention, the algorithm may incorporate temporal weighting including recent behavior emphasis with higher weights for current patterns, decay functions for reducing the impact of old behavior, seasonal adjustments for cyclical behavior patterns, trend analysis for identifying improving or declining behavior, or milestone-based weighting for significant behavior changes.

At step 1308, the method includes augmenting scoring with contextual factors such as location risk, weather, and usage patterns. In an exemplary embodiment of the present invention, the contextual augmentation system may implement comprehensive environmental risk assessment including geographic risk analysis, temporal risk factors, external condition integration, market-specific considerations, and dynamic risk adjustment based on real-time conditions and circumstances.

In some exemplary embodiments of the present invention, the location risk assessment may encompass various geographic factors including crime statistics and safety ratings for the rental area, infrastructure quality and accessibility for robot operation, population density and traffic patterns affecting usage complexity, economic indicators and market stability, regulatory environment and compliance requirements, or natural disaster risk and environmental hazards.

In some exemplary embodiments of the present invention, the weather factor integration may include comprehensive meteorological analysis such as current weather conditions affecting robot operation and safety, weather forecasts for the rental period, seasonal weather patterns and historical impact on robot performance, extreme weather risk assessment, or climate-specific operational considerations for different robot types.

In some exemplary embodiments of the present invention, the usage pattern analysis may incorporate various behavioral indicators including time-of-day preferences with associated risk profiles, duration patterns and intensity of use, multi-robot rental patterns for complex usage scenarios, seasonal usage variations and associated risk changes, or specialized usage patterns for different robot types and applications.

In some exemplary embodiments of the present invention, the contextual scoring may utilize external data sources including government agencies for crime and safety statistics, meteorological services for weather data, traffic authorities for infrastructure information, economic databases for market indicators, or social media and news sources for real-time local condition monitoring.

In some exemplary embodiments of the present invention, the augmentation algorithms may implement machine learning techniques including feature engineering for contextual factor integration, ensemble methods for combining multiple contextual inputs, reinforcement learning for adaptive contextual weighting, or deep learning models for complex contextual pattern recognition.

At step 1310, the method includes analyzing the robot type requested and its corresponding risk multiplier. In an exemplary embodiment of the present invention, the robot-specific risk analysis system may implement comprehensive asset-based risk assessment including robot value and replacement cost analysis, operational complexity and user skill requirements, safety considerations and liability implications, theft susceptibility and security features, and maintenance requirements and reliability factors.

In some exemplary embodiments of the present invention, the robot type analysis may encompass various risk categories including high-value robots with premium features and advanced capabilities, specialized robots requiring technical expertise for operation, industrial robots with safety considerations and regulatory requirements, consumer robots with broad market appeal and theft risk, or prototype robots with limited availability and high replacement costs.

In some exemplary embodiments of the present invention, the risk multiplier calculation may consider various factors including robot market value and insurance replacement cost, component fragility and repair complexity, user training requirements and skill level matching, operational environment suitability and safety considerations, or historical loss data and claim frequency for specific robot types.

In some exemplary embodiments of the present invention, the robot-specific scoring may implement dynamic adjustment mechanisms including market value fluctuation tracking, technology advancement impact on risk profiles, seasonal demand variations affecting theft risk, competitive analysis for market positioning, or regulatory changes affecting operational requirements and compliance.

At step 1312, the method includes generating composite user risk score reflecting behavioral and contextual metrics. In an exemplary embodiment of the present invention, the composite scoring system may implement risk integration including multi-dimensional score combination, weighted factor aggregation, uncertainty quantification, confidence interval calculation, and dynamic score updating based on real-time information and changing conditions.

In some exemplary embodiments of the present invention, the composite score generation may utilize various aggregation methods including weighted arithmetic means for balanced factor integration, geometric means for multiplicative factor relationships, harmonic means for rate-based factor combination, or custom aggregation functions designed for specific risk assessment requirements and business objectives.

In some exemplary embodiments of the present invention, the behavioral and contextual metrics integration may implement modelling including factor interaction analysis for understanding complex relationships, non-linear combination functions for realistic risk representation, temporal dynamics for time-varying risk factors, or stochastic modelling for handling uncertainty and variability in risk assessment.

In some exemplary embodiments of the present invention, the composite scoring may include quality assurance measures such as score validation through historical performance correlation, outlier detection for unusual risk profiles, sensitivity analysis for factor importance assessment, or benchmark comparison against industry standards and competitive practices.

At step 1314, the method includes using computed risk score to adjust insurance fee or security deposit amount dynamically. In an exemplary embodiment of the present invention, the dynamic pricing adjustment system may implement risk-based financial optimization including graduated fee structures based on risk levels, real-time price adjustment algorithms, customer segment differentiation, competitive pricing analysis, and regulatory compliance for fair pricing practices.

In some exemplary embodiments of the present invention, the insurance fee adjustment may implement various pricing strategies including linear scaling based on risk score magnitude, tiered pricing with discrete risk categories, exponential scaling for high-risk customers, or custom pricing curves designed for optimal risk-revenue balance and customer retention.

In some exemplary embodiments of the present invention, the security deposit adjustment may consider various factors including customer payment history and reliability, robot value and replacement risk, rental duration and usage intensity, seasonal risk variations, or alternative risk mitigation options such as insurance coverage or guarantor arrangements.

In some exemplary embodiments of the present invention, the dynamic adjustment may implement customer communication features including transparent fee explanation, risk reduction recommendations, alternative pricing options, loyalty program benefits, or customer service support for fee-related questions and concerns.

At step 1316, the method includes storing computed score and risk-related parameters for audit and future updates. In an exemplary embodiment of the present invention, the data storage and management system may implement comprehensive record-keeping including audit trail generation, version control for score updates, data retention policies, privacy protection measures, and analytical data preparation for continuous model improvement.

In some exemplary embodiments of the present invention, the score storage may utilize secure database systems including encrypted storage for sensitive customer information, backup systems for data protection, distributed storage for scalability and availability, audit logging for regulatory compliance, or blockchain technology for immutable record keeping.

In some exemplary embodiments of the present invention, the audit functionality may include comprehensive tracking such as score calculation history with timestamps, factor weight changes and justifications, model version tracking for reproducibility, customer interaction history, or regulatory compliance documentation for financial and insurance regulations.

In some exemplary embodiments of the present invention, the future update preparation may implement data analytics capabilities including model performance monitoring, factor effectiveness analysis, customer satisfaction correlation, business impact assessment, or continuous improvement recommendations for score accuracy and business optimization.

After step 1316, the method concludes the user scoring and risk assessment process. In an exemplary embodiment of the present invention, the process conclusion may trigger various follow-up activities including customer notification of pricing decisions, score-based service customization, risk mitigation strategy implementation, performance monitoring setup, and analytics data collection for model refinement and business intelligence.

In some exemplary embodiments of the present invention, the conclusion may include comprehensive documentation such as risk assessment reports for regulatory compliance, customer service notes for future reference, business analytics data for strategic planning, model performance metrics for continuous improvement, or customer feedback integration for service enhancement and risk model optimization.

In some exemplary embodiments of the present invention, there is provided a flowchart illustrating a non-limiting example of a method for task assignment and execution in an on-demand robot rental and dispatch system.

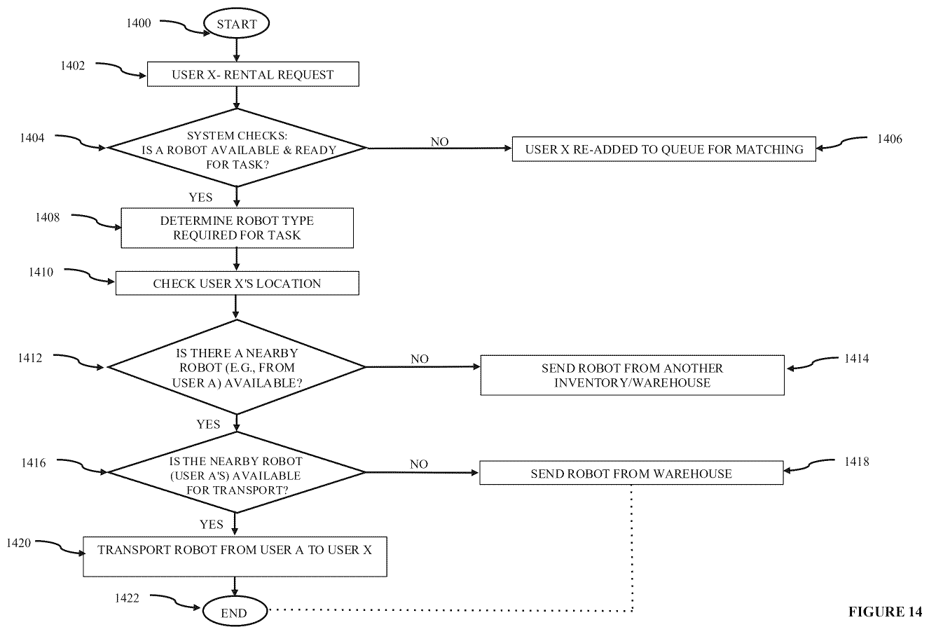

In some exemplary embodiments of the present invention, reference is made to FIG. 14 illustrating a non-limiting example of a structured sequence of operations that enable efficient processing of user rental requests, robot availability verification, and optimized task fulfilment through warehouse or peer-to-peer robot transfers. The disclosed method ensures dynamic task allocation, reduced idle time, and optimized resource utilization across the robotic fleet.

At step 1400, the process begins with the initiation of the task assignment and execution workflow. The system may initialize various operational modules including user authentication, request validation, and robot status monitoring subsystems to prepare for task execution.

At step 1402, the method includes receiving a rental request initiated by a user (e.g., User X) for a desired robot type. The request may include specific details such as robot category, task type, rental duration, and delivery location. In certain embodiments, the request may be received through a mobile or web-based interface connected to the system backend via secure communication channels.

At step 1404, the system checks whether the requested robot is available and ready for task execution. This step may involve querying the robot inventory database, analyzing robot operational status (e.g., battery level, maintenance condition), and verifying scheduling conflicts or prior commitments. The outcome determines the next operational path.

If the system determines that the requested robot is not available i.e. “no”, then at step 1406, the method adds the user again to the matching queue and prevents the scheduling for that specific time slot. The user may be notified of the unavailability through the application interface or push notifications and may be presented with alternative available time slots. This upfront availability check is generally preferred to a queue, as users often require the robot at a specific time. In an exception scenario where a previously confirmed booking loses availability (e.g., due to robot damage), the system may then initiate a refund or re-allocation process that includes: (i) automatic re-allocation and dynamic logistics attempts for a defined grace period; (ii) escalation to human operational staff if automated attempts fail; and (iii) only if all recovery attempts are unsuccessful, the issuance of a full refund and cancellation of the booking.

If the robot is available i.e. “yes”, the process advances to step 1408, where the method includes determining the robot type required for the requested task. This determination may include assessing task parameters, identifying performance requirements, and mapping them to a suitable robot configuration or model. Machine learning algorithms may be used to suggest optimal robot types based on historical data and similar task profiles.

At step 1410, the system identifies and validates the location of User X. This may be achieved through GPS data, manual input, or address verification systems. The location data is then used to determine the most efficient dispatch route and identify potential nearby robot sources to minimize transportation time.

At step 1412, the method includes checking if there is a nearby robot available that can fulfill the request. In some embodiments, this may include verifying whether a robot currently rented by another user (e.g., User A) can be reassigned for the new task upon completion of its current usage period. The system evaluates proximity, robot condition, and transfer feasibility during this stage.

If no nearby robot is available for immediate transfer, then at step 1414, the system triggers robot dispatch from the warehouse or inventory. The warehouse management module coordinates with the transportation system to prepare and send a robot to User X's location. This includes scheduling pickup, route optimization, and estimated delivery time generation.

However, if a nearby robot is identified as available with another user, the method proceeds to step 1416, where the system checks if that robot is within a predefined proximity threshold and available for transport. The proximity threshold may vary depending on regional distribution, demand, and transportation conditions.

If the nearby robot is determined not to be within an acceptable range, then at step 1418, the system again initiates dispatch from the warehouse to ensure timely service.

In contrast, if the nearby robot meets the proximity and availability criteria, then at step 1420, the system facilitates transportation of the robot from User A to User X. This may involve coordinating third-party transport services, autonomous robot relocation, or direct user-to-user handoff with tracking and verification mechanisms.

At step 1422, the method concludes the task assignment and execution process. The system logs all operational data, updates the inventory and status databases, and notifies both users of the successful task completion or transfer. In some embodiments, performance metrics such as delivery time, distance covered, and resource utilization may be recorded for continuous process optimization.

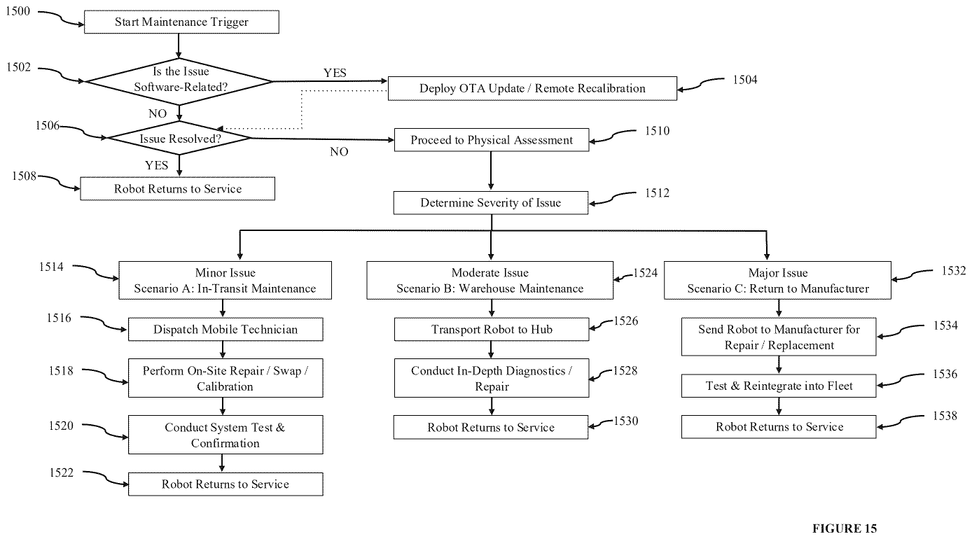

In some exemplary embodiments of the present invention, reference is made to FIG. 15 illustrating a non-limiting example of a robot maintenance decision process flowchart for an on-demand robot rental system.

In some exemplary embodiments of the present invention, the flowchart depicts the systematic sequence of actions undertaken by the system to identify, classify, and resolve maintenance issues in robots, ensuring operational continuity, reliability, and service quality.

At step 1500, the process begins with the system initiating a maintenance trigger. The trigger may be generated either through user feedback during active robot usage or via automated monitoring during robot transit or routine health checks. The system continuously monitors operational parameters, sensor data, and performance logs to proactively detect anomalies that may require maintenance intervention.

At step 1502, the method includes determining whether the issue is software-related. This evaluation may involve analyzing error codes, communication logs, firmware integrity, and system diagnostics.

If the issue is identified as software-related, then at step 1504, the system initiates an over-the-air (OTA) update or remote recalibration. This allows software fixes, configuration resets, or firmware patches to be deployed remotely without requiring physical intervention. The method then proceeds to step 1506. Otherwise, if the issue is identified as not being software-related in step 1502, the method proceeds to step 1506.

At step 1506, the method includes checking if the issue is resolved following the OTA update. If the issue is successfully resolved, the system proceeds to return the robot to service at step 1508, updating its operational status in the central database and making it available for deployment. If the issue remains unresolved after the remote intervention, the process advances to step 1510, where the system proceeds to a physical assessment phase to determine hardware-related issues.

At step 1512, the method includes determining the severity of the issue. The severity classification helps in deciding the appropriate maintenance pathway minor, moderate, or major. If the issue is determined to be minor in step 1514, corresponding to Scenario A (in-transit maintenance), then at step 1516, a mobile technician is dispatched to the robot's location.

At step 1518, the technician performs on-site repair, component swap, or calibration as needed. Following step 1518, at step 1520, a system test and confirmation are conducted to ensure that the robot is fully functional. Once validated, the robot is returned to service at step 1522.

If the issue severity is determined to be moderate in step 1524, corresponding to Scenario B (warehouse maintenance), then at step 1526, the robot is transported to a designated service hub.

At step 1528, the system conducts in-depth diagnostics and repairs using specialized tools and technical staff. Upon successful completion of the repair, the robot is returned to service at step 1530, following quality assurance testing.

If the issue severity is determined to be major in step 1532, corresponding to Scenario C 1532 (manufacturer maintenance), then at step 1534, the robot is sent back to the manufacturer for repair or replacement. At step 1536, the manufacturer conducts testing and reintegration procedures to ensure compliance with operational standards. At step 1538, the robot is reintegrated into the fleet and returned to active service, completing the maintenance cycle.

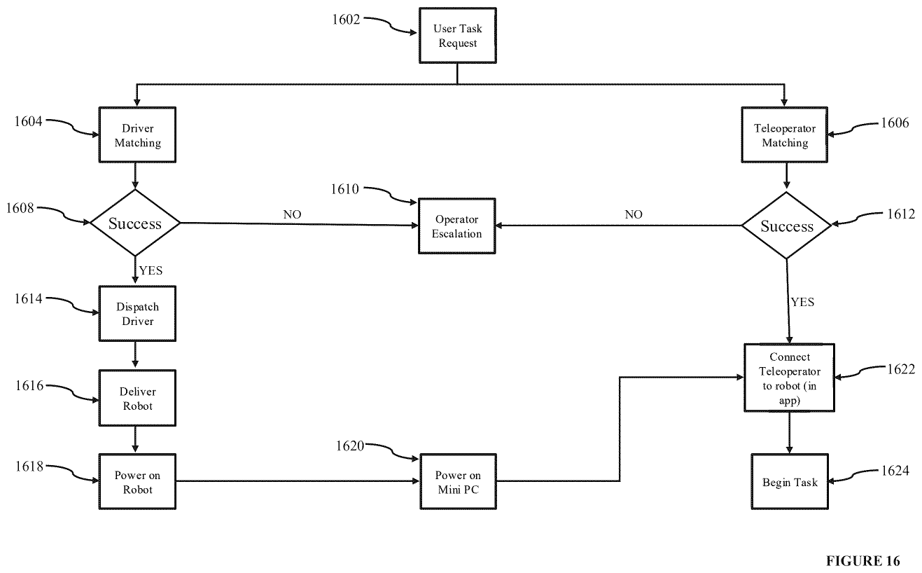

Referring now to FIG. 16, an exemplary flowchart illustrating a method for on-demand robotic asset deployment and task initiation is provided. This method details the sequential steps taken by the central management system to fulfil a user task request, encompassing fleet driver matching, robotic asset delivery, and teleoperator connection to facilitate the task.

At step 1602, a User Task Request is received by the central management system. This request, submitted by a user through the user application, specifies the nature of the task, the deployment location, the required robotic asset type, and the desired commencement time. Following receipt of the request, the central management system simultaneously initiates two parallel, independent process flows: the logistical flow and the operational readiness flow.

The logistical flow begins with Driver Matching at step 1604, where the system identifies and assigns a suitable fleet driver for the logistics of the robotic asset. At decision step 1608, the system determines the success of the Driver Matching. If the matching is unsuccessful in step 1608, the central management system triggers Operator Escalation at step 1610 to resolve the issue manually. If the Driver Matching is successful in step 1608, the system proceeds to Dispatch Driver at step 1614, sending the necessary mission details (pickup location, robotic asset ID, delivery destination, and delivery deadline) to the matched driver's device. The method then delivers the robot in step 1616, powers on the robot in step 1618, and powers on a mini PC in step 1620. After step 1620, the method proceeds to step 1622 to connect the teleoperator to the robot in an app.

Concurrently with steps 1604-1618, the operational readiness flow begins with Teleoperator Matching at step 1606, where the system attempts to identify and reserve a teleoperator who can remotely pilot the robotic asset. The system evaluates the result of the Teleoperator Matching at decision step 1612. If the matching is unsuccessful in step 1612, the system triggers Operator Escalation in step 1610, requiring a human operator to manually allocate a teleoperator or communicate a delay to the user.

If the matching is successful in step 1612, the method proceeds to step 1622 to connect the teleoperator to the robot in an app. The system proceeds to step 1622 only when both the logistical flow (Driver Dispatch in step 1614) and the operational readiness flow (Teleoperator Match in step 1612) are successful. The dispatched driver completes the Deliver Robot step at 1616, transporting the requested robotic asset to the user-specified location.

Once the robotic asset is delivered in step 1616, the user is prompted to complete the setup process, which includes Power on Robot at step 1618, and Power on Mini PC at step 1620. The step 1620 involves powering on the main robotic unit and its embedded computing module, typically the Mini PC, to establish network connectivity.

After the robotic asset is powered on in step 1618 and connected, the process moves to step 1622 for Connecting a Teleoperator to robot (in an app). The step 1622 involves establishing a secure, low-latency, real-time connection between the reserved teleoperator and the deployed robotic asset via the central management application, enabling remote control. Finally, upon successful connection of the teleoperator in step 1622, the service can commence at step 1624 to Begin a Task, where the teleoperator or the user initiates the primary work requested in step 1602.

Portions of the methods described herein can be performed by software or firmware in machine readable form on a tangible or non-transitory storage medium. For example, the software or firmware can be in the form of a computer program including computer program code adapted to cause the system to perform various actions described herein when the program is run on a computer or suitable hardware device, and where the computer program can be implemented on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments, implementations, or arrangements.

The terminology used herein is for the purpose of describing particular implementations only and is not intended to limit the invention. As used herein, the singular forms “a”, “an”, and “the” are intended to include the plural forms as well, unless the context clearly indicates otherwise. It will be further understood that the terms “contains”, “containing”, “includes”, “including”, “comprises”, and/or “comprising”, and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second”. Also, the phraseology and terminology used herein is for the purpose of description and should not be regarded as limiting. The use of “including”, “comprising”, “having”, “containing”, “involving”, and variations thereof herein, is meant to encompass the items listed thereafter and equivalents thereof as well as additional items.

While the disclosure has described several exemplary implementations, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to implementations of the disclosure without departing from the essential scope thereof. Therefore, it is intended that the invention is not limited to the particular implementations disclosed, or to the best mode contemplated for carrying out this invention, but that the invention will include all implementations falling within the scope of the appended claims.

The subject matter described above is provided by way of illustration only and should not be construed as limiting. Various modifications and changes can be made to the subject matter described herein without following the example embodiments, implementations, and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for managing on-demand distribution of one or more robots, the method comprising:
receiving, at a server from a first user device, a first rental request for one or more robots, the first rental request defining a first rental period and a first delivery location;
transferring, by a transport resource, the one or more robots from a source to the first delivery location for the duration of the first rental period;
receiving, at the server from a second user device, a second rental request for the one or more robots, the second rental request defining a second rental period and a second delivery location;
in response to receiving the second rental request:
identifying, by a processor, a geographic location of the one or more robots,
identifying, by the processor, if the geographic location is within a predefined geographic radius of the second delivery location, and
determining, by the processor, an availability status of the one or more robots upon the conclusion of the first rental period;
assigning, by the processor, the one or more robots to the second rental request based on identified geographic location and availability status of the one or more robots; and
transferring, by the transport resource, the one or more robots from the geographic location to the second delivery location.

2. The method of claim 1, wherein the availability status of the one or more robots is determined based on a plurality of parameters comprising-task completion status, battery life, operational readiness, current location accessibility, user availability, maintenance requirements, and system health diagnostics, and
wherein determining the availability status includes determining a health parameter, comparing the health parameter against a predefined maintenance threshold, and assigning the one or more robots only if the health parameter satisfies the threshold.

3. The method of claim 1, wherein the source includes one or more of an inventory storage location, a robot currently in transit from a prior delivery, a third-party user's location who lends robots to the rental fleet, or a designated staging area,
wherein the processor selects the source based on minimizing total travel time and transportation costs to reach the delivery location, and
wherein the method further comprises implementing fleet redistribution operations by analyzing the geographic distribution of robots relative to anticipated demand patterns, identifying underutilized robots for repositioning, and coordinating automated robot relocation to optimize fleet coverage.

4. The method of claim 1, wherein assigning the one or more robots to the second rental request is based on one or more parameters comprising: delivery time, cost-effectiveness, user availability and type of service.

5. The method of claim 1, further comprising:
determining an efficient route for the transfer of the one or more robots from their source or geographic location, and
determining optimal return timing based on rental period completion and demand forecasting,
wherein the demand forecasting comprises implementing predictive analytics by analyzing historical demand patterns to forecast future robot requirements, optimizing robot pre-positioning based on anticipated demand hotspots, and adjusting fleet composition recommendations based on seasonal usage trends.

6. The method of claim 1, further comprising:
determining a rental cost using dynamic pricing algorithms that process current demand data and robot availability metrics, wherein the algorithms determine a base rate, apply demand multipliers based on supply-demand ratios and geographic factors, wherein the geographic factors determined based on distance to the destination, regional market conditions, and increase multipliers when demand for a specified robot type exceeds supply, creating a surge price, and
updating fleet utilization metrics, analyzing robot usage statistics across time periods and geographic regions, and optimizing future matching and pricing algorithms based on customer interaction data.

7. The method of claim 1, wherein the one or more robots are located within the predefined geographic radius is identified using a real-time inventory management system that maintains current source or geographic location, operational status, capability profiles, and historical performance data for each robot, and
wherein the real-time inventory management system further tracks real-time position data using GPS and cellular communication networks, monitors operational status indicators including battery level and system health, and generates security alerts for unauthorized access or unusual movement patterns.

8. The method of claim 1, further comprising determining an insurance value based on one or more of parameters including rental history, payment history, damage rates from prior rentals, environmental risk metrics, location-based risk data derived from crime statistics, and robot-specific factors including market value and fragility ratings.

9. The method of claim 1, further comprising processing a payment transaction for the rental request including:
performing real-time authorization verification,
executing automated billing and electronic settlement,
authorizing a security deposit amount prior to dispatching of the one or more robots, and
releasing the deposit upon successful conclusion of the rental period.

10. The method of claim 1, wherein the first and the second rental requests defines functions performed by the one or more robots and/or the type of the one or more robots performing one or more functions, and wherein the identified geographic location is the first delivery location.

11. The method of claim 1, wherein transferring the one or more robots comprises generating task sequences for pickup, transportation, and delivery operations, transmitting routing information, and providing exception handling protocols for managing failed or delayed operations, and
wherein the exception handling protocols further comprise executing dynamic reallocation capabilities for handling transport resource cancellations or delays.

12. A method for managing on-demand distribution of one or more robots, the method comprising:
receiving, at a server from a user device, a rental request for a robot, the rental request defining a rental period and a delivery location;
dispatching the robot from an inventory to the delivery location for the duration of the rental period;
identifying, via a processor, an available robot based on geographic proximity to the delivery location and having a status indicating suitability for the rental request;
in response to said identifying, assigning, via the processor, the available robot using proximity, availability, and performance metrics; and
transmitting, from the server, instructions to a transport resource to execute pickup and delivery of the robot to the delivery location.

13. A method for managing an on-demand rental of a robot provided by a third-party owner, the method comprising:
receiving, at a server from a device associated with a third-party owner, a registration of one or more robots for inclusion in a rental fleet, the registration defining an availability period and a home location for the robot;
receiving, at the server from a user device, a rental request for the one or more robots, the rental request defining a rental period and a delivery location;
identifying, via a processor, that the registered robot from the third-party owner is available during the rental period and satisfies the requirements of the rental request;
in response to said identifying, transmitting first instructions to a transport resource to retrieve the robot from the home location and deliver it to the delivery location for the duration of the rental period; and
upon a conclusion of the rental period, transmitting second instructions to the transport resource to execute a return transfer of the robot.

14. The method of claim 13, wherein the first robot is provided by a third-party owner and registered in the inventory, the method further comprising calculating a commission fee based on rental income and platform fees, crediting payment to the account of the third-party owner.

15. The method of claim 13, further comprising tracking real-time position data using GPS and cellular communication networks, monitoring operational status indicators including battery level and system health, and generating security alerts for unauthorized access or unusual movement patterns.

16. The method of claim 13, further comprising updating fleet utilization metrics, analyzing robot usage statistics across time periods and geographic regions, and optimizing future matching and pricing algorithms based on customer interaction data.

17. The method of claim 13, further comprising implementing fleet redistribution operations analyzing geographic distribution of robots relative to anticipated demand patterns, identifying underutilized robots for repositioning, and coordinating automated robot relocation to optimize fleet coverage.

18. The method of claim 13, further comprising implementing predictive analytics analyzing historical demand patterns to forecast future robot requirements, optimizing robot pre-positioning based on anticipated demand hotspots, and adjusting fleet composition recommendations based on seasonal usage trends.

19. The method of claim 13, wherein assigning the first robot further comprises executing dynamic reallocation capabilities for handling transport resource cancellations or delays.
